(19) United States
(12) Patent Application Publication
(10) Pub. No.: US 2026/0283175 A1
(43) Pub. Date: Sep. 24, 2026

(54) IMPROVED PREPARATION OF SUNFLOWER PROTEIN PRODUCTS ("SF871NDS")

(71) Applicant: Burcon Nutrascience (MB) Corp., Winnipeg (CA)

(72) Inventors: Edwin CATIPON, Winnipeg (CA); Martin SCHWEIZER, Winnipeg (CA); Kip UNDERWOOD, Town and Country, MO (US)

(21) Appl. No.: 19/475,396

(22) PCT Filed: Apr. 13, 2024
(86) PCT No.: PCT/CA2024/050476

§ 371 Date: Oct. 14, 2025

Related U.S. Application Data
(60) Provisional application No. 63/496,032, filed on Apr. 14, 2023.

(51) Int. Cl. A23C 11/06; A23J 1/14; A23J 3/14; A23J 3/22

(52) U.S. Cl. CPC A23C 11/06; A23J 1/14; A23J 3/14; A23J 3/227

(57) ABSTRACT

Processes for preparing sunflower protein products from a sunflower protein source are provided. Protein extracted from the sunflower protein source is processed to provide a sunflower protein product having a protein content of greater than 60 wt % (N×6.25) d.b. A separation step is employed in the process to improve the efficiency of membrane processing. Additional sunflower protein product is prepared from the residual sunflower protein source after protein extraction, preferably having a protein content of greater than 30 wt % (N×6.25) d.b. These protein products are also provided as are food and beverages, pet food, animal feed, industrial product, cosmetic product or personal care product comprising the sunflower protein products.

### RELATED APPLICATIONS

The present application claims priority to U.S. provisional patent application 63/496,032 filed Apr. 14, 2023 herein incorporated by reference in its entirety.

### FIELD

The present disclosure relates to sunflower protein products and to methods of preparing sunflower protein products.

### SUMMARY

The present disclosure relates to sunflower products, and processes for the preparation thereof.

In one embodiment, there is provided a process for preparing a sunflower protein product from a sunflower protein source, the sunflower protein product having a protein content of greater than 60 wt % (N×6.25) d.b., the process comprising
a) extracting sunflower protein from a sunflower protein source to cause solubilization of the sunflower protein from the sunflower protein source to produce an aqueous phase and a residual sunflower protein source;
b) separating the aqueous phase from the residual sunflower protein source to produce an aqueous sunflower protein solution and a separated residual sunflower protein source
c) optionally defatting the separated aqueous sunflower protein solution to at least partially remove fat from the separated aqueous sunflower protein solution;
d) adjusting the pH of the aqueous sunflower protein solution to an acidic value in the range of about pH 1.5 to about pH 5.0 to provide an acidified sunflower protein solution;
e) optionally concentrating the acidified sunflower protein solution;
f) optionally diafiltering the concentrated acidified sunflower protein solution using water as the diafiltration solution OR optionally diafiltering the acidified sunflower protein solution using water prior to concentration or optionally diafiltering the partially concentrated acidified sunflower protein solution using water;
g) optionally drying the acidified sunflower protein solution (d) or optionally concentrated and/or diafiltered sunflower protein solution ((e) or (f)) to provide a sunflower protein product;
wherein steps e) and f) may optionally be carried out simultaneously.

In another embodiment of the process or processes outlined above, the process further comprises: treating the aqueous sunflower protein solution with an anti-foamer, such as any suitable food-grade, non-silicone based anti-foamer, to reduce the volume of foam formed upon further processing, and wherein the anti-foamer is optionally added during the extraction step a).

In another embodiment of the process or processes outlined above, the quantity of anti-foamer employed is generally greater than about 0.0003% w/v.

In another embodiment of the process or processes outlined above, the process further comprises: treating the aqueous sunflower protein solution with an adsorbent, such as granulated activated carbon, to remove colour and/or odour compounds.

In another embodiment of the process or processes outlined above, separation comprises centrifugation and/or filtration optionally with a decanter centrifuge and a disc stack centrifuge.

In another embodiment of the process or processes outlined above, defatting of the separated aqueous sunflower protein solution is achieved by centrifugation and/or filtration.

In another embodiment of the process or processes outlined above, defatting comprises the use of a three-phase centrifuge, such as a three-phase separator, for the simultaneous separation of fat and residual solids from the protein solution, and wherein the three-phase centrifuge is optionally used potentially instead of or in addition to the separation steps defined above.

In another embodiment of the process or processes outlined above, solubilization from the sunflower protein source is effected using water having different levels of purity such as tap water or reverse osmosis (RO) purified water.

In another embodiment of the process or processes outlined above, the pH of the extraction may be the natural pH of the combination of the water and the sunflower protein source, or the pH of the extraction may be adjusted up to any value between the natural pH and about 8.5, or the pH may be adjusted within the range of about 6.8 to about 8.0, or the pH may be adjusted to about 6.8 to about 7.5.

In another embodiment of the process or processes outlined above, food grade sodium hydroxide, potassium hydroxide or any other conventional food grade alkali and combinations thereof are added to the water to adjust the pH of the extraction.

In another embodiment of the process or processes outlined above, solubilization of the protein is effected at a temperature of from about 1° to about 100° C., preferably about 15° to about 65° C., more preferably about 50° C. to about 60° C., preferably accompanied by agitation.

In another embodiment of the process or processes outlined above, the solubilization time is about 1 to about 60 minutes, preferably about 10 to about 30 minutes.

In another embodiment of the process or processes outlined above, the concentration of the sunflower protein source in the water during the extraction step is selected from the group consisting of about 5 to about 20% w/v and about 5 to about 15% w/v.

In another embodiment of the process or processes outlined above, the aqueous phase resulting from the extraction step generally has a protein concentration of about 0.5 to about 5 wt %, preferably about 1 to about 5 wt %.

In another embodiment of the process or processes outlined above, the water of extraction may contain an antioxidant, such as ascorbic acid optionally in an amount of from about 0.01 to about 1 wt % of the solution, preferably about 0.05 to about 0.15 wt %, more preferably about 0.05 to about 0.10 wt %.

In another embodiment of the process or processes outlined above, the separation step b) is conducted at the same temperature as the extraction step or at any temperature within the range of about 1° to about 100° C., preferably about 15° to about 65° C., more preferably about 50° to about 60° C.

In another embodiment of the process or processes outlined above, the separated sunflower protein solution is adjusted in pH to a pH of about 2.0 to about 3.0 in step (d).

In another embodiment of the process or processes outlined above, the separated sunflower protein solution is adjusted in pH in step (d) by the addition of any food grade acid such as food grade hydrochloric acid solution or food grade phosphoric acid solution or food grade citric acid.

In another embodiment of the process or processes outlined above, the acidified protein solution following acidification step (d) is subjected to a heat treatment step.

In an embodiment of the process or processes outlined above, the heat treatment step is effected to potentially aid to inactivate heat-labile anti-nutritional factors.

In an embodiment of the process or processes outlined above, the anti-nutritional factors are heat-labile trypsin inhibitors.

In another embodiment of the process or processes outlined above, the heat treatment step is effected to pasteurize the acidified aqueous protein solution.

In another embodiment of the process or processes outlined above, the heat treatment is effected at a temperature of about 70° to about 160° C. for about 10 seconds to about 60 minutes.

In another embodiment of the process or processes outlined above, the heat treatment is effected at a temperature of about 80° to about 120° C. for about 10 seconds to about 5 minutes.

In another embodiment of the process or processes outlined above, the heat treatment is effected at a temperature of about 85° to about 95° C. for about 30 seconds to about 5 minutes.

In another embodiment of the process or processes outlined above, the heat treated acidified sunflower protein solution is cooled to a temperature of about 2° to about 65° C.

In another embodiment of the process or processes outlined above, the heat treated acidified sunflower protein solution is cooled to a temperature of about 50° to about 60° C.

In another embodiment of the process or processes outlined above, the acidified sunflower protein solution is dried to provide a sunflower protein product having a protein content of at least about 60 wt % (N×6.25) d.b.

In another embodiment of the process or processes outlined above the acidified sunflower protein solution is optionally concentrated in (e) to a protein concentration of about 5 to about 30 wt %, preferably about 5 to about 20 wt %, more preferably about 10 to about 20 wt %.

In another embodiment of the process or processes outlined above, the concentration step e) is effected by a selective membrane technique, such as ultrafiltration or diafiltration, using membranes, such as hollow-fibre membranes or spiral-wound membranes, with a suitable molecular weight cut-off (MWCO), such as about 1,000 to about 1,000,000 daltons, preferably about 1,000 to about 100,000 daltons, more preferably about 10,000 to about 100,000 daltons.

In another embodiment of the process or processes outlined above, the diafiltration step f) is effected using water as the diafiltration solution without any pH adjustment or the water is adjusted with any food grade acid to a pH down to that of the optionally concentrated sunflower protein solution.

In another embodiment of the process or processes outlined above, the diafiltration step f) may be done in stages using water at different pH values, such as initial volumes of diafiltration using water adjusted to the pH of the protein solution followed by additional volumes of diafiltration using water without pH adjusting agent.

In another embodiment of the process or processes outlined above, diafiltration is effected using from about 0.5 to about 40 volumes of diafiltration solution, preferably about 2 to about 25 volumes of diafiltration solution, more preferably about 2 to about 5 volumes of diafiltration solution.

In another embodiment of the process or processes outlined above, diafiltration is effected using the same membrane as for the concentration step e) or the diafiltration step f) is effected using a separate membrane with a different molecular weight cut-off, such as a membrane having a molecular weight cut-off in the range of about 1,000 to about 1,000,000 daltons, preferably about 1,000 to about 100,000 daltons, more preferably about 10,000 to about 100,000 daltons.

In another embodiment of the process or processes outlined above, the concentration step and/or the diafiltration step are effected in such a manner that the sunflower protein product subsequently recovered contains at least about 60 wt %, at least about 65 wt %, at least about 70 wt %, at least about 75 wt %, at least about 80 wt %, at least about 85 wt %, or greater than about 90 wt % protein (N×6.25) d.b.

In another embodiment of the process or processes outlined above, the diafiltration water comprises an antioxidant, such as ascorbic acid, optionally in an amount of from about 0.01 to about 1 wt %, preferably about 0.05 to about 0.15 wt %, more preferably about 0.05 to about 0.10 wt %.

In another embodiment of the process or processes outlined above, the optional concentration step e) and the optional diafiltration step f) are effected at generally about 2° to about 65° C., preferably about 50° to about 60° C.

In another embodiment of the process or processes outlined above, the optionally concentrated and optionally diafiltered protein solution is subject to a further defatting step.

In another embodiment of the process or processes outlined above, the optionally concentrated and optionally diafiltered protein solution are treated with an adsorbent, such as granulated activated carbon, to remove colour and/or odour compounds.

In another embodiment of the process or processes outlined above, step e) and/or f) are carried out and the partially concentrated, concentrated and/or diafiltered acidified sunflower protein solution is subjected to a heat treatment step.

In another embodiment of the process or processes outlined above, the heat treatment step is effected to potentially aid to inactivate heat-labile anti-nutritional factors.

In another embodiment of the process or processes outlined above, the anti-nutritional factors are heat-labile trypsin inhibitors.

In another embodiment of the process or processes outlined above, the heat treatment step is effected to pasteurize the partially concentrated, concentrated and/or diafiltered acidified sunflower protein solution.

In another embodiment of the process or processes outlined above, the heat treatment is effected at a temperature of about 70° to about 160° C. for about 10 seconds to about 60 minutes.

In another embodiment of the process or processes outlined above, the heat treatment is effected at a temperature of about 80° to about 120° C. for about 10 seconds to about 5 minutes.

In another embodiment of the process or processes outlined above, the heat treatment is effected at a temperature of about 85° C. to about 95° C. for about 30 seconds to about 5 minutes.

In another embodiment of the process or processes outlined above, the heat treated sunflower protein solution is cooled to a temperature of about 2° to about 65° C.

In another embodiment of the process or processes outlined above, the heat treated sunflower protein solution is cooled to a temperature of about 50° to about 60° C.

In another embodiment of the process or processes outlined above, the concentration and/or diafiltration steps are operated in a manner favourable for removal of trypsin inhibitors in the permeate, optionally by using a membrane of larger molecular weight cut-off, such as 30,000 to 1,000,000 Da, operating the membrane at elevated temperatures, such as about 30° to about 65° C., preferably about 50° to about 60° C. and employing greater volumes of diafiltration medium, such as 10 to 40 volumes.

In another embodiment of the process or processes outlined above, the aqueous sunflower protein solution is exposed to reducing agents that at least partially disrupt or rearrange the disulfide bonds of the inhibitors, such as sodium sulfite, cysteine or N-acetylcysteine.

In another embodiment of the process or processes outlined above, the optionally concentrated and optionally diafiltered protein solution is pasteurized prior to optional drying or further processing and wherein pasteurization optionally comprises heating the optionally concentrated and optionally diafiltered sunflower protein solution to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds, and optionally the pasteurized sunflower protein solution is cooled, such as to a temperature of about 20° to about 35° C.

In another embodiment of the process or processes outlined above, the optionally concentrated, optionally diafiltered and optionally pasteurized sunflower protein solution is subject to drying step g) to provide a sunflower protein product having a protein content of at least about 60 wt %, at least about 65 wt %, at least about 70 wt %, at least about 75 wt %, at least about 80 wt %, at least about 85 wt %, or greater than about 90 wt % protein (N×6.25) d.b.

In another embodiment of the process or processes outlined above, step e) and/or f) are carried out and said concentrated and/or diafiltered acidified sunflower protein solution is subjected to drying step g) to provide a sunflower protein product having a protein content of at least about 60 wt %, at least about 65 wt %, at least about 70 wt %, at least about 75 wt %, at least about 80 wt %, at least about 85 wt %, or greater than about 90 wt % protein (N×6.25) d.b.

In another embodiment of the process or processes outlined above, the pH of the optionally concentrated and optionally diafiltered acidified sunflower protein solution is raised to a value selected from the group consisting of less than about 8.0, about 6.0 to about 8.0 and about 6.5 to about 7.5, to produce a pH adjusted sunflower protein solution.

In another embodiment of the process or processes outlined above, a food grade sodium hydroxide, potassium hydroxide or any other conventional food grade alkali and combinations thereof are added to the optionally concentrated and optionally diafiltered acidified sunflower protein solution to raise the pH.

In another embodiment of the process or processes outlined above, the pH adjusted sunflower protein solution is pasteurized prior to optional drying and pasteurization optionally comprises heating the sunflower protein solution to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds, and optionally the pasteurized sunflower protein solution is cooled, such as to a temperature of about 20° to about 35° C.

In another embodiment of the process or processes outlined above, the pH adjusted sunflower protein solution is separated into protein solids and a solids-removed protein solution.

In another embodiment of the process or processes outlined above, the separation is performed using a disc stack centrifuge.

In another embodiment of the process or processes outlined above, the solids-removed protein solution is concentrated by a selective membrane technique, such as ultrafiltration or diafiltration, using membranes, such as hollow-fibre membranes or spiral-wound membranes, with a suitable molecular weight cut-off, such as about 1,000 to about 100,000 daltons, preferably about 1,000 to about 10,000 daltons.

In another embodiment of the process or processes outlined above, the concentrated solids-removed protein solution is diafiltered using water as the diafiltration solution or the solids-removed protein solution is diafiltered with water prior to concentration or the partially concentrated solids-removed protein solution is diafiltered with water then further concentrated.

In another embodiment of the process or processes outlined above, diafiltration is effected using from about 0.5 to about 40 volumes of diafiltration solution, preferably about 1 to about 25 volumes of diafiltration solution, more preferably about 1 to about 5 volumes of diafiltration solution.

In another embodiment of the process or processes outlined above, diafiltration is effected using the same membrane as for the concentration of the solids-removed protein solution or the diafiltration is effected using a separate membrane with a different molecular weight cut-off, such as a membrane having a molecular weight cut-off in the range of about 1,000 to about 100,000 daltons, preferably about 1,000 to about 10,000 daltons.

In another embodiment of the process or processes outlined above, the diafiltration solution comprises an antioxidant, such as ascorbic acid, optionally in an amount of from about 0.01 to about 1 wt %, preferably about 0.05 to about 0.15 wt %, more preferably about 0.05 to about 0.10 wt %.

In another embodiment of the process or processes outlined above, the concentration step and the diafiltration step for solids-removed protein solution are effected at generally about 2° to about 65° C., preferably about 50° to about 60° C.

In another embodiment of the process or processes outlined above, the protein solids and concentrated and/or diafiltered solids-removed protein solution are pasteurized individually or in combination by heating to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds and optionally combined if not combined previously, then optionally dried.

In another embodiment of the process or processes outlined above, the protein solids and concentrated and/or diafiltered solids-removed protein solution are dried and then dry blended.

In another embodiment of the process or processes outlined above, the optionally concentrated and optionally diafiltered acidified sunflower protein solution, the pH adjusted sunflower protein solution, the protein solids, the membrane processed solids-removed protein solution or the combined protein solids and membrane processed solids-removed protein solution is jet cooked to a temperature of about 110 to about 150° C. for a time of at least about 10 seconds, preferably about 10 seconds to about 1 minute, more preferably about 140 to about 145° C. for about 40 to about 50 seconds, prior to drying step (g).

In another embodiment of the process or processes outlined above, the process or processes further comprise the steps of: bi) further processing the separated residual sunflower protein source obtained in step b), such as to recover residual protein; and wherein step bi) optionally comprises re-extracting the separated residual sunflower protein source obtained in step b) with fresh extraction solution to recover residual protein and separating the re-extraction protein solution from the residual sunflower protein source and optionally combining the re-extraction protein solution with the aqueous sunflower protein solution for further processing.

In another embodiment of the process or processes outlined above, step a) is carried out using a counter-current extraction procedure.

In another embodiment of the process or processes outlined above, the finer residual solids are captured separately from the bulk of the separated residual sunflower protein source in step b), optionally using a disc stack centrifuge, are optionally diluted with water, optionally RO water, then optionally dried to form a sunflower protein product having a protein content of at least about 40 wt % (N×6.25) d.b., preferably at least about 45, 50, 55, 60 or 65 wt % (N×6.25) d.b., more preferably at least about 70 wt % (N×6.25) d.b.

In another embodiment of the process or processes outlined above, the pH of the optionally diluted finer solids is raised to a value between about 6.0 and about 8.0, preferably between about 6.5 and about 7.5, by any conventional means such as by the addition of sodium hydroxide, potassium hydroxide or any other conventional food grade alkali and combinations thereof, or hydrochloric acid, phosphoric acid, citric acid or any other conventional food grade acid and combinations thereof, prior to optional drying to form a sunflower protein product having a protein content of at least about 40 wt % (N×6.25) d.b., preferably at least about 45, 50, 55, 60 or 65 wt % (N×6.25) d.b., preferably at least about 70 wt % (N×6.25) d.b.

In another embodiment of the process or processes outlined above, the finer solids are washed in order to remove contaminants and improve the purity and flavour of the product, optionally by suspending the solids in between about 1 and about 20 volumes, preferably about 1 to about 10 volumes of wash solution such as water, preferably RO water, and optionally the washing step is conducted at any conventional temperature such as about 15° to about 65° C., preferably about 50° to about 60° C., and optionally for any conventional length of time, preferably 15 minutes or less. The washed finer solids are then separated from the used wash solution by any conventional means such as by centrifugation using a disc stack centrifuge.

In another embodiment of the process or processes outlined above, the wash solution separated from the washed finer solids is optionally added to the aqueous sunflower protein solution arising from the separation step b) for further processing.

In another embodiment of the process or processes outlined above, the separated used wash solution is defatted before addition to the aqueous sunflower protein solution.

In another embodiment of the process or processes outlined above, the washed finer solids are optionally diluted with water then optionally dried to provide a sunflower protein product having a protein content of at least about 40 wt % (N×6.25) d.b., preferably at least about 45, 50, 55, 60 or 65 wt % (N×6.25) d.b., preferably at least about 70 wt % (N×6.25) d.b.

In another embodiment of the process or processes outlined above, the pH of the optionally diluted washed finer residual solids is adjusted to a value between about 6.0 and about 8.0, preferably between about 6.5 and about 7.5, by any conventional means such as by the addition of sodium hydroxide, potassium hydroxide or any other conventional food grade alkali and combinations thereof, or hydrochloric acid, phosphoric acid, citric acid or any other conventional food grade acid and combinations thereof, prior to optional drying to form a sunflower protein product having a protein content of at least about 40 wt % (N×6.25) d.b., preferably at least about 45, 50, 55, 60 or 65 wt % (N×6.25) d.b., preferably at least about 70 wt % (N×6.25) d.b.

In another embodiment of the process or processes outlined above, the finer residual solids are pH adjusted during the washing step by adjusting the mixture of finer solids and wash water to a pH between about 6.0 and about 8.0, preferably between about 6.5 and about 7.5, using food grade alkali or acid solution, then collecting the solids by centrifugation and optionally diluting and optionally drying the solids.

In another embodiment of the process or processes outlined above, the process or processes further comprise pasteurizing the optionally diluted and optionally pH adjusted finer residual solids or optionally diluted and optionally pH adjusted washed finer residual solids prior to the optional drying step, wherein pasteurization optionally comprises heating to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds.

In another embodiment of the process or processes outlined above, the pasteurized optionally diluted and optionally pH adjusted finer residual solids or optionally diluted and optionally pH adjusted washed finer residual solids is cooled, such as to a temperature of about 20° to about 35° C.

In another embodiment of the process or processes outlined above, the optionally diluted and optionally pH adjusted finer residual solids or optionally diluted and optionally pH adjusted washed finer residual solids are jet cooked to a temperature of about 110 to about 150° C. for a time of at least about 10 seconds, preferably about 10 seconds to about 1 minute, more preferably about 140 to about 145° C. for about 40 to about 50 seconds, prior to drying step.

In another embodiment of the process or processes outlined above, the coarse residual solids are captured separately from the finer residual solids of the separated residual sunflower protein source in step b), optionally using a decanter centrifuge, are optionally diluted with water, optionally RO water, optionally pH adjusted to a value between about 6.0 and about 8.0, preferably between about 6.5 and about 7.5, optionally pasteurized then optionally dried to form a sunflower protein product having a protein content of at least about 25 wt % (N×6.25) d.b., preferably at least about 30, 35, 40 or 45 wt % (N×6.25) d.b., more preferably at least about 50 wt % (N×6.25) d.b.

In another embodiment of the process or processes outlined above, the optionally diluted and optionally pH adjusted coarse residual solids are jet cooked to a temperature of about 110 to about 150° C. for a time of at least about 10 seconds, preferably about 10 seconds to about 1 minute, more preferably about 140 to about 145° C. for about 40 to about 50 seconds, prior to drying.

In another embodiment of the process or processes outlined above, the coarse residual solids are captured separately from the finer residual solids of the separated residual sunflower protein source in step b), the finer residual solids are optionally washed, then the coarse residual solids and the optionally washed finer residual solids are combined for optional dilution with water, optional pasteurization and optional drying to form a sunflower protein product having a protein content of at least about 25, 30, 35, 40, 45, 50, 55, 60, 65 or 70 wt % (N×6.25) d.b.,

In another embodiment of the process or processes outlined above, the extraction is carried out in a continuous operation or a batch operation.

In a further embodiment, the present disclosure provides for a sunflower protein product having a protein content of at least about 60, at least about 65, at least about 70, at least about 75, at least about 80, at least about 85, at least about 90, or at least about 95 wt % (N×6.25) d.b., which has a protein solubility of less than about 30%, preferably between 14.4 and 22.2%, when measured at pH 4, less than about 20%, preferably between 8.5 and 14.9%, when measured at pH 5.5 and less than about 40%, preferably between 15.9 and 24.4%, when measured at pH 7.

In a further embodiment, the present disclosure provides for a sunflower protein product having a water binding capacity of about 4.0 to about 10.0 ml/g, preferably about 5.9 to about 9.0 ml/g, more preferably 5.96 to 8.95 ml/g.

In a further embodiment of the product or products outlined above, the product has a dry colour b* value of less than about 14.80, preferably less than about 14.00, more preferably no more than 13.94.

In a further embodiment, the present disclosure provides for a sunflower protein product having an in vitro protein digestibility of at least 99%.

In a further embodiment, the present disclosure provides for a sunflower protein product having an attribute from one or more of the following tables:
a protein content as defined in or captured by Table 3;
a protein solubility as defined in or captured by Table 4;
a dry colour as defined in or captured by Table 5;
a water binding capacity as defined in or captured by Table 6;
an oil binding capacity as defined in or captured by Table 7;
an amino acid profile comprising one or more amino acids as defined or captured by Table 8;
a chlorogenic acid content as defined or captured by Table 9;
a sodium content as defined or captured by Table 10;
an acid hydrolysis fat content as defined or captured by Table 11;
a foam overrun as defined in or captured by Table 12; and/or
a foam stability as defined in or captured by Table 13.

In a further embodiment of the sunflower protein product or products outlined above, the product or products are derived from confectionery (also known as non-oilseed) or black oil (also known as oilseed) or conoil sunflower seed.

In a further embodiment of the sunflower protein product or products outlined above, the product or products are derived from dehulled sunflower seed, also known as sunflower kernels.

In a further embodiment of the sunflower protein product or products outlined above, the product or products are derived from a partially or fully defatted sunflower protein source.

In a further embodiment, the present disclosure provides for a pet food, animal feed, industrial product, cosmetic product or personal care product comprising a sunflower protein product such as that produced by the process or processes outlined above and/or herein, or a sunflower protein product outlined above and/or herein.

In a further embodiment, the present disclosure provides for a food or beverage comprising a sunflower protein product such as that produced by the process or processes outlined above and/or herein, or a sunflower protein product outlined above and/or herein.

In a further embodiment of the food or beverage or beverages outlined above, the food or beverage is: a dairy alternative, a meat alternative, a seafood alternative, a grain product, a snack or sweet, a fats and oils product, a condiment or sauce, or a nutritional product.

In a further embodiment of the food or beverage or beverages outlined above, the dairy alternative is: a milk alternative beverage, a frozen dessert, a cheese alternative, or a yogurt alternative.

In a further embodiment of the food or beverage or beverages outlined above, the meat alternative is: a beef alternative, a pork alternative, or a poultry alternative.

In a further embodiment of the food or beverage or beverages outlined above, the seafood alternative is: a tuna alternative, a salmon alternative, or a shrimp alternative.

In a further embodiment of the food or beverage or beverages outlined above, the grain product is: a pasta, a bread, or a breakfast cereal.

In a further embodiment of the food or beverage or beverages outlined above, the snack or sweet is: a cookie, a cracker, a bar product, or a cake.

In a further embodiment of the food or beverage or beverages outlined above, the fats and oils product is: a margarine, or a dressing.

In a further embodiment of the food or beverage or beverages outlined above, the condiment or sauce is: a tomato based sauce, a non tomato based sauce, a dip; or a gravy.

In a further embodiment of the food or beverage or beverages outlined above, the nutritional product is: a nutritional drink; or a nutritional powder.

In a further embodiment of the food or beverage or beverages outlined above, the food or beverage is: a sports drink; an energy drink; or a smoothie.

In a further embodiment of the food or beverage or beverages outlined above, the food or beverage is a meat product.

In a further embodiment of the food or beverage or beverages outlined above, the meat product is an extended meat product and the cook yield is about equal to or greater than the cook yield when the same quantity of soy protein concentrate is used as the extender.

In a further embodiment, the present disclosure provides for a cooked or uncooked meat product comprising a sunflower protein product such as that produced by the process or processes outlined above and/or herein, or a sunflower protein product outlined above and/or herein.

In a further embodiment, the present disclosure provides for a sunflower protein product referred to herein as S871NDS2 or SF871PC.

In a further embodiment, the present disclosure provides for a food or beverage comprising the sunflower protein product or products outlined above and/or herein.

In a further embodiment, the present disclosure provides for a sunflower protein product having an amino acid profile comprising:

| Amino acid | Concentration (mg/g protein) |
|---|---|
| Threonine | about 29.9 to about 45.3 |
| Valine | about 40.4 to about 52.4 |
| Isoleucine | about 32.6 to about 42.5 |
| Leucine | about 50.8 to about 72.3 |
| Tyrosine | about 21.2 to about 30.6 |
| Phenylalanine | about 27.7 to about 56.2 |
| Lysine | about 23.6 to about 47.0 |
| Histidine | about 21.8 to about 26.2 |
| Cysteine | about 13.4 to about 34.2 |
| Methionine | about 16.0 to about 34.8 |
| Tryptophan | about 6.5 to about 13.1 |

In a further embodiment of the product or products outlined above, the product has an amino acid profile comprising:

| Amino acid | Concentration (mg/g protein) |
|---|---|
| Threonine | about 29.9 to about 37.9 |
| Valine | about 43.5 to about 49.0 |
| Isoleucine | about 38.1 to about 40.3 |
| Leucine | about 58.1 to about 64.1 |
| Tyrosine | about 22.3 to about 30.6 |
| Phenylalanine | about 49.4 to about 52.8 |
| Lysine | about 27.2 to about 28.5 |
| Histidine | about 25.0 to about 26.2 |
| Cysteine | about 14.2 to about 19.9 |
| Methionine | about 22.6 to about 24.5 |
| Tryptophan | about 10.4 to about 11.4 |

In a further embodiment, the present disclosure provides for a sunflower protein product having an amino acid profile comprising:

| Amino acid | Concentration (mg/g protein) |
|---|---|
| Tyrosine | about 21.2 to about 30.6 |
| Cysteine | about 13.4 to about 34.2 |

In a further embodiment of the product or products outlined above, the product has an amino acid profile comprising:

| Amino acid | Concentration (mg/g protein) |
|---|---|
| Tyrosine | about 21.2 to about 26.0 |
| Cysteine | about 21.5 to about 27.8 |

In a further embodiment, the present disclosure provides for a sunflower protein product having a chlorogenic acid content of less than about 1500 ppm on a dry basis, preferably less than about 1000 ppm on a dry basis, more preferably no more than 973 ppm on a dry basis.

In a further embodiment of the product or products outlined above, the product has a protein content of less than about 60 wt % (N×6.25) d.b., preferably less than about 50 wt % (N×6.25) d.b.

### DETAILED DESCRIPTION

One or more illustrative embodiments have been described by way of example. It will be appreciated that embodiments and examples are provided for illustrative purposes intended for those skilled in the art, and are not meant to be limiting in any way. All references to embodiments, examples, aspects, compounds, food products, compositions, solutions and the like is intended to be illustrative and non-limiting.

The initial step of the process of providing the sunflower protein products as disclosed herein involves solubilizing sunflower protein from a sunflower protein source. The sunflower protein source may be any variety of sunflower seed used for human food or animal feeding purposes. Confectionery (also known as non-oilseed), black oil (also known as oilseed) and conoil types of sunflower seed may be used. The sunflower protein source may be used in the full fat form, partially defatted form (e.g. pressed cake/meal) or fully defatted form (e.g. pressed and solvent extracted meal). For the purpose of this disclosure, the terms “cake” and “meal” are used interchangeably. “Cake” is generally yielded from pressing and the solvent extraction of the cake yields a “meal”. Meal may also be considered a ground presscake. Pressed sunflower, encompassed by the terms “cake” and “meal” may be added to extraction solution without a grinding step when it is generally soft enough that it fragments when mixed with water or other appropriate solvent or liquid. The sunflower protein source may contain hulls (i.e. derived from seeds with hulls) or may be dehulled material (i.e. derived from seeds with the hulls removed, also known as kernels). Preferably the sunflower protein source is dehulled and defatted prior to use in the processes described herein. Where the sunflower protein source contains an appreciable amount of fat, an oil removal step may be required during the process. The particle size of the sunflower protein source may vary but it is preferred that the sunflower protein source is in the form of granules or a powder to facilitate more rapid wetting and more thorough mixing with the extraction solution. As mentioned above, some sunflower protein sources, such as certain cakes/meals from pressing may fragment when mixed with extraction solution. The sunflower protein source may also be ground before the extraction step to achieve a desired particle size. Ground sunflower protein source may be referred to as a flour. The sunflower protein recovered from the sunflower protein source may be the protein naturally occurring in the sunflower seed or the proteinaceous material may be a protein modified by genetic manipulation but possessing characteristic hydrophobic and polar properties of the natural protein.

The sunflower protein products of the present disclosure may be prepared from sunflower protein source by either a batch process or a continuous process or a semi-continuous process. Protein solubilization from the sunflower protein source material may be effected using water. The water used may be tap water (e.g. city water) or water having different levels of purity. Reverse osmosis (RO) purified water is preferred.

The pH of the extraction may be the natural pH of the combination of the water and the sunflower protein source, or the pH of the extraction may be adjusted up to any value between the natural pH and about 8.5, preferably the pH is adjusted within the range of about 6.8 to about 8.0, more preferably the pH is adjusted to about 6.8 to about 7.5. Suitable pH values for the extraction encompass the natural pH and include about 6.8 to about 8.5 or any value therebetween (optionally rounded to the nearest 0.1), or any subrange spanning between any two of these values, such as 6.8 to 8.0. For example, pH values of 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, and others are considered. Food grade sodium hydroxide, potassium hydroxide or any other conventional food grade alkali and combinations thereof may be added to the water to adjust the pH of the extraction as required. The food grade alkali is preferably added in aqueous solution form.

The solubilization of the protein may be effected at a temperature of from about 1° to about 100° C., preferably about 15° to about 65° C., more preferably about 50° C. to about 60° C., preferably accompanied by agitation to decrease the solubilization time, which is usually about 1 to about 60 minutes, preferably about 10 to about 30 minutes. It is preferred to effect the solubilization to extract substantially as much protein from the sunflower protein source as is practicable, so as to provide an overall high product yield. The pH values of the extraction and subsequent steps refer to values typically measured at room temperature (21-24° C.). For absence of doubt, when, for example, the extraction is conducted at an elevated temperature, the pH of the extraction mixture is such that a sample of extraction mixture cooled to room temperature has a pH reading in the specified range.

Extraction of the protein from the sunflower protein source, when conducted in a continuous operation, may be carried out in any manner consistent with effecting a continuous extraction of protein from the sunflower protein source. In one embodiment, the sunflower protein source is continuously mixed with the water and the mixture is conveyed through a pipe or conduit having a length and at a flow rate for a residence time sufficient to effect the desired extraction in accordance with the parameters described herein.

The concentration of sunflower protein source in the water during the solubilization step may vary widely. Typical concentration values are about 5 to about 20% w/v, preferably about 5 to about 15% w/v.

It will be appreciated that reference to solubilizing encompasses both complete and partial solubilization of the protein from the sunflower protein source.

The protein extraction step has the additional effect of solubilizing fats which may be present in the sunflower protein source, which then results in the fats being present in the aqueous phase.

The protein solution resulting from the extraction step may have a protein concentration of about 0.5 to about 5 wt %, preferably about 1 to about 5 wt %.

The water of extraction may contain an antioxidant. The antioxidant may be any conventional antioxidant, such as ascorbic acid or sodium sulfite. Preferably the antioxidant is ascorbic acid. The quantity of antioxidant employed may vary from about 0.01 to about 1 wt % of the solution, preferably about 0.05 to about 0.15 wt %, more preferably about 0.05 to about 0.10 wt %. The antioxidant serves to inhibit oxidation of phenolics present in the protein solution and preferably inhibits the development of green colouration that may occur in sunflower protein solutions at alkaline pH.

The aqueous phase resulting from the extraction step then may be separated from the residual sunflower protein source, in any conventional manner, such as by centrifugation and/or filtration. Preferably the aqueous phase resulting from the extraction step is separated from the bulk of the residual sunflower protein source (coarse residual solids) using a decanter centrifuge and the resulting centrate is further clarified using a disc stack centrifuge to remove finer residual solids. The coarse and finer residual solids may be further processed separately to provide separate products disclosed herein and as described in greater detail starting in paragraph [00168] (finer residual solids) and paragraph [00173] (coarse residual solids). Preferably the coarse and finer solids are combined before or after further processing to provide a combined solids product. The coarse or combined residual solids may also be further processed to recover residual protein. When the coarse or combined residual solids are further processed to recover residual protein, the residual protein may be recovered by re-extracting the separated coarse or combined residual sunflower protein source with fresh water and the protein solution yielded upon separation as described above combined with the initial protein solution for further processing as described below. A counter-current extraction procedure may also be utilized. The separated coarse or combined residual sunflower protein source may alternatively be processed by any other conventional procedure to recover residual protein. Coarse and finer residual solids captured in the re-extraction or counter current extraction procedures may be further processed separately to provide separate products disclosed herein and, for example, as described in greater detail starting in paragraph [00168] (finer residual solids) and paragraph [00173] (coarse residual solids). Preferably the coarse and finer residual solids are combined before or after further processing to provide a combined solids product. Utilizing the re-extraction or counter current extraction procedures may result in a lower quantity of chlorogenic acid, such as less than 1500 ppm d.b., preferably less than 1000 ppm d.b., more preferably less than 600 ppm d.b., in the residual solids compared to a single extraction. Lower chlorogenic acid content in the residual solids may result in better colour/quality for the products derived from the residual solids. The separation step may be conducted at the same temperature as the extraction step or at any temperature within the range of about 1° to about 100° C., preferably about 15° to about 65° C., more preferably about 50° to about 60° C. When the separation is done in more than one step (e.g. employing decanter centrifuge then disc stack centrifuge), different temperatures within the abovementioned range may employed for each step of the separation process.

It will be appreciated that reference herein to a separation step and to separation of the aqueous phase and residual sunflower protein source is intended to refer to both complete separation as well as to at least partial separation. It is to be understood that trace or minor amounts of residual components may be found in the aqueous phase, for example but not limited to: coarse residual solids, finer residual solids, and/or fat/oil.

The aqueous sunflower protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer in the quantity described may be added in the extraction steps.

The separated aqueous sunflower protein solution may be subject to a defatting operation, if desired or required. Defatting of the separated aqueous sunflower protein solution may be achieved by any conventional procedure such as centrifugation and/or filtration. A three-phase centrifuge such as a three-phase separator may be used for the simultaneous separation of fat and residual solids from the protein solution with the three-phase centrifuge potentially being used instead of or in addition to the separation steps already described above. When a three-phase centrifuge is used in addition to the decanter and disc stack centrifuge described above, the order in which the disc stack and three-phase centrifuge steps are applied to the post-decanter protein solution may be varied. Solids collected by the three-phase centrifuge may be disposed of or further processed, alone or in combination with solids collected from the decanter centrifuge and/or disc stack centrifuge.

The aqueous sunflower protein solution may be treated with an adsorbent, such as granulated activated carbon, to remove colour and/or odour compounds. Such adsorbent treatment may be carried out under any conventional conditions, generally at the ambient temperature of the separated aqueous protein solution.

The aqueous sunflower protein solution is adjusted in pH to an acidic value in the range of about pH 1.5 to about pH 5.0, preferably about pH 2.0 to about pH 3.0. The pH of the aqueous sunflower protein solution may be adjusted by the addition of any food grade acid such as food grade hydrochloric acid solution or food grade phosphoric acid solution. Food grade organic acids such as citric acid may also be used. Suitable pH values for the acidified protein solution include a range of about 1.5 to about 5.0 or any value therebetween (optionally rounded to the nearest 0.1), or any subrange spanning between any two of these values, such as 2.0 to 3.0. For example, pH values of 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, and others are considered. The low pH of the acidified aqueous sunflower protein solution is believed to improve the flux rate of subsequent membrane processing. The low pH is also believed to have a positive impact on the colour and flavour of the sunflower protein product provided by the process.

The acidified aqueous sunflower protein solution may be subjected to a heat treatment to potentially aid to inactivate heat labile anti-nutritional factors, which may include trypsin inhibitors, present in such solution as a result of extraction from the sunflower protein source material during the extraction step. Such a heating step may also provide the additional benefit of reducing the microbial load. Generally, the protein solution is heated to a temperature of about 70° to about 160° C. for about 10 seconds to about 60 minutes, preferably about 80° to about 120° C. for about 10 seconds to about 5 minutes, more preferably about 85° to about 95° C. for about 30 seconds to about 5 minutes. The heat treated acidified sunflower protein solution then may be cooled for further processing as described below, to a temperature of about 2° to about 65° C., preferably about 50° C. to about 60° C.

If of adequate purity, the acidified aqueous sunflower protein solution may be directly dried to produce a sunflower protein product having a protein content of greater than 60 wt % (N×6.25) d.b. To provide a sunflower protein product having a decreased impurities content, such as a sunflower protein isolate, the acidified aqueous sunflower protein solution may be processed as described below prior to drying. Further processing as described below is also believed to have a beneficial effect on the flavour of the product.

The acidified aqueous sunflower protein solution may be concentrated to provide a concentrated acidified sunflower protein solution having a protein concentration of about 5 to about 30 wt %, preferably about 5 to about 20 wt %, more preferably about 10 to about 20 wt %. It will be appreciated that concentrations of less than about 5 wt % may be considered as partially concentrated. Suitable protein concentrations include a range of about 5 to about 30 wt % or any value therebetween (optionally rounded to the nearest 0.1), or any subrange spanning between any two of these values, such as about 10 to about 20 wt %. For example, values of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 wt % and others are considered.

The concentration step may be effected in any conventional manner consistent with batch or continuous operation, such as by employing any conventional selective membrane technique, such as ultrafiltration or diafiltration, using membranes, such as hollow-fibre membranes or spiral-wound membranes, with a suitable molecular weight cut-off, such as about 1,000 to about 1,000,000 daltons, preferably about 1,000 to about 100,000 daltons, more preferably about 10,000 to about 100,000 daltons having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass therethrough while preventing higher molecular weight species from so doing. The low molecular weight species include low molecular weight materials extracted from the source material, such as carbohydrates, pigments, low molecular weight proteins and anti-nutritional factors, such as trypsin inhibitors, which are themselves low molecular weight proteins. The molecular weight cut-off of the membrane is usually chosen to ensure retention of a significant proportion of the protein in the solution, while permitting contaminants to pass through having regard to the different membrane materials and configurations.

The concentrated acidified sunflower protein solution then may be subjected to a diafiltration step using water as the diafiltration solution. The water may be used as the diafiltration solution without any pH adjustment or the water may be adjusted with any food grade acid to a pH down to that of the concentrated acidified sunflower protein solution. The diafiltration may be done in stages using water at different pH values, such as initial volumes of diafiltration using water adjusted to the pH of the protein solution followed by additional volumes of diafiltration using water without pH adjusting agent. In general, diafiltration may be effected using from about 0.5 to about 40 volumes of diafiltration solution, preferably about 2 to about 25 volumes of diafiltration solution, more preferably about 2 to about 5 volumes of diafiltration solution. Suitable numbers of diafiltration volumes include a range of about 0.5 to about 40 or any value therebetween (optionally rounded to the nearest 0.1), or any subrange spanning between any two of these values, such as about 2 to about 25. For example, values of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 and others are considered. In the diafiltration operation, further quantities of contaminants are removed from the aqueous acidified sunflower protein solution by passage through the membrane with the permeate. This purifies the aqueous protein solution and may also reduce its viscosity. The diafiltration operation may be effected until no significant further quantities of contaminants or visible colour are present in the permeate or until the retentate has been sufficiently purified so as to provide a sunflower protein isolate with a protein content of at least about 90 wt % (N×6.25) d.b. Such diafiltration may be effected using the same membrane as for the concentration step. However, if desired, the diafiltration step may be effected using a separate membrane with a different molecular weight cut-off, such as a membrane having a molecular weight cut-off in the range of about 1,000 to about 1,000,000 daltons, preferably about 1,000 to about 100,000 daltons, more preferably about 10,000 to about 100,000 daltons, having regard to different membrane materials and configuration.

Alternatively, the diafiltration step may be applied to the acidified aqueous protein solution prior to concentration or to partially concentrated acidified aqueous protein solution. Diafiltration may also be applied at multiple points during the concentration process. When diafiltration is applied prior to concentration or to the partially concentrated solution, the resulting diafiltered solution may then be additionally concentrated. Diafiltering multiple times as the protein solution is concentrated may allow a higher final, fully concentrated protein concentration to be achieved. This may reduce the volume of material to be dried.

The concentration step and the diafiltration step may be effected herein in such a manner that the sunflower protein product subsequently recovered contains less than about 90 wt % protein (N×6.25) d.b., such as at least about 60 wt % protein (N×6.25) d.b. By partially concentrating and/or partially diafiltering the acidified aqueous sunflower protein solution, it is possible to only partially remove contaminants. This protein solution may then be dried to provide a sunflower protein product with lower levels of purity.

An antioxidant may be present in the diafiltration water during at least part of the diafiltration step. The antioxidant may be any conventional antioxidant, such as ascorbic acid or sodium sulfite. Preferably the antioxidant is ascorbic acid. The quantity of antioxidant employed in the diafiltration water depends on the materials employed and may vary from about 0.01 to about 1 wt %, preferably about 0.05 to about 0.15 wt %, more preferably about 0.05 to about 0.10 wt %. The antioxidant serves to inhibit oxidation of phenolics present in the protein solution.

The optional concentration step and the optional diafiltration step may be effected at any conventional temperature, generally about 2° to about 65° C., preferably about 50° to about 60° C., and for the period of time to effect the desired degree of concentration and diafiltration. The temperature and other conditions used to some degree depend upon the membrane equipment used to effect the membrane processing, the desired protein concentration of the solution and the efficiency of the removal of contaminants to the permeate.

As alluded to earlier, sunflowers can contain anti-nutritional trypsin inhibitors. The level of trypsin inhibitor activity in the final sunflower protein product can be controlled by the manipulation of various process variables.

As noted above, heat treatment of the acidified aqueous sunflower protein solution may be used to potentially aid to inactivate heat-labile trypsin inhibitors. The partially concentrated or fully concentrated acidified sunflower protein solution may also be heat treated to potentially inactivate heat labile trypsin inhibitors. When the heat treatment is applied to the partially concentrated acidified sunflower protein solution, the resulting heat-treated solution may then be additionally concentrated.

The concentration and/or diafiltration steps may be operated in a manner favourable for removal of trypsin inhibitors in the permeate along with the other contaminants. Removal of the trypsin inhibitors is promoted by using a membrane of larger MWCO, such as 30,000 to 1,000,000 Da, operating the membrane at elevated temperatures, such as about 30° to about 65° C., preferably about 50° to about 60° C. and employing greater volumes of diafiltration medium, such as 10 to 40 volumes.

Acidifying and membrane processing the sunflower protein solution at a lower pH, such as 1.5 to 2.5, may reduce the trypsin inhibitor activity relative to processing the solution at higher pH, such as 2.5 to 5.0. When the acidified protein solution is concentrated and/or diafiltered at the low end of the pH range, it may be desired to raise the pH of the solution within the aforementioned acid pH range prior to drying. The pH of the concentrated and/or diafiltered protein solution may be raised to the desired value, for example pH 3, by the addition of any conventional food grade alkali, such as sodium hydroxide, potassium hydroxide and combinations thereof. The food grade alkali is preferably added in aqueous solution form.

Further, a reduction in trypsin inhibitor activity may be achieved by exposing sunflower materials to reducing agents that disrupt or rearrange the disulfide bonds of the inhibitors. Suitable reducing agents include, but are not limited to, sodium sulfite, cysteine and N-acetylcysteine.

The addition of such reducing agents may be effected at various stages of the overall process. The reducing agent may be added with the sunflower protein source material in the extraction step, may be added to the aqueous sunflower protein solution following removal of residual sunflower protein source material, may be added to the diafiltered retentate before drying or may be dry blended with the dried sunflower protein product. The addition of the reducing agent may be combined with the heat treatment and/or membrane processing steps, as described above.

If it is desired to retain active trypsin inhibitors in the protein solution, this can be achieved by not utilizing reducing agents, utilizing a concentration and diafiltration membrane with a smaller molecular weight cut-off, operating the membrane at lower temperatures and employing fewer volumes of diafiltration medium.

The optionally concentrated and optionally diafiltered acidified protein solution may be subject to a further defatting operation, if required. Defatting of the optionally concentrated and optionally diafiltered acidified protein solution may be achieved by any conventional procedure.

The optionally concentrated and optionally diafiltered acidified protein solution may be treated with an adsorbent, such as granulated activated carbon, to remove colour and/or odour compounds. Such adsorbent treatment may be carried out under any conventional conditions, generally at the ambient temperature of the protein solution.

The optionally concentrated and optionally diafiltered acidified protein solution may be pasteurized prior to drying or further processing. Such pasteurization may be effected under any conventional pasteurization conditions. Generally, the optionally concentrated and optionally diafiltered acidified sunflower protein solution is heated to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds. The pasteurized sunflower protein solution then may be cooled, such as to a temperature of about 20° to about 35° C.

The optionally concentrated, optionally diafiltered and optionally pasteurized acidified sunflower protein solution then may be dried by any conventional means such as spray drying or freeze drying to provide a sunflower protein product. Alternatively, the optionally concentrated, optionally diafiltered and optionally pasteurized acidified sunflower protein solution may be raised in pH to a value of less than about 8.0, preferably about 6.0 to about 8.0, more preferably about 6.5 to about 7.5, to form a pH adjusted sunflower protein solution, prior to optional drying. Suitable pH values for the pH adjusted protein solution include a range of about 6.0 to about 8.0 or any value therebetween (optionally rounded to the nearest 0.1), or any subrange spanning between any two of these values, such as about 6.5 to about 7.5. For example, values of 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0 and others are considered. The pH may be raised in any conventional manner such as by the addition of sodium hydroxide, potassium hydroxide or any other conventional food grade alkali and combinations thereof. The food grade alkali is preferably added in aqueous solution form. If the protein solution is not pasteurized before pH adjustment, the pasteurization may be conducted after the pH adjustment using the conditions described above.

As a further alternative, the pH adjusted sunflower protein solution may be further processed to remove additional impurities including salts formed in the pH adjustment step prior to optional pasteurization and optional drying as described above. One means of removing the additional impurities including salts formed in the pH adjustment step is to subject the material to membrane processing such as a concentration step and/or a diafiltration step using water. The concern with this approach is that the pH adjustment step can cause protein to come out of solution and the resulting suspended solids may cause membrane fouling and reduce processing efficiency. This issue may be overcome by applying a separation step to collect the suspended protein material (protein solids) and allow more efficient membrane processing of the remaining solids-removed protein solution.

Separation of the pH adjusted sunflower protein solution into protein solids and solids-removed protein solution may be achieved in any conventional manner, such as by centrifugation and/or filtration. The pH adjusted protein solution may be diluted with water prior to the separation step. Alternatively, the optionally concentrated, optionally diafiltered and optionally pasteurized acidified sunflower protein solution may be diluted with water prior to adjustment of the pH to a value of less than about 8.0, preferably about 6.0 to about 8.0, more preferably about 6.5 to about 7.5, to form a pH adjusted sunflower protein solution, which is then separated into protein solids and solids-removed protein solution.

The solids-removed protein solution may be concentrated using any conventional selective membrane technique, such as ultrafiltration or diafiltration, in batch or continuous operation, using membranes, such as hollow-fibre membranes or spiral-wound membranes, with a suitable molecular weight cut-off, such as about 1,000 to about 100,000 daltons, preferably about 1,000 to about 10,000 daltons, having regard to differing membrane materials and configurations, and, for continuous operation, dimensioned to permit the desired degree of concentration as the aqueous protein solution passes through the membranes.

The concentrated solids-removed protein solution then may be subjected to a diafiltration step using water as the diafiltration solution. In general, diafiltration may be effected using from about 0.5 to about 40 volumes of diafiltration solution, preferably about 1 to about 25 volumes of diafiltration solution, more preferably about 1 to about 5 volumes of diafiltration solution. Suitable numbers of diafiltration volumes include a range of about 0.5 to about 40 or any value therebetween (optionally rounded to the nearest 0.1), or any subrange spanning between any two of these values, such as about 2 to about 25. For example, values of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 and others are considered. Such diafiltration may be effected using the same membrane as for the concentration step. However, if desired, the diafiltration step may be effected using a separate membrane with a different molecular weight cut-off, such as a membrane having a molecular weight cut-off in the range of about 1,000 to about 100,000 daltons, preferably about 1,000 to about 10,000 daltons, having regard to different membrane materials and configuration.

Alternatively, the diafiltration step may be applied to the solids-removed protein solution prior to concentration or to partially concentrated solids-removed protein solution. Diafiltration may also be applied at multiple points during the concentration process. When diafiltration is applied prior to concentration or to the partially concentrated solution, the resulting diafiltered solution may then be additionally concentrated. Diafiltering multiple times as the protein solution is concentrated may allow a higher final, fully concentrated protein concentration to be achieved. This may reduce the volume of material to be dried.

An antioxidant may be present in the diafiltration water during at least part of the diafiltration step. The antioxidant may be any conventional antioxidant, such as ascorbic acid or sodium sulfite. Preferably the antioxidant is ascorbic acid. The quantity of antioxidant employed in the diafiltration water depends on the materials employed and may vary from about 0.01 to about 1 wt %, preferably about 0.05 to about 0.15 wt %, more preferably about 0.05 to about 0.10 wt %. The antioxidant serves to inhibit oxidation of phenolics present in the solids-removed protein solution and preferably inhibits the development of green colouration that may occur in sunflower protein solutions at alkaline pH.

The optional concentration step and the optional diafiltration step may be effected at any conventional temperature, generally about 2° to about 65° C., preferably about 50° to about 60° C., and for the period of time to effect the desired degree of concentration and diafiltration. The temperature and other conditions used to some degree depend upon the membrane equipment used to effect the membrane processing, the desired protein concentration of the solution and the efficiency of the removal of contaminants to the permeate.

The protein solids, may be optionally diluted, optionally pasteurized under the conditions described above and optionally dried. The membrane processed solids-removed protein solution may be pasteurized under the conditions described above and optionally dried. The protein solids may also be combined with the membrane processed solids-removed protein solution before pasteurization and the mixture pasteurized or after the individual fractions have been pasteurized. The combined protein solids and membrane processed solids-removed protein solution may be optionally dried. The dried optionally washed protein solids and dried membrane processed solids-removed protein solution may also be combined by dry-blending.

As a further alternative, the optionally concentrated and optionally diafiltered acidified sunflower protein solution or the pH adjusted sunflower protein solution or the optionally washed protein solids or the membrane processed solids-removed protein solution or the combined optionally washed protein solids and membrane processed solids-removed protein solution may be jet cooked prior to drying in order to modify the functional properties of the protein product. In such jet cooking, the material may be heated to a temperature of about 110 to about 150° C. for a time of at least about 10 seconds, preferably about 10 seconds to about 1 minute. More preferably the material is heated to about 140° C. to 145° C. for about 40 to 50 seconds.

Sunflower protein product prepared from the aqueous sunflower protein solution (prepared with or without the pH adjustment step, including product derived from the protein solids and product derived from the solids-removed protein solution, alone or in combination) has a protein content greater than about 60 wt % (N×6.25) d.b. Preferably the sunflower protein product has a protein content greater than about 65, 70, 75, 80 and 85 wt % (N×6.25) d.b. Most preferably, the sunflower protein product is an isolate with a protein content in excess of about 90 wt % protein (N×6.25) d.b. Suitable protein content values include a range of about 60-100 wt % or higher, or any value therebetween (optionally rounded to the nearest 0.1), or any subrange spanning between any two of these values, such as 65-95 wt %. For example, values of 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 wt % and others are considered. Note, it will be appreciated that values higher than 100% are possible due, for example, to the calculation to convert nitrogen determined to percent protein (N×6.25) (see for example the results in Table 3).

The sunflower protein products prepared from the aqueous sunflower protein solution (including product derived from the protein solids and product derived from the solids-removed protein solution, alone or in combination) have organoleptic and functional properties making them suitable for use in various food and beverage products including but not limited to dairy alternatives (for example milk alternative beverages, frozen desserts, plant based cheese, yogurt alternative products and the like), meat alternatives (for example beef alternatives, pork alternatives, poultry alternatives and the like), seafood alternatives (for example tuna alternatives, salmon alternatives, shrimp alternatives and the like), grain products (for example pastas, breads, breakfast cereals and the like), snacks and sweets (for example cookies, crackers, bars, cakes, candies, chocolates and the like), beverages (for example sports drinks, energy drinks, smoothies and the like), fats and oils products (for example margarines, dressings and the like), condiments and sauces (for example tomato based or non-tomato based sauces, dips, gravies and the like) and nutritional products (for example drinks, powders and the like). The sunflower protein products prepared from the aqueous sunflower protein solution are rich in sulfur containing amino acids. The sunflower protein products may be formulated into a functional food or beverage. The sunflower protein products may be formulated into a food or beverage product to provide protein fortification. The sunflower protein products may be formulated into a food or beverage product to replace other protein ingredients (including as an extender in meat or dairy products) or to replace non-protein functional ingredients. Sunflower protein product derived from the residual solids fractions may be particularly useful as a meat extender. Other uses of the sunflower protein products are in pet foods, animal feed and in industrial, cosmetic and personal care products.

In accordance with another aspect of the present disclosure, the finer residual solids captured by the disc stack centrifuge in the initial separation step may be further processed to provide a sunflower protein product. The finer solids may be optionally diluted with water then optionally dried to form a sunflower protein product having a protein content of at least about 40 wt % (N×6.25) d.b., preferably at least about 45, 50, 55, 60 or 65 wt % (N×6.25) d.b., more preferably at least about 70 wt % (N×6.25) d.b. Alternatively, the pH of the optionally diluted finer residual solids may be adjusted to a value between about pH 6.0 and about 8.0, preferably about pH 6.5 to about 7.5, by any conventional means such as by the addition of sodium hydroxide, potassium hydroxide or any other conventional food grade alkali and combinations thereof or the addition of hydrochloric acid, phosphoric acid, citric acid or any other conventional food grade acid and combinations thereof as needed prior to optional drying to form a sunflower protein product having a protein content of at least about 40 wt % (N×6.25) d.b., preferably at least about 45, 50, 55, 60, or 65 wt % (N×6.25) d.b., more preferably at least about 70 wt % (N×6.25) d.b. Suitable pH values for the pH adjusted finer residual solids include a range of about 6.0 to about 8.0 or any value therebetween (optionally rounded to the nearest 0.1), or any subrange spanning between any two of these values, such as about 6.5 to about 7.5. For example, values of 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0 and others are considered. The food grade alkali or acid is preferably added in aqueous solution form.

Preferably, the finer residual solids are washed in order to remove contaminants and improve the purity and flavour of the product. The finer residual solids may be washed by suspending the solids in between about 1 and about 20 volumes, preferably about 1 to about 10 volumes of water, preferably RO water. The washing step may be conducted at any conventional temperature such as about 15° to about 65° C., preferably about 50° to about 60° C. The finer residual solids may be mixed with the wash solution for any conventional length of time, preferably 15 minutes or less. The washed finer residual solids may then be separated from the used wash solution by any conventional means such as by centrifugation using a disc stack centrifuge. The used wash solution may optionally be defatted then added to the protein solution arising from the initial separation step for further processing as described above. Alternatively, the used wash solution may optionally be defatted then added to the optionally concentrated and optionally diafiltered acidified protein solution prior to pH adjustment and further processing as described above. The washed finer residual solids may be optionally diluted with water then optionally dried by any conventional means such as spray drying or freeze drying to provide a sunflower protein product having a protein content of at least about 40 wt % (N×6.25) d.b., preferably about 45, 50, 55, 60 or 65 wt % (N×6.25) d.b., more preferably about 70 wt % (N×6.25) d.b. Alternatively, the pH of the optionally diluted washed finer residual solids may be adjusted to a value between about 6.0 and about 8.0, preferably about 6.5 and about 7.5, by any conventional means such as by the addition of sodium hydroxide, potassium hydroxide or any other conventional food grade alkali and combinations thereof or the addition of hydrochloric acid, phosphoric acid, citric acid or any other conventional food grade acid and combinations thereof as needed, prior to optional drying to provide a sunflower protein product having a protein content of at least about 40 wt % (N×6.25) d.b., preferably about 45, 50, 55, 60 or 65 wt % (N×6.25) d.b., more preferably about 70 wt % (N×6.25) d.b. As a further alternative, the finer residual solids may be pH adjusted during the washing step by adjusting the mixture of finer residual solids and wash water to a pH between about 6.0 and about 8.0 using food grade alkali or acid as needed, then collecting the solids by centrifugation and optionally drying the solids. Suitable pH values for the pH adjusted washed finer residual solids include a range of about 6.0 to about 8.0 or any value therebetween (optionally rounded to the nearest 0.1), or any subrange spanning between any two of these values, such as about 6.5 to about 7.5. For example, values of 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0 and others are considered. The food grade alkali or acid is preferably added in aqueous solution form.

A pasteurization step may be employed on the optionally diluted and optionally pH adjusted finer residual solids or optionally diluted and optionally pH adjusted washed finer residual solids prior to the optional drying step. Such pasteurization may be effected under any conventional pasteurization conditions. Generally, the optionally diluted and optionally pH adjusted finer residual solids or optionally diluted and optionally pH adjusted washed finer residual solids are heated to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds. The pasteurized optionally diluted and optionally pH adjusted finer residual solids or optionally diluted and optionally pH adjusted washed finer residual solids then may be cooled, such as to a temperature of about 20° to about 35° C.

The optionally diluted and optionally pH adjusted finer residual solids or optionally diluted and optionally pH adjusted washed finer residual solids may be jet cooked prior to drying in order to modify the functional properties of the protein product. In such jet cooking, the protein solution may be heated to a temperature of about 110 to about 150° C. for a time of at least about 10 seconds, preferably about 10 seconds to about 1 minute. More preferably the product is heated to about 135° C. to about 145° C. for about 40 to 50 seconds.

The product derived from the finer residual solids may be used in food and beverage applications as described above for the sunflower protein product prepared from the aqueous sunflower protein solution. Other uses of the sunflower protein product derived from the finer residual solids are in pet foods, animal feed and in industrial, cosmetic and personal care products.

In accordance with another aspect of the present disclosure, the coarse residual solids captured by the decanter centrifuge in the initial separation step may be further processed to provide a sunflower protein product. The coarse residual solids may be optionally diluted with water, preferably RO water, then optionally dried to form a sunflower protein product having a protein content of at least about 25 wt % (N×6.25) d.b., preferably at least about 30, 35, 40 or 45 wt % (N×6.25) d.b., more preferably at least about 50 wt % (N×6.25) d.b. Alternatively, the pH of the optionally diluted coarse residual solids may be adjusted to a value between the about 6.0 and about 8.0, preferably about 6.5 and about 7.5, by any conventional means such as by the addition of sodium hydroxide, potassium hydroxide or any other conventional food grade alkali and combinations thereof or the addition of hydrochloric acid, phosphoric acid, citric acid or any other conventional food grade acid and combinations thereof as needed prior to optional drying to form a sunflower protein product having a protein content of at least about 25 wt % (N×6.25) d.b., preferably at least about 30, 35, 40 or 45 wt % (N×6.25) d.b., more preferably at least about 50 wt % (N×6.25) d.b. Suitable pH values for the pH adjusted coarse residual solids include a range of about 6.0 to about 8.0 or any value therebetween (optionally rounded to the nearest 0.1), or any subrange spanning between any two of these values, such as about 6.5 to about 7.5. For example, values of 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0 and others are considered. The food grade alkali or acid is preferably added in aqueous solution form.

A pasteurization step may be employed on the optionally diluted and optionally pH adjusted coarse residual solids prior to the optional drying step. Such pasteurization may be effected under any conventional pasteurization conditions. Generally, the optionally diluted and optionally pH adjusted coarse residual solids are heated to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds. The pasteurized optionally diluted and optionally pH adjusted coarse residual solids then may be cooled, such as to a temperature of about 20° to about 35° C.

The optionally diluted and optionally pH adjusted coarse residual solids may be jet cooked prior to drying in order to modify the functional properties of the protein product. In such jet cooking, the protein solution may be heated to a temperature of about 110 to about 150° C. for a time of at least about 10 seconds, preferably about 10 seconds to about 1 minute. More preferably the product is heated to about 135° C. to about 145° C. for about 40 to 50 seconds.

The product derived from the coarse residual solids may be used in food and beverage applications as described above for the sunflower protein product prepared from the aqueous sunflower protein solution. Other uses of the sunflower protein product derived from the finer solids are in pet foods, animal feed and in industrial, cosmetic and personal care products. When the coarse residual solids are used as a food ingredient, the sunflower protein source material is typically dehulled material.

In accordance with another aspect of the present disclosure, the coarse residual solids captured by the decanter centrifuge and the finer residual solids captured by the disc stack centrifuge in the initial separation step are optionally processed as described above then combined to form a sunflower protein product having a protein content of at least about 25, 30, 35, 40, 45, 50, 55, 60, 65 or 70 wt % (N×6.25) d.b. If not already pH adjusted, pasteurized, jet cooked or dried before combination, these steps may be applied to the combined solids as described for the processing of the individual solids fractions.

The combined residual solids product may be used in food and beverage applications as described above for the sunflower protein product prepared from the aqueous sunflower protein solution. Other uses of the combined residual solids product are in pet foods, animal feed and in industrial, cosmetic and personal care products. When the combined residual solids are used as a food ingredient, the sunflower protein source material is typically dehulled material

### EXAMPLES

### Example 1

30 kg of sunflower cake/meal (prepared by pressing black oil sunflower kernels at about 44-75° C.) was combined with 300 L of reverse osmosis purified (RO) water having a temperature of about 60° C., 0.30 kg of ascorbic acid and 0.68 kg of 25% NaOH solution. The mixture was stirred for an unrecorded length of time. Mixing times are typically about 10 to about 30 minutes. A portion of suspended (coarse) residual solids (80.58 kg), having an as-is protein content of 6.19 wt % and solids content of 17.60% (35.17% protein (N×6.25) d.b.), were removed by centrifugation using a decanter centrifuge to provide a protein solution having a protein content of 2.68 wt % and a pH of 7.38. The protein solution was then fed to a three-phase separator which removed 17.16 kg of oil phase and 10.16 kg of suspended solids (as-is protein content of 3.69 wt % and solids content of 5.62% (65.66% protein (N×6.25) d.b.)) and provided 220 L of protein solution having a protein content of 2.28 wt %. The pH of this protein solution was adjusted from 7.25 to 2.95 by the addition of 1.62 kg of HCl solution (concentrated HCl diluted with an equal volume of RO water).

The acidified protein solution was then reduced in volume to 60 L by concentration on a polyethersulfone membrane having a molecular weight cut-off (MWCO) of 10,000 daltons operated at a temperature of about 49° C. The concentrated acidified protein solution with a protein content of 6.72 wt % was then diafiltered on the same membrane with 180 L of RO water at a temperature of about 53° C.

63.26 kg of diafiltered acidified protein solution, having a protein content of 7.32 wt %, was diluted with 130 L of RO water having a temperature of about 50° C. and the pH adjusted to 7.15 by the addition of 0.60 kg of 25% NaOH solution. The pH adjusted solution was centrifuged with a disc stack centrifuge to provide 160 L of solids-removed protein solution having a protein content of 0.61 wt % and 31.88 kg of protein solids having a protein content of 10.55 wt %. The protein solids were diluted with 5 L of RO water then pasteurized at about 72° C. for 16 seconds. The pasteurized material was spray dried to yield a product having a protein content of 104.38% (N×6.25) d.b. The product was termed SF15-C31-22A SF871NDS.

Note all cited pH values were from measurements conducted with the sample at room temperature unless otherwise noted.

### Example 2

30 kg of sunflower cake/meal (prepared by pressing black oil sunflower kernels at about 64-73° C.) was combined with 300 L of reverse osmosis purified (RO) water having a temperature of 60.8° C., 0.30 kg of ascorbic acid and 0.68 kg of 25% NaOH solution. The mixture was stirred for an unrecorded length of time. Mixing times are typically about 10 to about 30 minutes. A portion of suspended (coarse) residual solids (49.1 kg), having an as-is protein content of 10.19 wt % and solids content of 24.57% (41.47% protein (N×6.25) d.b.), were removed by centrifugation using a decanter centrifuge to provide a protein solution having a protein content of 2.58 wt % and a pH of 7.23. The protein solution was then further clarified by centrifugation using a disc stack centrifuge to remove additional suspended (finer) residual solids (7.62 kg), having an as-is protein content of 9.15 wt % and solids content of 17.83% (51.32% protein (N×6.25) d.b.), and provide 270 L of protein solution having a protein content of 2.29 wt %. This protein solution was then fed to a three-phase separator which removed 9.12 kg of oil phase and another 7.82 kg of suspended solids and provided 244 L of protein solution having a protein content of 2.18 wt %. The pH of this protein solution was adjusted from 7.13 to 2.94 by the addition of 1.88 kg of HCl solution (concentrated HCl diluted with an equal volume of RO water).

The acidified protein solution was then reduced in volume by concentration on a polyethersulfone membrane having a molecular weight cut-off (MWCO) of 100,000 daltons, operated at a temperature of about 47° C. to provide a concentrated acidified protein solution having a protein content of 7.22 wt %. This solution was then diafiltered on the same membrane with 210 L of RO water at a temperature of about 52° C.

70 L of diafiltered acidified protein solution, having a protein content of 7.34 wt %, was diluted with 140 L of RO water having a temperature of 51.9° C. and the pH adjusted to 7.28 by the addition of 0.64 kg of 25% NaOH solution. The pH adjusted solution was centrifuged with a disc stack centrifuge to provide 195.3 L of solids-removed protein solution having a protein content of 0.65 wt % and 21.78 kg of protein solids having a protein content of 15.14 wt %. The protein solids were diluted with 8 L of RO water then pasteurized at about 73° C. for 1 minute. The pasteurized material was spray dried to yield a product having a protein content of 106.82% (N×6.25) d.b. The product was termed SF17-D27-22A SF871NDS.

195 L of the solids-removed protein solution was reduced to 25.44 kg by concentration on a polyethersulfone membrane having a molecular weight cut-off (MWCO) of 10,000 daltons, operated at a temperature of about 48° C., providing a protein solution with a protein content of 4.48 wt %. This solution was pasteurized at 72° C. for 16 seconds. The pasteurized solution was spray dried to yield a product having a protein content of 89.00% (N×6.25) d.b. This product was termed SF17-D27-22A SF871NDSRet.

Note all cited pH values were from measurements conducted with the sample at room temperature unless otherwise noted. The extraction slurry was noted as having a pH of 7.07 at 57.9° C.

### Example 3

30 kg of sunflower flour/meal (partially defatted, made from kernels) was combined with 300 L of reverse osmosis purified (RO) water having a temperature of 62.1° C., 0.30 kg of ascorbic acid and 0.76 kg of 25% NaOH solution. The mixture was stirred for 15 minutes. A portion of suspended (coarse) residual solids (77.81 kg) were removed by centrifugation using a decanter centrifuge to provide a protein solution having a protein content of 3.21 wt % and a pH of 7.50. The protein solution was then further clarified by centrifugation using a disc stack centrifuge to remove additional suspended (finer) residual solids (12.28 kg) and provide 230 L of protein solution having a protein content of 2.96 wt %. This protein solution was then fed to a three-phase separator which removed 2.56 kg of oil phase and an unrecorded amount of suspended solids and provided 210 L of protein solution having a protein content of 2.81 wt %. The pH of this protein solution was adjusted from 7.37 to 3.00 by the addition of 1.72 kg of HCl solution (concentrated HCl diluted with an equal volume of RO water).

The acidified protein solution was reduced in volume to 75 L by concentration on a polyvinylidene fluoride membrane having a molecular weight cut-off (MWCO) of 70,000 daltons operated at a temperature of about 44° C. The concentrated acidified protein solution, having a protein content of 7.58 wt %, was then diafiltered on the same membrane with 225 L of RO water at a temperature of about 51° C.

65 kg of the diafiltered acidified protein solution was diluted with 130 L of RO water having a temperature of about 50° C. and the pH adjusted to 7.05 by the addition of 0.54 kg of 25% NaOH solution. The pH adjusted solution was then centrifuged with a disc stack centrifuge to provide 164 L of solids-removed protein solution having a protein content of 0.49 wt % and 23.7 kg of protein solids. The protein solids were diluted with 5.86 L of RO water and then pasteurized at about 72° C. for 16 seconds. The pasteurized material was spray dried to yield a product having a protein content of 101.58% (N×6.25) d.b. This product was termed SF19-E16-22A SF871NDS.

The 164 L of solids-removed protein solution was reduced in volume to 40 L by concentration on a polyvinylidene fluoride membrane having a molecular weight cut-off (MWCO) of 70,000 daltons operated at a temperature of about 51° C. The protein solution, with a protein content of 1.47 wt %, was then diafiltered on the same membrane with 40 L of RO water at a temperature of about 52° C. The diafiltered solids-removed protein solution was then further concentrated to a protein content of 1.98 wt % and pasteurized at 72° C. for 16 seconds. The pasteurized solution was spray dried to yield a product having a protein content of 68.89% (N×6.25) d.b. This product was termed SF19-E16-22A SF871NDSRet.

12.28 kg of finer residual solids from the initial disc stack centrifuge step were combined with an unrecorded weight of residual solids collected by the three-phase separator. The mixture, having a protein content of 4.98 wt %, was pasteurized at about 73° C. for 1 minute. The pasteurized material was spray dried to yield a product having a protein content of 55.91% (N×6.25) d.b. and was termed SF19-E16-22A SF871PN2.

Note all cited pH values were from measurements conducted with the sample at room temperature unless otherwise noted. The extraction slurry was noted as having a pH of 7.12 at 61° C.

### Example 4

30 kg of sunflower flour/meal (partially defatted, made from kernels) was combined with 300 L of reverse osmosis purified (RO) water having a temperature of 64° C., 0.30 kg of ascorbic acid and 0.72 kg of 25% NaOH solution. The mixture was stirred for 15 minutes. A portion of suspended (coarse) residual solids (60.02 kg), having an as-is protein content of 8.95 wt % and solids content of 17.70% (50.56% protein (N×6.25) d.b.), were removed by centrifugation using a decanter centrifuge to provide a protein solution having a protein content of 4.19 wt % and a pH of 7.61. The protein solution was then further clarified by centrifugation using a disc stack centrifuge to remove additional suspended (finer) residual solids (22.72 kg), having an as-is protein content of 10.62 wt % and solids content of 16.80% (63.21% protein (N×6.25) d.b.), and provide 269.9 L of protein solution having a protein content of 3.14 wt %. This protein solution was then fed to a three-phase separator which removed 3.28 kg of oil phase and 11.00 kg of suspended solids and provided about 250 L of protein solution having a protein content of 2.96 wt %. The pH of this protein solution was adjusted from 7.51 to 3.00 by the addition of 2.28 kg of HCl solution (concentrated HCl diluted with an equal volume of RO water).

The acidified protein solution was reduced in volume by concentration on a polyethersulfone membrane having a molecular weight cut-off (MWCO) of 100,000 daltons operated at a temperature of about 47° C. The concentrated protein solution, with a protein content of 15.68 wt %, was then diafiltered on the same membrane with 60 L of RO water at a temperature of about 57° C.

40.35 kg of the diafiltered protein solution was diluted with RO water (target volume of about 81 L) having a temperature of about 60° C. and the pH adjusted to 7.16 by the addition of 0.78 kg of 25% NaOH solution. The pH adjusted solution was then centrifuged with a disc stack centrifuge to provide 75 L of solids-removed protein solution having a protein content of 1.45 wt % and 33.93 kg of protein solids.

The 75 L of solids-removed protein solution was reduced to 23.84 kg by concentration on polyethersulfone membrane having a molecular weight cut-off (MWCO) of 100,000 daltons operated at a temperature of about 56° C. This solution, having a protein content of 3.30 wt %, was combined with the 33.93 kg of protein solids. The mixture was pasteurized at about 72° C. for 5 minutes. The pasteurized mixture was spray dried to yield a product having a protein content of 98.14% (N×6.25) d.b. This product was termed SF25-112-22A SF871NDS2.

Note all cited pH values were from measurements conducted with the sample at room temperature unless otherwise noted. The extraction slurry was noted as having a pH of 7.11 at 60.2° C.

### Example 5

30 kg of sunflower flour/meal (partially defatted, made from kernels) was combined with 300 L of RO water having a temperature of 59.8° C., 0.30 kg of ascorbic acid and 0.62 kg of 25% NaOH solution. The mixture was stirred for an unrecorded length of time. Extraction time is typically about 10 to about 30 minutes. A portion of suspended (coarse) residual solids (71.47 kg) were removed by centrifugation using a decanter centrifuge to provide a protein solution having a protein content of 3.17 wt % and a pH of 7.34. The protein solution was then further clarified by centrifugation using a disc stack centrifuge to remove additional suspended (finer) residual solids (15.4 kg), having an as-is protein content of 6.17 wt % and solids content of 10.07% (61.27% protein (N×6.25) d.b.), and provide 245 L of protein solution having a protein content of 2.87 wt %. This protein solution was then fed to a three-phase separator which removed 2.72 kg of oil phase and 10.94 kg of suspended solids and provided 240 L of protein solution having a protein content of 2.58 wt %. The pH of this protein solution was adjusted from 7.21 to 3.03 by the addition of 1.94 kg of HCl solution (concentrated HCl diluted with an equal volume of RO water) to provide an acidified protein solution.

The 15.4 kg of finer residual solids captured by the disc stack centrifuge was mixed with RO water (target volume of about 62 L) having a temperature of about 60° C. The solution was centrifuged with a disc stack centrifuge to provide 7.6 kg of washed finer residual solids having an as-is protein content of 5.59 wt % and solids content of 8.73% (64.03% protein (N×6.25) d.b.) as well as 70 L of used wash solution having a protein content of 0.70 wt %.

240 L of acidified protein solution was reduced in volume to 75 L by concentration on a polyethersulfone membrane having a molecular weight cut-off (MWCO) of 100,000 daltons operated at a temperature of about 51° C. The concentrated acidified protein solution, with a protein content of 7.14 wt %, was then diafiltered on the same membrane with 150 L of RO water at a temperature of about 59° C.

79.28 kg of the concentrated and diafiltered protein solution was mixed with the 70 L used wash solution and 56 L of RO water. The pH of the solution was adjusted to 7.21 by the addition of 0.78 kg of 25% NaOH solution. The pH adjusted solution was centrifuged with a disc stack centrifuge to provide 175 L of solids-removed protein solution, having a protein content of 0.81 wt %, and 35.24 kg of protein solids.

The 175 L of solids-removed protein solution was reduced to 28.86 kg by concentration on a polyethersulfone membrane having a molecular weight cut-off (MWCO) of 100,000 daltons operated at a temperature of about 54° C. This solution, having a protein content of 3.93 wt %, was combined with the 35.24 kg of protein solids and the mixture pasteurized at about 72° C. for 5 minutes. The 61.74 kg of pasteurized material was spray dried to yield a product having a protein content of 93.58% (N×6.25) d.b. This product was termed SF19-128-22A SF871NDS2.

A portion of the coarse solids captured in the initial decanter centrifuge step were diluted with RO water and spray dried to yield a product having a protein content of 47.66% (N×6.25) d.b. This product was termed SF19-128-22A SF871SM

Note all cited pH values were from measurements conducted with the sample at room temperature unless otherwise noted.

### Example 6

30 kg of sunflower flour/meal (partially defatted, made from kernels) was combined with 300 L of reverse osmosis purified (RO) water having a temperature of 63.6° C., 0.30 kg of ascorbic acid and 0.66 kg of 25% NaOH solution. The mixture was stirred for an unrecorded time. Typical mixing times are 10-30 minutes. A portion of suspended (coarse) residual solids (72.98 kg) were removed by centrifugation using a decanter centrifuge to provide a protein solution having a protein content of 3.30 wt % and a pH of 7.46. The protein solution was then further clarified by centrifugation using a disc stack centrifuge to remove additional suspended (finer) residual solids (15.42 kg) and provide 258 L of protein solution having a protein content of 2.92 wt %. This protein solution was then fed to a three-phase separator which removed 3.36 kg of oil phase and 10.38 kg of suspended solids and provided 250 L of protein solution having a protein content of 2.72 wt %.

The finer residual solids captured by the disc stack centrifuge were combined with RO water (target was a volume of about 62 L at about 60° C.) then run through the disc stack centrifuge again. 4.32 kg of washed finer solids were recovered along with 75 L of used wash solution having a protein content of 0.67 wt %. The protein solution recovered from the three-phase separator was combined with the used wash solution and 2.10 kg of 1:1 HCl (concentrated HCl diluted with an equal volume of RO water) to yield an acidified protein solution with a protein content of 2.13 wt % and a pH of 3.12.

The acidified protein solution was reduced in volume from 330 L to 60 L by concentration on a polyethersulfone membrane having a molecular weight cut-off (MWCO) of 100,000 daltons operated at a temperature of about 50° C. The concentrated acidified protein solution with a protein content of 9.43 wt % was then diafiltered on the same membrane with 120 L of RO water at a temperature of about 54° C.

The diafiltered acidified protein solution (66.46 kg) was diluted with about 264 L of RO water, with the mixture having a temperature of 62.2° C., and the pH raised to 7.16 by the addition of 0.80 kg of 25% NaOH. The pH adjusted protein solution was then centrifuged with a disc stack centrifuge to provide a 295 L of solids-removed protein solution having a protein content of 0.57 wt % and 37.92 kg of protein solids.

The protein solids were diluted with 5 L of RO water and then pasteurized at 72° C. for 16 seconds. 31.46 of the pasteurized material was spray dried to yield a product having a protein content of 102.64% (N×6.25) d.b. This product was termed SF19-K15-22A SF871NDS.

The solids-removed protein solution was reduced to 22 kg by concentration on a polyethersulfone membrane having a molecular weight cut-off (MWCO) of 100,000 daltons operated at a temperature of about 50° C. This protein solution, with a protein content of 4.49 wt %, was pasteurized at 72° C. for 16 seconds. 15.8 kg of the pasteurized solution was spray dried to yield a product having a protein content of 79.47% (N×6.25) d.b. This product was termed SF19-K15-22A SF871NDSRet.

10 kg of the pasteurized insoluble solid material was combined with 5 kg of the pasteurized concentrated solids-removed protein solution and the mixture spray dried to yield a product having a protein content of 97.69% (N×6.25) d.b. This product was termed SF19-K15-22A SF871NDS2.

Note all cited pH values were from measurements conducted with the sample at room temperature unless otherwise noted. The extraction slurry was noted as having a pH of 7.09 at 60.3° C.

### Example 7

Sunflower flour/meal (partially defatted, made from kernels) was combined with RO water, ascorbic acid and 25% NaOH solution in 3 lots as detailed in Table 1 below.

TABLE 1
Details of extraction slurries for preparation of SF26-L07-22A products

| | Wt. | Vol. RO | Temp. RO | Wt. ascorbic | Wt. 25% NaOH | Slurry pH |
|---|---|---|---|---|---|---|
| lot | flour (kg) | water (L) | water (° C.) | acid (kg) | solution (kg) | measurement |
| 1 | 85 | 850 | About 60 | 0.85 | 2.35 | 7.06 at T not |
| | | | | | | recorded |
| 2 | 85 | 850 | About 60 | 0.85 | 2.35 | 7.08, at T not |
| | | | | | | recorded |
| 3 | 80 | 800 | About 60 | 0.85 | 2.21 | Not recorded |

The mixtures were stirred for 10 minutes. A portion of the suspended (coarse) residual solids (576.19 kg) were removed by centrifugation using a decanter centrifuge to provide a protein solution having a protein content of 3.94 wt % and a pH of 7.29. The protein solution was then further clarified by centrifugation using a disc stack centrifuge to remove additional suspended (finer) residual solids (167.15 kg) and provide a protein solution having a protein content of 2.96 wt %. The protein solution was then fed to a three-phase separator which removed 29.0 kg of oil phase and 9.66 kg of suspended solids and provided 1881 L of protein solution having a protein content of 2.99 wt %. The pH of the protein solution was adjusted from 7.27 to 2.81 by the addition of 17.8 kg of HCl solution (concentrated HCl diluted with one volume of RO water). The acidified solution was then diluted with 3520 L of RO water having a temperature of about 60° C.

The acidified protein solution, having a protein content of 0.89 wt %, was reduced in volume from 5401 L to 485 L by concentration on a polyethersulfone membrane having a molecular weight cut-off (MWCO) of 100,000 daltons operated at a temperature of about 57° C. The concentrated protein solution was then diluted with 1940 L of RO water at a temperature of 60° C. and the pH adjusted to 7.31 with 25% NaOH solution, resulting in a pH adjusted protein solution having a protein content of 1.99 wt %. 2325 L of the pH adjusted protein solution was then centrifuged with a disc stack centrifuge to provide 2000 L of solids-removed protein solution having a protein content of 0.45 wt % and 258.40 kg of protein solids having a protein content of 13.57%.

A 17.75 kg aliquot of the protein solids was diluted with 16.83 L of RO water and then pasteurized at about 73° C. for 1 minute. A portion of the pasteurized solution was spray dried to yield a product having a protein content of 106.21% (N×6.25) d.b. This product was termed SF26-L07-22A SF871NDS.

The 2000 L of solids-removed protein solution was reduced in volume to 70 L by concentration on a polyethersulfone membrane having a MWCO of 100,000 daltons operated at a temperature of about 57° C. A 29.08 kg aliquot of the concentrated protein solution, with a protein content of 5.97 wt %, was pasteurized at about 73° C. for 16 seconds. 25.87 kg of pasteurized solution was spray dried to yield a product having a protein content of 83.37% (N×6.25) d.b. This product was termed SF26-L07-22A SF871NDSRet.

An aliquot of diluted and pasteurized protein solids (16.27 kg) was blended with an aliquot of pasteurized concentrated solids-removed protein solution (2.41 kg). The combined material, having a protein content of 7.18 wt %, was spray dried to yield a product having a protein content of 101.98% (N×6.25) d.b. This product was termed SF26-L07-22A SF871NDS2.

### Example 8

Sunflower flour/meal (partially defatted, made from kernels) was combined with RO water, ascorbic acid and 25% NaOH solution in 3 lots as detailed in Table 2 below.

TABLE 2
Details of extraction slurries for preparation
of SF26-A10-23A products

| | Wt. | | Temp. RO | Wt. | Wt. |
|---|---|---|---|---|---|
| | flour | Vol. RO | water | ascorbic | 25% NaOH |
| lot | (kg) | water (L) | (° C.) | acid (kg) | solution (kg) |
| 1 | 30 | 300 | 64.2 | 0.30 | 0.91 |
| 2 | 30 | 300 | 63.9 | 0.30 | 0.92 |
| 3 | 30 | 300 | 64.6 | 0.30 | 0.84 |

The mixtures were stirred for 15 minutes. A portion of the suspended (coarse) residual solids (151.55 kg), having an as-is protein content of 10.42 wt % and solids content of 21.46% (48.56% protein (N×6.25) d.b.), were removed by centrifugation using a decanter centrifuge to provide a protein solution having a protein content of 3.74 wt % and a pH of 7.45. The protein solution was then further clarified by centrifugation using a disc stack centrifuge to remove additional suspended (finer) residual solids (53.52 kg), having an as-is protein content of 11.58 wt % and solids content of 20.27% (57.13% protein (N×6.25) d.b.), and provide a protein solution having a protein content of 3.00 wt %. The protein solution was then fed to a three-phase separator which removed 15 kg of oil phase and 10 kg of suspended solids and provided 760 L of protein solution having a protein content of 3.01 wt %. The pH of the solution was adjusted from 7.44 to 3.04 by the addition of 7.22 kg of HCl solution (concentrated HCl diluted with one volume of RO water) to provide an acidified protein solution.

The 53.52 kg of finer residual solids captured by the disc stack centrifuge was mixed with 215 L of RO water having a temperature of 60.8° C. The solution was centrifuged with a disc stack centrifuge to provide 22.64 kg of washed finer solids having a protein content of 10.40 wt % and a solids content of 20.93 (49.69% protein (N×6.25) d.b.), as well as 265 L of used wash solution having a protein content of 1.51 wt %. The used wash solution was then fed to a three-phase separator which removed 3.63 kg of oil phase and 10.04 kg of suspended solids and provided 250 L of used wash solution having a protein content of 1.15 wt %. The pH of this protein solution was adjusted by the addition of 0.96 kg of HCl solution (concentrated HCl diluted with an equal volume of RO water) to provide an acidified used wash solution.

The two acidified solutions were combined to form an acidified protein solution with a protein content of 2.39 wt %. This acidified protein solution was reduced in volume from 1010 L to 230 L by concentration on a polyethersulfone membrane having a molecular weight cut-off (MWCO) of 10,000 daltons operated at a temperature of about 60° C. The concentrated acidified protein solution with a protein content of 9.95 wt % was then diafiltered on the same membrane with 460 L of RO water at a temperature of about 63° C. The product was displaced from the membrane with water to yield about 230 L of diafiltered acidified protein solution having a protein concentration of 8.10 wt %.

The diafiltered protein solution (220 L) was raised in pH from 3.24 to 7.04 by the addition of 2.74 kg of 25% NaOH. The pH adjusted solution was then diluted with 1480 L of RO water having a temperature of about 60° C., resulting in a solution with a protein content of 1.15 wt %. The protein solution was then centrifuged with a disc stack centrifuge to provide 1570 L of solids-removed protein solution having a protein content of 0.26 wt % and 106.22 kg of protein solids. The disc stack discharge port was flushed with water, providing an additional 7.72 kg of protein solids. 32.92 kg of protein solids was diluted with 16.46 L of RO water and pasteurized at about 72° C. for 1 minute. Another 73.30 kg of protein solids was combined with an aliquot of the protein solids material from the disc stack discharge port flush and 25 L of RO water then pasteurized at about 72° C. for 1 minute. The pasteurized materials were combined and spray dried to yield a product having a protein content of 104.16% (N×6.25) d.b. This product was termed SF26-A10-23A SF871NDS.

The 1570 L of solids-removed protein solution was reduced in volume to 50 L by concentration on a polyethersulfone membrane having a molecular weight cut-off (MWCO) of 10,000 daltons operated at a temperature of about 58° C. This concentrated protein solution, with a protein content of 10.15 wt %, was then diafiltered on the same membrane with 100 L of RO water at a temperature of about 62° C. This diafiltered protein solution, having a mass of 40.62 kg and a protein content of 8.70%, which was then pasteurized at 72° C. for 16 seconds. This pasteurized solution was spray dried to yield a product having a protein content of 86.49% (N×6.25) d.b. This product was termed BW-SF26-A10-23A SF871NDSRet.

Aliquots of the SF26-A10-23A SF871NDS and the BW-SF26-A10-23A SF871NDSRet were dry blended to provide a product having a protein content of 100.44% (N×6.25) d.b. This product was termed SF26-A10-23A SF871NDS2.

Note all cited pH values were from measurements conducted with the sample at room temperature unless otherwise noted.

### Example 9

30 kg of sunflower flour/meal (partially defatted, made from kernels) was combined with 300 L of reverse osmosis purified (RO) water having a temperature of 61.2° C., 0.30 kg of ascorbic acid and 25% NaOH solution to adjust the pH. Another 30 kg of sunflower flour (partially defatted, made from kernels) was combined with 300 L of reverse osmosis purified (RO) water having a temperature of 64.2° C., 0.30 kg of ascorbic acid and 25% NaOH solution to adjust the pH. In total 1.94 kg of 25% NaOH solution was used. The mixtures were stirred for 10 minutes. A portion of suspended (coarse) residual solids (100.19 kg) were removed by centrifugation using a decanter centrifuge to provide a protein solution having a protein content of 3.74 wt % and a pH of 7.66. The protein solution was then further clarified by centrifugation using a disc stack centrifuge to remove additional suspended (finer) residual solids (29.82 kg) and provide 541 L of protein solution having a protein content of 3.25 wt %. This protein solution was then fed to a three-phase separator which removed 9.1 kg of oil phase and 10.16 kg of suspended solids and provided 511 L of protein solution having a protein content of 3.15 wt %. The pH of this protein solution was adjusted from 7.47 to 3.04 by the addition of 4.92 kg of HCl solution (concentrated HCl diluted with an equal volume of RO water) to provide an acidified protein solution.

The finer residual solids captured by the disc stack centrifuge were combined with about 120 L of RO water at an unrecorded temperature, typically about 60° C., then run through the disc stack centrifuge again. 12.88 kg of washed finer residual solids were recovered along with 143 L of used wash solution having a protein content of 1.21 wt %. The used wash solution was then fed to a three-phase separator which removed 1.94 kg of oil phase and 10.3 kg of suspended solids and provided 139 L of used wash solution having a protein content of 1.28 wt %. The pH of this protein solution was adjusted from 7.85 to 3.43 by the addition of 0.58 kg of HCl solution (concentrated HCl diluted with an equal volume of RO water) to provide an acidified used wash solution.

The two acidified solutions were combined to form a protein solution with a protein content of 2.61 wt %. This protein solution was reduced in volume from 650 L to 160 L by concentration on a polyethersulfone membrane having a molecular weight cut-off (MWCO) of 10,000 daltons operated at a temperature of about 57° C. The concentrated acidified protein solution with a protein content of 10.14 wt % was then diafiltered on the same membrane with 320 L of RO water at a temperature of about 61° C.

The pH of the diafiltered acidified protein solution was raised from 3.20 to 7.03 by the addition of 2.04 kg of 25% NaOH. The pH adjusted solution was then diluted with 1060 L of RO water having a temperature of about 60° C., resulting in a solution with a protein content of 1.29 wt %. The diluted pH adjusted protein solution, having a temperature of 58.5° C., was then centrifuged with a disc stack centrifuge to provide 1140 L of solids-removed protein solution having a protein content of 0.29 wt % and a total of 100.54 kg of protein solids (aliquot 1 (43.14 kg) and aliquot 2 (57.40 kg). The disc stack discharge port was flushed with water, providing an additional 8.08 kg of protein solids that was combined with protein solids aliquot 2.

Protein solids aliquot 1 was diluted with 7 L of RO water and then pasteurized at 72° C. for 1 minute, resulting in a solution with a protein content of 10.23 wt %. The combined aliquot 2 protein solids/disc stack discharge port flush protein solids was pasteurized at about 72° C. for 1 minute, resulting in a solution with a protein content of 9.09 wt %. The two pasteurized protein solids streams were spray dried together to yield a product having a protein content of 103.75% (N×6.25) d.b. This product was termed SF26-A12-23A SF871NDS.

The 1140 L of solids-removed protein solution was reduced in volume to 50 L by concentration on a polyethersulfone membrane having a molecular weight cut-off (MWCO) of 10,000 daltons operated at a temperature of about 59° C. The concentrated solids-removed protein solution, with a protein content of 7.26 wt %, was then diafiltered on the same membrane with 100 L of RO water at a temperature of about 61.2° C. The diafiltered solids-removed protein solution, with a protein content of 5.84 wt %, was pasteurized at 72° C. for 16 seconds. The pasteurized solution was spray dried to yield a product having a protein content of 88.01% (N×6.25) d.b. This product was termed SF26-A12-23A SF871NDSRet.

An aliquot of the coarse residual solids collected from the decanter centrifuge was combined with an aliquot of the washed finer residual solids and diluted then the mixture pasteurized at 72° C. for 1 minute. 35.1 kg of the mixture was spray dried to yield a product having a protein content of 45.41% (N×6.25) d.b. This product was termed SF26-A12-23A SF871PC.

Note all cited pH values were from measurements conducted with the sample at room temperature unless otherwise noted. One extraction slurry was noted as having a pH of 7.11 at 58.5° C. The other extraction slurry was noted as having a pH of 7.11 at 59.0° C.

### Example 10

This Example describes preparation of the product with initial extraction steps simulating counter current extraction.

30 kg of sunflower cake/meal was combined with 300 L of reverse osmosis purified (RO) water having a temperature of 64.0° C., 0.30 kg of ascorbic acid and 0.85 kg of 25% NaOH solution. The mixture was stirred for 10 minutes. A portion of the suspended (coarse) residual solids, termed spent meal 1 (55.55 kg) were removed by centrifugation using a decanter centrifuge to provide a protein solution, termed extract 1, having a protein content of 3.35 wt % and a pH of 7.35. Spent meal 1 had an as-is protein content of 9.65 wt % and a solids content of 22.7 wt % (42.51% protein (N×6.25) d.b.).

55.55 kg of spent meal 1 was combined with 300 L of reverse osmosis purified (RO) water having a temperature of 64.1° C., 0.30 kg of ascorbic acid and 0.31 kg of 25% NaOH solution and the mixture stirred for 10 minutes. A portion of the suspended (coarse) residual solids, termed spent meal 2 (47.57 kg) were removed by centrifugation using a decanter centrifuge to provide a protein solution termed extract 2, having a protein content of 0.81 wt % and a pH of 7.64. Spent meal 2 had an as-is protein content of 5.25 wt % and a solids content of 15.68 wt % (33.48% protein (N×6.25) d.b.).

30 kg of sunflower cake/meal was combined with 290 L of extract 2 having a temperature of about 48.5° C. and 0.59 kg of 25% NaOH solution. The mixture was stirred for 10 minutes. A portion of the suspended (coarse) residual solids, termed spent meal 3 (54.0 kg), having an as-is protein content of 12.86 wt % and solids content of 25.54% (50.35% protein (N×6.25) d.b.), were removed by centrifugation using a decanter centrifuge to provide a protein solution, termed extract 3, having a protein content of 4.01 wt % and a pH of 7.31. This protein solution was then further clarified by centrifugation using a disc stack centrifuge to remove additional suspended (finer) residual solids (29.30 kg), having an as-is protein content of 9.72 wt % and solids content of 17.22% (56.45% protein (N×6.25) d.b.), and provide 247 L of protein solution having a protein content of 3.10 wt %. This solution had a pH of 7.31. This protein solution was then fed to a three-phase separator which removed 2.0 kg of oil phase and another 10.0 kg of suspended solids and provided 295 L of protein solution having a protein content of 3.18 wt %. The pH of this solution was adjusted from 7.31 to 3.18 by the addition of 2.08 kg of HCl solution (concentrated HCl diluted with an equal volume of RO water) to provide an acidified protein solution.

The 29.30 kg of finer residual solids captured by the disc stack centrifuge were combined with 120 L of RO water at 62.6° C. then run through the disc stack centrifuge again. 8.44 kg of washed finer residual solids, having an as-is protein content of 8.26 wt % and solids content of 13.63% (60.60% protein (N×6.25) d.b.), were recovered along with 151 L of used wash solution having a protein content of 1.35 wt %. The used wash solution was then fed to a three-phase separator which removed 4.76 kg of oil phase and 10.38 kg of suspended solids and provided 85 L of used wash solution having a protein content of 1.30 wt %. The pH of this solution was adjusted from 7.64 to 3.52 by the addition of 0.46 kg of HCl solution (concentrated HCl diluted with an equal volume of RO water) to provide an acidified used wash solution.

The two acidified solutions were combined to form a protein solution with a protein content of 2.22 wt %. This solution was reduced in volume from 380 L to 75 L by concentration on a polyethersulfone membrane having a molecular weight cut-off (MWCO) of 10,000 daltons operated at a temperature of about 51° C. The concentrated acidified protein solution, with a protein content of 10.50 wt %, was then diafiltered on the same membrane with 150 L of RO water at a temperature of about 60° C. The product was displaced from the membrane with water to yield 93.82 kg of protein solution having a protein concentration of 7.75 wt %.

The pH of the diafiltered acidified protein solution was raised from 3.31 to 7.25 by the addition of 1.06 kg of 25% NaOH. The pH adjusted solution was then diluted with 560 L of RO water having a temperature of 64° C., resulting in a solution with a protein content of 1.26 wt %. The protein solution, having a temperature of 61.1° C., was then centrifuged with a disc stack centrifuge to provide 610 L of solids-removed protein solution having a protein content of 0.38 wt % and 49.00 kg of protein solids. The disc stack discharge port was flushed with water, providing an additional 4.72 kg of protein solids.

The 53.72 kg of protein solids was pasteurized at about 72° C. for 1 minute, resulting in a solution with a protein content of 9.74 wt %. The pasteurized protein solids was spray dried to yield a product having a protein content of 98.80% (N×6.25) d.b. This product was termed SF28-A25-23A SF871NDS.

The 610 L of solids-removed protein solution was reduced in volume to 40 L by concentration on a polyethersulfone membrane having a molecular weight cut-off (MWCO) of 10,000 daltons operated at a temperature of about 62° C. This protein solution, with a protein content of 3.58 wt %, was diafiltered on the same membrane with 80 L of RO water at a temperature of about 59° C. and then further concentrated to a protein concentration of 4.76 wt %. This solution (29.24 kg) was pasteurized at 72° C. for 16 seconds. The pasteurized solution was spray dried to yield a product having a protein content of 82.06% (N×6.25) d.b. This product was termed SF28-A25-23A SF871NDSRet.

Aliquots of the SF28-A25-23A SF871NDS and the SF28-A25-23A SF871NDSRet were dry blended to provide a product having a protein content of 95.78% (N×6.25) d.b. This product was termed SF28-A25-23A SF871NDS2.

Note all cited pH values were from measurements conducted with the sample at room temperature unless otherwise noted. The first extraction slurry was noted as having a pH of 7.13 at 61.9° C. The second extraction slurry was noted as having a pH of 7.11 at 60.1° C. The third extraction slurry was noted as having a pH of 7.18 at 47.9° C.

### Example 11

30 kg of sunflower flour/meal (partially defatted, made from kernels) was combined with 300 L of reverse osmosis purified (RO) water having a temperature of 59.6° C., 0.30 kg of ascorbic acid and an unrecorded weight of 25% NaOH solution. The mixtures were stirred for an unrecorded length of time. Mixing times are typically 10-30 minutes. A portion of suspended (coarse) residual solids (44.09 kg) were removed by centrifugation using a decanter centrifuge to provide a protein solution having a protein content of 3.45 wt % and a pH of 7.15. The protein solution was then further clarified by centrifugation using a disc stack centrifuge to remove additional suspended (finer) residual solids (21.98 kg) and provide 265 L of protein solution having a protein content of 3.16 wt %. This protein solution was then fed to a three-phase separator which removed 4.28 kg of oil phase and 10.0 kg of suspended solids and provided 236 L of protein solution having a protein content of 2.92 wt %. The pH of this protein solution was adjusted from 7.22 to 3.18 by the addition of 2.20 kg of HCl solution (concentrated HCl diluted with an equal volume of RO water) to provide an acidified protein solution.

The 21.98 kg of finer residual solids captured by the disc stack centrifuge were combined with 88 L of RO water having a temperature of 57.9° C. then run through the disc stack centrifuge again. 7.92 kg of washed finer residual solids were recovered along with an unrecorded volume of used wash solution having a protein content of 0.86 wt %. The used wash solution was then fed to a three-phase separator which removed 4.34 kg of oil phase and 10.12 kg of suspended solids and provided 129 L of used wash solution having a protein content of 0.82 wt %. The pH of this solution was adjusted from 7.62 to 3.08 by the addition of 0.28 kg of HCl solution (concentrated HCl diluted with an equal volume of RO water) to provide an acidified used wash solution.

The two acidified solutions were combined to form an acidified protein solution with a protein content of 2.10 wt %. This acidified protein solution was reduced in volume from 365 L to 80 L by concentration on a polyethersulfone membrane having a molecular weight cut-off (MWCO) of 10,000 daltons operated at a temperature of about 53° C. The concentrated acidified protein solution with a protein content of 8.15 wt % was then diafiltered on the same membrane with 160 L of RO water at a temperature of about 63° C. The product was displaced from the membrane with water to yield 96.60 kg of protein solution having a protein concentration of 7.25 wt %.

The diafiltered acidified protein solution (96.60 kg) was raised in pH from 3.27 to 7.08 by the addition of 0.98 kg of 25% NaOH. The pH adjusted solution was then diluted with 580 L of RO water having a temperature of about 60° C., resulting in a solution with a protein content of 1.00 wt %. The pH adjusted protein solution, having a temperature of about 60° C., was then centrifuged with a disc stack centrifuge to provide 650 L of solids-removed protein solution having a protein content of 0.30 wt % and 50.91 kg of protein solids.

The 650 L of solids-removed protein solution was reduced in volume to 40 L by concentration on a polyethersulfone membrane having a molecular weight cut-off (MWCO) of 10,000 daltons operated at a temperature of about 58° C. This protein solution with a protein content of 3.18 wt % was then diafiltered on the same membrane with 80 L of RO water at a temperature of about 56° C. then further concentrated to a protein content of 4.05 wt %. 32.1 kg of this solution was combined with 50.91 kg of protein solids and the mixture pasteurized at about 72° C. for 1 minute. 81.10 kg of pasteurized material was spray dried to yield a product having a protein content of 99.63% (N×6.25) d.b. This product was termed SF26-A30-23A SF871NDS2.

Coarse residual solids collected from the decanter centrifuge (about 44 kg) were combined with washed finer residual solids (7.92 kg) and diluted with 140 L of RO water, then the mixture pasteurized at about 72° C. for 1-2 minutes. The pasteurized mixture was spray dried to yield a product having a protein content of 49.09% (N×6.25) d.b. This product was termed SF26-A30-23A SF871PC.

Note all cited pH values were from measurements conducted with the sample at room temperature unless otherwise noted.

### Example 12

30 kg of sunflower flour/meal (partially defatted, made from kernels) was combined with 300 L of reverse osmosis purified (RO) water having a temperature of 64.9° C., 0.30 kg of ascorbic acid and 0.88 kg of 25% NaOH solution. The mixture was stirred for 10 minutes. A portion of suspended (coarse) residual solids, termed spent meal 1 (46.67 kg) were removed by centrifugation using a decanter centrifuge to provide a protein solution, termed extract 1, having a protein content of 3.57 wt % and a pH of 7.50. Spent meal 1 had an as-is protein content of 9.57 wt % and a solids content of 20.45 wt % (46.80% protein (N×6.25) d.b.). The extract 1 protein solution was then further clarified by centrifugation using a disc stack centrifuge to remove additional suspended (finer) residual solids (21.38 kg), having an as-is protein content of 8.83 wt % and solids content of 15.34% (57.56% protein (N×6.25) d.b.), and provide 312 L of protein solution having a protein content of 3.13 wt %. The protein solution was then fed to a three-phase separator which removed 13.0 kg of oil phase, 10.24 kg of suspended solids and provided 267 L of protein solution having a protein content of 2.70 wt %. The pH of the solution was adjusted from 7.44 to 3.01 by the addition of 2.18 kg of HCl solution (concentrated HCl diluted with an equal volume of RO water) to provide a first acidified protein solution.

46.67 kg of spent meal 1 was combined with 300 L of reverse osmosis purified (RO) water having a temperature of 62.8° C., 0.30 kg of ascorbic acid, 0.28 kg of 25% NaOH solution and stirred for 10 minutes. A portion of the suspended (coarse) residual solids, termed spent meal 2 (39.47 kg) were removed by centrifugation using a decanter centrifuge to provide a protein solution termed extract 2, having a protein content of 0.58 wt % and a pH of 7.67. Spent meal 2 had an as-is protein content of 6.99 wt % and a solids content of 16.73 wt % (41.78% protein (N×6.25) d.b.). The extract 2 protein solution was then further clarified by centrifugation using a disc stack centrifuge to remove additional suspended (finer) residual solids (14.2 kg), having an as-is protein content of 3.14 wt % and solids content of 4.73% (66.38% protein (N×6.25) d.b.), and provide 303 L of protein solution having a protein content of 0.47 wt %. The protein solution was then fed to a three-phase separator which removed 6.9 kg of oil phase and 10.0 kg of suspended solids and provided 291 L of protein solution having a protein content of 0.40 wt %. The pH of the solution was adjusted from 7.53 to 2.88 by the addition of 0.98 kg of HCl solution (concentrated HCl diluted with an equal volume of RO water) to provide a second acidified protein solution.

The finer residual solids captured in the first disc stack centrifuge step (21.38 kg) was combined with the finer residual solids captured in the second disc stack centrifuge step (14.2 kg) and then diluted with RO water (target volume of about 142 L). The solution, having a temperature of 63° C., was centrifuged with a disc stack centrifuge to provide 11.86 kg of washed finer solids, having an as-is protein content of 9.83 wt % and solids content of 17.76% (55.35% protein (N×6.25) d.b.), and 136 L of used wash solution having a protein content of 0.60 wt %. The used wash solution was then fed to a three-phase separator which removed 5.50 kg of oil phase, 10.2 kg of suspended solids and provided 160 L of used wash solution having a protein content of 0.51 wt % (some sample dilution occurred from flush of equipment with water). The pH of this solution was adjusted from 7.79 to 2.95 by the addition of 0.32 kg of HCl solution (concentrated HCl diluted with equal volume of RO water) to provide an acidified used wash solution.

The three acidified protein solutions were combined to provide an acidified protein solution having a protein content of 1.31 wt % and a pH of 2.94. This solution was reduced in volume from 730 L to 75 L by concentration on a polyethersulfone membrane having a molecular weight cut-off (MWCO) of 10,000 daltons, operated at a temperature of about 59° C. The concentrated acidified protein solution with a protein content of 11.54 wt % was then diafiltered on the same membrane with 150 L of RO water at a temperature of about 58° C. The product was displaced from the membrane system with water. The collected diafiltered acidified protein solution (90 L) had a protein content of 9.20 wt %.

The 90 L of diafiltered acidified protein solution was adjusted to pH 6.96 by the addition of 1.14 kg of 25% NaOH solution. This pH adjusted protein solution was mixed with RO water (target volume of 540 L, target temperature of 60° C.), then centrifuged with a disc stack centrifuge to provide 550 L solids-removed protein solution and 36.76 kg of protein solids. The disc stack discharge port was flushed with water, providing an additional 8.98 kg of protein solids.

The 550 L of solids-removed protein solution having a protein content of 0.34 wt % was reduced in volume by concentration on a polyethersulfone membrane with a molecular weight cut-off (MWCO) of 10,000 daltons operated at a temperature of 57° C. The protein solution was concentrated to a protein content of 4.24 wt %. This solution was then diafiltered on the same membrane with 80 L of RO water at an unrecorded temperature then further concentrated. The product was displaced from the membrane system with water to yield 26.50 kg of diafiltered protein solution having a protein content of 5.56 wt %. This diafiltered protein solution was combined with the 36.76 kg of protein solids and the 8.98 kg protein solids from the disc stack port flush and pasteurized at about 72° C. for 1 minute. The pasteurized material, having a protein content of 10.09 wt % was spray dried to yield a product having a protein content of 96.84% (N×6.25) d.b. This product was termed BW-SF26-B14-23A SF871NDS2.

### Example 13

30 kg of sunflower flour/meal (partially defatted, made from kernels) was combined with 300 L of reverse osmosis purified (RO) water having a temperature of 62.7° C., 0.30 kg of ascorbic acid and 0.78 kg of 25% NaOH solution. The mixture was stirred for 10 minutes. A portion of the suspended (coarse) residual solids, termed spent meal 1 (48.57 kg) were removed by centrifugation using a decanter centrifuge to provide a protein solution, termed extract 1, having a protein content of 3.42 wt % and a pH of 7.28. Spent meal 1 had an as-is protein content of 11.58 wt % and a solids content of 22.54 wt % (51.38% protein (N×6.25) d.b.). The extract 1 protein solution was then further clarified by centrifugation using a disc stack centrifuge to remove additional suspended (finer) solids (28.74 kg), having an as-is protein content of 6.84 wt % and solids content of 12.61% (54.24% protein (N×6.25) d.b.), and provide 276 L of protein solution having a protein content of 2.94 wt %. The protein solution was then fed to a three-phase separator which removed 8.84 kg of oil phase and 9.90 kg of suspended solids and provided 300 L of protein solution having a protein content of 2.26 wt %. The pH of the solution was adjusted from 7.19 to 3.03 by the addition of 2.22 kg of HCl solution (concentrated HCl diluted with an equal volume of RO water) to provide a first acidified protein solution.

48.5 kg of spent meal 1 was combined with 300 L of reverse osmosis purified (RO) water having a temperature of 62.7° C., 0.30 kg of ascorbic acid and 0.24 kg of 25% NaOH solution and the mixture stirred for 10 minutes. A portion of the suspended (coarse) residual solids, termed spent meal 2 (40.4 kg) were removed by centrifugation using a decanter centrifuge to provide a protein solution termed extract 2, having a protein content of 0.78 wt % and a pH of 7.39. Spent meal 2 had an as-is protein content of 8.16 wt % and a solids content of 18.21 wt % (44.81% protein (N×6.25) d.b.). The extract 2 protein solution was then further clarified by centrifugation using a disc stack centrifuge to remove additional suspended (finer) residual solids (11.40 kg), having an as-is protein content of 5.31 wt % and solids content of 7.56% (70.24% protein (N×6.25) d.b.), and provide 319 L of protein solution having a protein content of 0.53 wt %. The protein solution was then fed to a three-phase separator which removed 19.5 kg of oil phase and 10.5 kg of suspended solids and provided 300 L of protein solution having a protein content of 0.39 wt %. The pH of the solution was adjusted from 7.32 to 3.01 by the addition of 0.84 kg of HCl solution (concentrated HCl diluted with an equal volume of RO water) to provide a second acidified protein solution.

The finer residual solids captured in the first disc stack centrifuge step (28.74 kg) were combined with the finer residual solids captured in the second disc stack centrifuge step (11.40 kg) and then diluted with 160 L of RO water having a temperature of about 60° C. The solution was centrifuged with the disc stack centrifuge to provide 18.26 kg of washed finer solids, having an as-is protein content of 6.86 wt % and solids content of 11.12% (61.69% protein (N×6.25) d.b.), and a used wash solution having a protein content of 0.49 wt %. The used wash solution was then fed to a three-phase separator which removed 23 kg of oil phase and 10 kg of suspended solids and provided 180 L of used wash solution having a protein content of 0.43 wt %. The pH of this solution was adjusted from 7.42 to pH 2.31 by the addition of 0.71 kg of HCl solution (concentrated HCl diluted with an equal volume of RO water) to provide an acidified used wash solution.

The three acidified protein solutions were combined to provide a protein solution having a protein content of 1.17 wt % and a pH of 2.88. This solution was reduced in volume to 80 L by concentration on a polyethersulfone membrane having a molecular weight cut-off (MWCO) of 10,000 daltons, operated at a temperature of about 59° C. The protein solution with a protein content of 10.54% was then diafiltered on the same membrane with 160 L of RO water at a temperature of about 61° C. The product was displaced from the membrane system with water to yield a diafiltered acidified protein solution (93.60 kg) with a protein content of 9.26 wt %.

The 93.60 kg of diafiltered acidified protein solution was adjusted in pH to 6.90 by the addition of 1.22 kg of 25% NaOH solution. This pH adjusted protein solution was mixed with 560 L of RO water having a temperature of about 60° C. then centrifuged with a disc stack centrifuge to provide 620 L solids-removed protein solution, having a protein content of 0.31 wt %, and 43.66 kg of protein solids. The disc stack discharge port was flushed with water, providing an additional 4.70 kg of protein solids.

The 620 L of solids-removed protein solution was reduced in volume to 45 L by concentration on a polyethersulfone membrane with a molecular weight cut-off (MWCO) of 10,000 daltons operated at a temperature of about 59° C. The resulting protein solution had a protein content of 3.64%. This solution was then diafiltered on the same membrane with 90 L of RO water at a temperature of about 59° C. then further concentrated to a protein content of 5.68 wt %. The diafiltered solids-removed protein solution (23.75 kg) was combined with the 43.66 kg of protein solids and 4.70 kg disc stack discharge port flush protein solids and pasteurized at 72° C. for 1 minute. The pasteurized material, having a protein content of 9.77%, was spray dried to yield a product having a protein content of 96.86% (N×6.25) d.b. This product was termed BW-SF26-B27-23A SF871NDS2.

Note all cited pH values were from measurements conducted with the sample at room temperature unless otherwise noted. The extraction slurry was noted as having a pH of 7.14 at 62.1° C.

### Example 14

This Example describes preparation of the product with initial extraction steps simulating counter current extraction.

15 kg of sunflower flour/meal (partially defatted, made from kernels) was combined with 150 L of reverse osmosis purified (RO) water having a temperature of 61.3° C., 0.15 kg of ascorbic acid and 0.32 kg of 25% NaOH solution. The mixture was stirred for an unrecorded length of time. A portion of the suspended (coarse) residual solids, termed spent meal 1 (33.58 kg) were removed by centrifugation using a decanter centrifuge to provide a protein solution, termed extract 1, having a protein content of 3.22 wt % and a pH of 7.41. Spent meal 1 had an as-is protein content of 9.77 wt % and a solids content of 19.72 wt % (49.54% protein (N×6.25) d.b.).

33.58 kg of spent meal 1 was combined with 150 L of reverse osmosis purified (RO) water having a temperature of 60.5° C. and the mixture stirred for a target time of 10 minutes. A portion of the suspended (coarse) residual solids, termed spent meal 2 (25.52 kg) were removed by centrifugation using a decanter centrifuge to provide a protein solution termed extract 2, having a protein content of 0.88 wt % and a pH of 7.80. Spent meal 2 had an as-is protein content of 5.57 wt % and a solids content of 13.84 wt % (40.25% protein (N×6.25) d.b.).

14 kg of sunflower flour/meal (partially defatted, made from kernels) was combined with 140 L of extract 2 having a temperature of 51.0° C., 0.14 kg of ascorbic acid and 0.34 kg of 25% NaOH solution. The mixture was stirred for an unrecorded length of time. A portion of the suspended (coarse) residual solids, termed spent meal 3 (32.83 kg), having an as-is protein content of 9.86 wt % and solids content of 21.22% (46.47% protein (N×6.25) d.b.), were removed by centrifugation using a decanter centrifuge to provide a protein solution, termed extract 3, having a protein content of 3.85 wt % and a pH of 7.55. This protein solution was then further clarified by centrifugation using a disc stack centrifuge to remove additional suspended (finer) residual solids (7.32 kg), having an as-is protein content of 11.39 wt % and solids content of 18.11% (62.89% protein (N×6.25) d.b.), and provide 115 L of protein solution having a protein content of 3.05 wt % and pH of 7.46. The protein solution was then fed to a three-phase separator which removed 1.3 kg of oil phase and 10.72 kg of suspended solids and provided 130 L of protein solution having a protein content of 2.71 wt %. This solution was discarded.

The 7.32 kg of finer residual solids captured by the disc stack centrifuge were combined with 30 L of RO water at 62.3° C. then run through the disc stack centrifuge again. 3.86 kg of washed finer residual solids, having an as-is protein content of 6.94 wt % and solids content of 10.46% (66.35% protein (N×6.25) d.b.), were recovered along with 40 L of used wash solution having a protein content of 1.04 wt %, which was discarded.

Spent meal 2 (25.52 kg) was combined with the washed finer residual solids (3.86 kg) and about 51 L of RO water and the mixture spray dried to yield a product having a protein content of 41.26% (N×6.25) d.b. The product was termed SF19-J06-22A SF871PC.

Note all cited pH values were from measurements conducted with the sample at room temperature unless otherwise noted. The first extraction slurry was noted as having a pH of 7.05 at 56.3° C. The second extraction slurry was noted as having a pH of 7.62 at 56.7° C. The third extraction slurry was noted as having a pH of 7.39 at 46.6° C.

### Example 15

This Example describes preparation of the product with initial extraction steps simulating counter current extraction.

15 kg of sunflower flour/meal (partially defatted, made from kernels) was combined with 150 L of reverse osmosis purified (RO) water having a temperature of 65.1° C., 0.15 kg of ascorbic acid and 0.52 kg of 25% NaOH solution. The mixture was stirred for 10 minutes. A portion of the suspended (coarse) residual solids, termed spent meal 1 (20.46 kg) were removed by centrifugation using a decanter centrifuge to provide a protein solution, termed extract 1, having a protein content of 3.50 wt % and a pH of 7.60. Spent meal 1 had an as-is protein content of 10.96 wt % and a solids content of 22.26 wt % (49.24% protein (N×6.25) d.b.).

20.46 kg of spent meal 1 was combined with 150 L of reverse osmosis purified (RO) water having a temperature of 65° C., 0.15 kg of ascorbic acid and 0.14 kg of 25% NaOH solution and the mixture stirred for 10 minutes. A portion of the suspended (coarse) residual solids, termed spent meal 2 (12.74 kg) were removed by centrifugation using a decanter centrifuge to provide a protein solution termed extract 2, having a protein content of 0.64 wt % and a pH of 7.75. Spent meal 2 had an as-is protein content of 6.72 wt % and a solids content of 15.40 wt % (43.64% protein (N×6.25) d.b.).

15 kg of sunflower flour/meal (partially defatted, made from kernels) was combined with 152 L of extract 2 having a temperature of about 48.2° C. and 0.32 kg of 25% NaOH solution. The mixture was stirred for 10 minutes. A portion of the suspended (coarse) residual solids, termed spent meal 3 (24.82 kg), having an as-is protein content of 9.27 wt % and solids content of 17.86% (51.90% protein (N×6.25) d.b.), were removed by centrifugation using a decanter centrifuge to provide a protein solution, termed extract 3, having a protein content of 4.18 wt % and a pH of 7.47. This protein solution was then further clarified by centrifugation using a disc stack centrifuge to remove additional suspended (finer) residual solids (16.20 kg), having an as-is protein content of 9.83 wt % and solids content of 16.94% (58.03% protein (N×6.25) d.b.), and provide 130 L of protein solution having a protein content of 3.13 wt % and pH of 7.41, which was discarded.

The 16.20 kg of finer residual solids captured by the disc stack centrifuge were combined with 64.80 L of RO water at 58.9° C. then run through the disc stack centrifuge again. 8.40 kg of washed finer residual solids, having an as-is protein content of 5.39 wt % and solids content of 10.44% (51.63% protein (N×6.25) d.b.), were recovered along with 75 L of used wash solution having a protein content of 0.68 wt %, which was discarded.

Spent meal 2 (12.74 kg) was combined with the washed finer residual solids (8.40 kg) and 26 L of RO water and the mixture pasteurized at 72° C. for a target time of 1 minute. 46.95 kg of pasteurized sample was spray dried to yield a product having a protein content of 43.05% (N×6.25) d.b. The product was termed SF26-B01-23A SF871PC.

Note all cited pH values were from measurements conducted with the sample at room temperature unless otherwise noted. The first extraction slurry was noted as having a pH of 7.09 at 59° C. The second extraction slurry was noted as having a pH of 7.20 at 58.5° C. The third extraction slurry was noted as having a pH of 7.10 at 46.6° C.

### Example 16

32 kg of sunflower flour/meal (partially defatted, made from kernels) was combined with 300 L of reverse osmosis purified (RO) water having a temperature of 63.9° C., 0.30 kg of ascorbic acid and 0.80 kg of 25% NaOH solution. The mixture was stirred for 10 minutes. A portion of suspended (coarse) residual solids, termed spent meal 1 (55.47 kg) were removed by centrifugation using a decanter centrifuge to provide a protein solution, termed extract 1, having a protein content of 3.96 wt % and a pH of 7.30. The extract 1 protein solution was then further clarified by centrifugation using a disc stack centrifuge to remove additional suspended (finer) residual solids (28.84 kg) and provide 256 L of protein solution having a protein content of 3.34 wt %. An additional 3.76 kg of finer residual solids was recovered by flushing the disc stack discharge chute with RO water. The protein solution from the disc stack step was then fed to a three-phase separator which removed 4.48 kg of oil phase, 10.04 kg of suspended solids and provided 238 L of protein solution having a protein content of 3.11 wt %. This solution was discarded.

55.47 kg of spent meal 1 was combined with 300 L of reverse osmosis purified (RO) water having a temperature of 63.1° C., 0.30 kg of ascorbic acid, 0.32 kg of 25% NaOH solution and stirred for 10 minutes. A portion of the suspended (coarse) residual solids, termed spent meal 2 (45.02 kg) were removed by centrifugation using a decanter centrifuge to provide a protein solution termed extract 2, having a protein content of 0.89 wt % and a pH of 7.64. The extract 2 protein solution was then further clarified by centrifugation using a disc stack centrifuge to remove additional suspended (finer) residual solids (5.66 kg) and provide 318 L of protein solution having a protein content of 0.58 wt %. An additional 3.30 kg of finer residual solids was recovered by flushing the disc stack discharge chute with RO water. The protein solution from the disc stack step was then fed to a three-phase separator which removed 5.96 kg of oil phase and 10.42 kg of suspended solids and provided 308 L of protein solution having a protein content of 0.63 wt %. This solution was discarded.

The finer residual solids captured in the first disc stack centrifuge step (32.60 kg) was combined with the finer residual solids captured in the second disc stack centrifuge step (8.96 kg) and then diluted with 170 L of RO water. The solution, having a temperature of 62.1° C., was centrifuged with a disc stack centrifuge to provide 14.82 kg of washed finer solids and 220 L of used wash solution having a protein content of 0.53 wt %. The used wash solution was then fed to a three-phase separator which removed 2.96 kg of oil phase, 10.36 kg of suspended solids and provided 220 L of used wash solution having a protein content of 0.46 wt %. This solution was discarded.

20 kg of spent meal 2 was combined with 6.58 kg of the washed finer residual solids and 47 L of RO water and the mixture pasteurized at about 73° C. for 1 minute. 71.8 kg of pasteurized sample was spray dried to yield a product having a protein content of 47.80% (N×6.25) d.b. The product was termed SF26-B07-23A SF871PC.

Note all cited pH values were from measurements conducted with the sample at room temperature unless otherwise noted. The first extraction slurry was noted as having a pH of 7.07 at 61.9° C. The second extraction slurry was noted as having a pH of 7.17 at 61.9° C.

### Example 17

30 kg of sunflower flour/meal (partially defatted, made from kernels) was combined with 300 L of reverse osmosis purified (RO) water having a temperature of 70° C., 0.30 kg of ascorbic acid and 0.84 kg of 25% NaOH solution. Another 30 kg of sunflower flour (partially defatted, made from kernels) was combined with 300 L of reverse osmosis purified (RO) water having a temperature of 65° C., 0.30 kg of ascorbic acid and 0.83 kg of 25% NaOH solution. The mixtures were stirred for 10 minutes. A portion of suspended (coarse) residual solids, termed spent meal 1 (102.39 kg) were removed by centrifugation using a decanter centrifuge to provide a protein solution, termed extract 1, having a protein content of 4.20 wt % and a pH of 7.28. Spent meal 1 had an as-is protein content of 11.51 wt % and a solids content of 21.9 wt % (52.56% protein (N×6.25) d.b.). The extract 1 protein solution was then further clarified by centrifugation using a disc stack centrifuge to remove additional suspended (finer) residual solids (52.10 kg), having an as-is protein content of 10.96 wt % and solids content of 18.78% (58.36% protein (N×6.25) d.b.), and provide 520 L of protein solution having a protein content of 3.07 wt %. The protein solution was then fed to a three-phase separator which removed 10.78 kg of oil phase, 9.5 kg of suspended solids and provided 485 L of protein solution having a protein content of 2.99 wt %. This solution was discarded.

51.20 kg of spent meal 1 was combined with 300 L of reverse osmosis purified (RO) water having a temperature of 62.3° C., 0.30 kg of ascorbic acid and 0.25 kg of 25% NaOH solution. Another 51.20 kg of spent meal 1 was combined with 300 L of reverse osmosis purified (RO) water having a temperature of 62.0° C., 0.30 kg of ascorbic acid and 0.25 kg of 25% NaOH solution. The mixtures were stirred for 10 minutes. A portion of the suspended (coarse) residual solids, termed spent meal 2 (76.66 kg) were removed by centrifugation using a decanter centrifuge to provide a protein solution termed extract 2, having a protein content of 0.77 wt % and a pH of 7.37. Spent meal 2 had an as-is protein content of 7.13 wt % and a solids content of 15.94 wt % (44.73% protein (N×6.25) d.b.). The extract 2 protein solution was then further clarified by centrifugation using a disc stack centrifuge to remove additional suspended (finer) residual solids (17.66 kg), having an as-is protein content of 6.68 wt % and solids content of 9.08% (73.57% protein (N×6.25) d.b.), and provide 617 L of protein solution having a protein content of 0.58 wt %. The protein solution was then fed to a three-phase separator which removed 28.86 kg of oil phase and 10.42 kg of suspended solids and provided 560 L of protein solution having a protein content of 0.70 wt %. This solution was discarded.

The finer residual solids captured in the first disc stack centrifuge step (52.10 kg) was combined with the finer residual solids captured in the second disc stack centrifuge step (17.66 kg) and then diluted with 280 L of RO water having a target temperature of 60° C. The solution was centrifuged with a disc stack centrifuge to provide 21.44 kg of washed finer solids, having an as-is protein content of 12.31 wt % and solids content of 20.91% (58.87% protein (N×6.25) d.b.), and 350 L of used wash solution having a protein content of 0.88 wt %. The used wash solution was then fed to a three-phase separator which removed 20.94 kg of oil phase, 29.46 kg of suspended solids and provided 302 L of used wash solution having a protein content of 1.00 wt %. This solution was discarded.

Aliquots of spent meal 2 (15.64 kg) and washed finer residual solids (4.36 kg) were combined with RO water (40 L) and the mixture pasteurized at about 72° C. for 1 minute. An aliquot of pasteurized sample was spray dried to yield a product having a protein content of 46.69% (N×6.25) d.b. The product was termed SF26-B21-23A SF871PC.

Note all cited pH values were from measurements conducted with the sample at room temperature unless otherwise noted. The first extraction slurries were noted as having a pH of 7.09 at 62.6° C. and 7.03 at 59.2° C. The second extraction slurries were noted as having a pH of 7.15 at 58.5° C. and 7.16 at 58.3° C.

### Example 18

15 kg of sunflower flour/meal (partially defatted, made from kernels) was combined with 150 L of filtered city water having a temperature of 63.8° C., 0.15 kg of ascorbic acid and 0.50 kg of 25% NaOH solution. The mixture was stirred for 10 minutes. A portion of suspended (coarse) residual solids, termed spent meal 1 (22.04 kg) were removed by centrifugation using a decanter centrifuge to provide a protein solution, termed extract 1, having a protein content of 3.70 wt % and a pH of 7.79. The extract 1 protein solution was then further clarified by centrifugation using a disc stack centrifuge to remove additional suspended (finer) residual solids (12.42 kg) and provide 133 L of protein solution having a protein content of 2.98 wt %. This solution was discarded.

22.04 kg of spent meal 1 was combined with 150 L of filtered city water having a temperature of 64.1° C., 0.15 kg of ascorbic acid, 0.14 kg of 25% NaOH solution and stirred for a target time of 10 minutes. A portion of the suspended (coarse) residual solids, termed spent meal 2 (19.20 kg) were removed by centrifugation using a decanter centrifuge to provide a protein solution termed extract 2, having a protein content of 0.72 wt % and a pH of 7.81. The extract 2 protein solution was then further clarified by centrifugation using a disc stack centrifuge to remove additional suspended (finer) residual solids (7.52 kg) and provide 161 L of protein solution having a protein content of 0.59 wt %. This solution was discarded.

The finer residual solids captured in the first disc stack centrifuge step (12.42 kg) was combined with the finer residual solids captured in the second disc stack centrifuge step (7.52 kg) and then diluted with 80 L of filtered city water having a target temperature of 60° C. The solution was centrifuged with a disc stack centrifuge to provide 1.86 kg of washed finer residual solids and 112 L of used wash solution having a protein content of 0.56 wt %, which was discarded. An additional 2.84 kg of washed finer residual solids was recovered by flushing the disc stack discharge chute with filtered city water.

A mixture of spent meal 2, washed finer residual solids and filtered city water was prepared and the mixture pasteurized at 72° C. for 1 minute. Pasteurized sample was spray dried to yield a product having a protein content of 43.65% (N×6.25) d.b. The product was termed SF26-C08-23A SF871PC.

Note all cited pH values were from measurements conducted with the sample at room temperature unless otherwise noted. The first extraction slurry was noted as having a pH of 7.11 at 57° C. The second extraction slurry was noted as having a pH of 7.11 at 57.6° C.

### Example 19

30 kg of sunflower flour/meal (partially defatted, made from kernels) was combined with 300 L of filtered city water having a temperature of 64.1° C., 0.30 kg of ascorbic acid and 0.92 kg of 25% NaOH solution. The mixture was stirred for an unrecorded length of time. A portion of suspended (coarse) residual solids, termed spent meal 1 (49.7 kg) were removed by centrifugation using a decanter centrifuge to provide a protein solution, termed extract 1, having a protein content of 4.07 wt % and a pH of 7.44. The extract 1 protein solution was then further clarified by centrifugation using a disc stack centrifuge to remove additional suspended (finer) residual solids (19.80 kg) and provide 274 L of protein solution having a protein content of 3.16 wt %. The protein solution was then fed to a three-phase separator which removed 9.80 kg of oil phase, 10.10 kg of suspended solids and provided 260 L of protein solution having a protein content of 3.02 wt %. The pH of the solution was adjusted from 7.45 to 3.10 by the addition of 2.32 kg of HCl solution (concentrated HCl diluted with an equal volume of water) to provide a first acidified protein solution.

49.7 kg of spent meal 1 was combined with 300 L of filtered city water having a temperature of 65° C., 0.30 kg of ascorbic acid, 0.28 kg of 25% NaOH solution and stirred for 10 minutes. A portion of the suspended (coarse) residual solids, termed spent meal 2 (40.48 kg) were removed by centrifugation using a decanter centrifuge to provide a protein solution termed extract 2, having a protein content of 0.74 wt % and a pH of 7.39. The extract 2 protein solution was then further clarified by centrifugation using a disc stack centrifuge to remove additional suspended (finer) residual solids (22.4 kg) and provide 300 L of protein solution having a protein content of 0.64 wt %. The protein solution was then fed to a three-phase separator which removed 4.88 kg of oil phase and 9.92 kg of suspended solids and provided 300 L of protein solution having a protein content of 0.51 wt %. The pH of the solution was adjusted from 7.40 to 2.91 by the addition of 1.09 kg of HCl solution (concentrated HCl diluted with an equal volume of water) to provide a second acidified protein solution.

The finer residual solids captured in the first disc stack centrifuge step (19.80 kg) was combined with the finer residual solids captured in the second disc stack centrifuge step (22.4 kg) and then diluted with filtered city water (168.8 L) having a target temperature of 60° C. The solution was centrifuged with a disc stack centrifuge to provide 9.06 kg of washed finer solids and 221 L of used wash solution having a protein content of 0.49 wt %. The used wash solution was then fed to a three-phase separator which removed 6.34 kg of oil phase, 9.92 kg of suspended solids and provided 180 L of used wash solution having a protein content of 0.56 wt %. The pH of this solution was adjusted from 7.38 to 2.62 by the addition of 0.44 kg of HCl solution (concentrated HCl diluted with equal volume of water) to provide an acidified used wash solution.

The three acidified protein solutions were combined to provide an acidified protein solution having a protein content of 1.32 wt % and a pH of 2.98. This solution was reduced in volume to 100 L by concentration on a polyethersulfone membrane having a molecular weight cut-off (MWCO) of 10,000 daltons, operated at a temperature of about 59° C. The concentrated acidified protein solution with a protein content of 8.23 wt % was then diafiltered on the same membrane with 200 L of filtered city water at a temperature of about 64° C. then further concentrated to a protein concentration of 10.30 wt %. The product was displaced from the membrane system with filtered city water. The collected diafiltered acidified protein solution (112 L) had a protein content of 8.08 wt %.

110 L of diafiltered acidified protein solution was adjusted to pH 7.12 by the addition of 1.14 kg of 25% NaOH solution. This pH adjusted protein solution was mixed with filtered city water (550 L, target temperature of 60° C.), then centrifuged with a disc stack centrifuge to provide 585 L solids-removed protein solution and 58.44 kg of protein solids.

The 585 L of solids-removed protein solution having a protein content of 0.39 wt % was reduced in volume to 55 L by concentration on a polyethersulfone membrane with a molecular weight cut-off (MWCO) of 10,000 daltons operated at a temperature of 57° C. This solution, having a protein concentration of 2.59 wt %, was then diafiltered on the same membrane with 55 L of filtered city water at a temperature of about 59° C. then further concentrated to a protein concentration of 4.60 wt %. The resulting diafiltered protein solution (33.89 kg) was combined with the 58.44 kg of protein solids and pasteurized at 72° C. for 1 minute. The pasteurized material, having a protein content of 8.48 wt % was spray dried to yield a product having a protein content of 94.02% (N×6.25) d.b. This product was termed SF26-C13-23A SF871NDS2.

Note all cited pH values were from measurements conducted with the sample at room temperature unless otherwise noted. The first extraction slurry was noted as having a pH of 7.14 at 57.1° C. The second extraction slurry was noted as having a pH of 7.19 at 51.5° C.

### Example 20

22.68 kg of sunflower flour/meal (partially defatted, made from kernels) was combined with 225 L of filtered city water having a target temperature of 60° C., 0.225 kg of ascorbic acid and 0.58 kg of NaOH solution. The mixture was stirred for an unrecorded length of time. A portion of suspended (coarse) residual solids, termed spent meal 1 (50.9 kg) were removed by centrifugation using a decanter centrifuge to provide a protein solution, termed extract 1, having a protein content of 3.35 wt % and a pH of 7.18. The extract 1 protein solution was then further clarified by centrifugation using a disc stack centrifuge to remove additional suspended (finer) residual solids (21.32 kg) and provide 206 L of protein solution having a protein content of 2.91 wt %. The protein solution from the disc stack step was then fed to a three-phase separator which removed 6.12 kg of oil phase, 9.50 kg of suspended solids and provided 203 L of protein solution having a protein content of 2.50 wt %. The pH of the solution was adjusted from 7.21 to 2.99 by the addition of 1.40 kg of HCl solution (concentrated HCl diluted with an equal volume of water) to provide a first acidified protein solution.

50.9 kg of spent meal 1 was combined with 300 L of filtered city water having a temperature of 63.7° C., 0.30 kg of ascorbic acid, 0.20 kg of 25% NaOH solution and stirred for a target time of 10 minutes. A portion of the suspended (coarse) residual solids, termed spent meal 2 (40.68 kg) were removed by centrifugation using a decanter centrifuge to provide a protein solution termed extract 2, having a protein content of 0.76 wt % and a pH of 7.38. The extract 2 protein solution was then further clarified by centrifugation using a disc stack centrifuge to remove additional suspended (finer) residual solids (22.44 kg) and provide a protein solution having a protein content of 0.60 wt %. The protein solution was then fed to a three-phase separator which removed 5.74 kg of oil phase and 9.50 kg of suspended solids and provided 300 L of protein solution having a protein content of 0.62 wt %. The pH of the solution was adjusted from 7.26 to 3.00 by the addition of 0.80 kg of HCl solution (concentrated HCl diluted with an equal volume of water) to provide a second acidified protein solution.

The finer residual solids captured in the first disc stack centrifuge step (21.32 kg) was combined with the finer residual solids captured in the second disc stack centrifuge step (22.44 kg) and then diluted with filtered city water having a target temperature of 60° C. (262.56 L). The solution was centrifuged with a disc stack centrifuge to provide 22.68 kg of washed finer solids and 329.3 L of used wash solution having a protein content of 0.21 wt %. The used wash solution was then fed to a three-phase separator which removed 2.39 kg of oil phase, 9.88 kg of suspended solids and provided 300 L of used wash solution having a protein content of 0.18 wt %. The pH of this solution was adjusted from 7.53 to 3.07 by the addition of 0.26 kg of HCl solution (concentrated HCl diluted with equal volume of water) to provide an acidified used wash solution.

The three acidified protein solutions were combined to provide an acidified protein solution having a protein content of 0.96 wt % and a pH of 2.98. This solution was reduced in volume to 85 L by concentration on a polyethersulfone membrane having a molecular weight cut-off (MWCO) of 10,000 daltons, operated at a temperature of about 62° C. The concentrated acidified protein solution with a protein content of 8.40 wt % was then diafiltered on the same membrane with 170 L of filtered city water at a temperature of about 63° C. then further concentrated to a protein concentration of 13.33 wt %. The product was displaced from the membrane system with filtered city water. The collected diafiltered acidified protein solution (53.20 kg) had a protein content of 10.55 wt %.

The diafiltered acidified protein solution was adjusted to pH 7.00. This pH adjusted protein solution was mixed with 300 L of filtered city water having a temperature of 63.3° C.), then centrifuged with a disc stack centrifuge to provide 320 L solids-removed protein solution and 47.58 kg of protein solids.

The 320 L of solids-removed protein solution having a protein content of 0.46 wt % was reduced in volume to 50 L by concentration on a polyethersulfone membrane with a molecular weight cut-off (MWCO) of 10,000 daltons operated at a temperature of 58° C. The protein solution was concentrated to a protein content of 1.86 wt %. This solution was then diafiltered on the same membrane with 50 L of filtered city water at a temperature of about 57° C. then further concentrated to a protein concentration of 3.92 wt %. The product was displaced from the membrane system with filtered city water to yield 23.14 kg of diafiltered protein solution having a protein content of 3.12 wt %. Diafiltered protein solution and protein solids were combined and pasteurized at 72° C. for 1 minute. The pasteurized material, having a protein content of 6.83 wt % was spray dried to yield a product having a protein content of 92.72% (N×6.25) d.b. This product was termed SF19-D24-23A SF871NDS2.

Aliquots of spent meal 2 and washed finer residual solids were combined and diluted with filtered city water. The mixture was then pasteurized at about 73° C. for about 1 minute. About 120 kg of pasteurized sample was spray dried to yield a product having a protein content of 43.55% (N×6.25) d.b. The product was termed SF19-D24-23A SF871PC.

Note all cited pH values were from measurements conducted with the sample at room temperature unless otherwise noted. The first extraction slurry was noted as having a pH of 7.12 at 59° C.

### Example 21

30 kg of sunflower flour/meal made by comminuting presscake from the pressing of partially dehulled black oil sunflower seed at a temperature of about 75-78° C. was combined with 300 L of filtered city water having a temperature of 69.1° C., 0.30 kg of ascorbic acid and 0.88 kg of 25% NaOH solution. The mixture was stirred for 15 minutes. A portion of suspended (coarse) residual solids, termed spent meal 1 (65.98 kg) were removed by centrifugation using a decanter centrifuge to provide a protein solution, termed extract 1, having a protein content of 2.38 wt % and a pH of 7.41. Spent meal 1 had an as-is protein content of 7.05 wt % and a solids content of 18.63 wt % (37.84% protein (N×6.25) d.b.). The extract 1 protein solution was then further clarified by centrifugation using a disc stack centrifuge to remove additional suspended (finer) residual solids (18.49 kg), having an as-is protein content of 7.47 wt % and solids content of 14.20% (52.61% protein (N×6.25) d.b.), and provide 260 L of protein solution having a protein content of 2.23 wt %. The protein solution was then fed to a three-phase separator which removed 19.04 kg of oil phase, 10.88 kg of suspended solids and provided 220 L of protein solution having a protein content of 2.17 wt % and a pH of 7.26.

65 kg of spent meal 1 was combined with 300 L of filtered city water having a temperature of 65.0° C., 0.30 kg of ascorbic acid, 0.24 kg of 25% NaOH solution and stirred for 10 minutes. A portion of the suspended (coarse) residual solids, termed spent meal 2 (49.9 kg) were removed by centrifugation using a decanter centrifuge to provide a protein solution termed extract 2, having a protein content of 0.57 wt % and a pH of 7.44. Spent meal 2 had an as-is protein content of 5.28 wt % and a solids content of 18.10 wt % (29.17% protein (N×6.25) d.b.). The extract 2 protein solution was then further clarified by centrifugation using a disc stack centrifuge to remove additional suspended (finer) residual solids (5.48 kg), having an as-is protein content of 7.13 wt % and solids content of 10.88% (65.53% protein (N×6.25) d.b.), and provide 330 L of protein solution having a protein content of 0.41 wt %. The protein solution was then fed to a three-phase separator which removed 12.96 kg of oil phase and 11.12 kg of suspended solids and provided 300 L of protein solution having a protein content of 0.37 wt % and a pH of 7.29.

The finer residual solids captured in the first disc stack centrifuge step (18.49 kg) was combined with the finer residual solids captured in the second disc stack centrifuge step (5.48 kg) and then diluted with filtered city water (96 L) having a temperature of 57.9° C. The solution was centrifuged with a disc stack centrifuge to provide 9.82 kg of washed finer solids, having an as-is protein content of 7.65 wt % and solids content of 14.37% (53.24% protein (N×6.25) d.b.), and 125 L of used wash solution having a protein content of 0.41 wt %. Another 6.10 kg of washed finer solids were collected by flushing the disc stack discharge chute with filtered city water. The used wash solution was then fed to a three-phase separator which removed an unrecorded weight of oil phase, 22.92 kg of suspended solids and provided 120 L of used wash solution having a protein content of 0.37 wt % and a pH of 7.64.

The three protein solutions provided by the oil separator steps were combined and the pH of the combined solution adjusted to 2.99 by the addition of 2.86 kg of HCl solution (concentrated HCl diluted with an equal volume of water). This acidified solution, having a protein concentration of 0.98 wt %, was reduced in volume from 640 to 60 L by concentration on a polyethersulfone membrane having a molecular weight cut-off (MWCO) of 10,000 daltons, operated at a temperature of about 58° C. The concentrated acidified protein solution with a protein content of 7.83 wt % was then diafiltered on the same membrane with 120 L of filtered city water at a temperature of about 58° C. then further concentrated to a protein concentration of 10.30 wt %. The product was displaced from the membrane system with filtered city water. The collected diafiltered acidified protein solution (65 L) had a protein content of 7.11 wt %.

The diafiltered acidified protein solution was adjusted to pH 6.97 by the addition of 0.74 kg of 25% NaOH solution. This pH adjusted protein solution was mixed with 325 L of filtered city water having a target temperature of 60° C., then centrifuged with a disc stack centrifuge to provide 365 L solids-removed protein solution and 31.32 kg of protein solids.

The 365 L of solids-removed protein solution having a protein content of 0.41 wt % was reduced in volume to 40 L by concentration on a polyethersulfone membrane with a molecular weight cut-off (MWCO) of 10,000 daltons operated at a temperature of about 56° C. The protein solution was concentrated to a protein content of 2.27 wt %. This solution was then diafiltered on the same membrane with 40 L of filtered city water at a temperature of 60° C. 42.7 kg of diafiltered protein solution was combined with the 31.32 kg of protein solids and pasteurized at 72° C. for 1 minute. The pasteurized material, having a protein content of 5.48 wt % was spray dried to yield a product having a protein content of 88.12% (N×6.25) d.b. This product was termed SF38-F28-23A SF871NDS2.

Aliquots of spent meal 2 (1 kg) and washed finer residual solids (0.241 kg) were combined and freeze dried to provide a product having a protein content of 31.50% (N×6.25) d.b. The product was termed SF38-F28-23A SF871PC.

Note all cited pH values were from measurements conducted with the sample at room temperature unless otherwise noted. The first extraction slurry was noted as having a pH of 7.1 at 64.1° C. The second extraction slurry was noted as having a pH of 7.1 at 62.1° C.

### Example 22

30 kg of sunflower flour/meal made by comminuting presscake from the pressing of a mixture of 8.33 parts black oil sunflower kernels/1 part black oil sunflower seed at a temperature of about 73-76° C. was combined with 300 L of filtered city water having a target temperature of 60° C., 0.30 kg of ascorbic acid and an unrecorded amount of 25% NaOH solution. The mixture was stirred for an unrecorded length of time. A portion of suspended (coarse) residual solids, termed spent meal 1 (72.13 kg) were removed by centrifugation using a decanter centrifuge to provide a protein solution, termed extract 1, having a protein content of 2.94 wt % and a pH of 7.27. Spent meal 1 had an as-is protein content of 7.95 wt % and a solids content of 20.53 wt % (38.72% protein (N×6.25) d.b.). The extract 1 protein solution was then further clarified by centrifugation using a disc stack centrifuge to remove additional suspended (finer) residual solids (15.86 kg), having an as-is protein content of 6.24 wt % and solids content of 10.53% (59.26% protein (N×6.25) d.b.), and provide 238.47 L of protein solution having a protein content of 2.60 wt %. The protein solution was then fed to a three-phase separator which removed 9.90 kg of oil phase, 10.54 kg of suspended solids and provided 235 L of protein solution having a protein content of 2.40 wt % and a pH of 7.22.

72.13 kg of spent meal 1 was combined with 300 L of filtered city water having a temperature of 64.0° C., 0.30 kg of ascorbic acid and 0.30 kg of 25% NaOH solution and stirred for 10 minutes. A portion of the suspended (coarse) residual solids, termed spent meal 2 (46.73 kg) were removed by centrifugation using a decanter centrifuge to provide a protein solution termed extract 2, having a protein content of 0.72 wt % and a pH of 7.55. Spent meal 2 had an as-is protein content of 6.45 wt % and a solids content of 19.03 wt % (33.89% protein (N×6.25) d.b.). The extract 2 protein solution was then further clarified by centrifugation using a disc stack centrifuge to remove additional suspended (finer) residual solids (16.11 kg), having an as-is protein content of 3.24 wt % and solids content of 4.87% (66.53% protein (N×6.25) d.b.), and provide 308.4 L of protein solution having a protein content of 0.63 wt %. The protein solution was then fed to a three-phase separator which removed 5.14 kg of oil phase and 10.78 kg of suspended solids and provided 300 L of protein solution having a protein content of 0.58 wt % and a pH of 7.36.

The finer residual solids captured in the first disc stack centrifuge step (15.86 kg) was combined with the finer residual solids captured in the second disc stack centrifuge step (16.11 kg) and then diluted with filtered city water having a target temperature of 60° C. (128 L). The solution was centrifuged with a disc stack centrifuge to provide 12.52 kg of washed finer solids, having an as-is protein content of 6.21 wt % and solids content of 9.80% (63.37% protein (N×6.25) d.b.), and an unrecorded volume of used wash solution having a protein content of 0.42 wt %. The used wash solution was then fed to a three-phase separator which removed 2.6 kg of oil phase, 10.58 kg of suspended solids and provided 165 L of used wash solution having a protein content of 0.35 wt % and a pH of 7.53.

The three protein solutions provided by the oil separator steps were combined and the pH of the combined solution adjusted to 2.95 by the addition of 3.3 kg of HCl solution (concentrated HCl diluted with an equal volume of water). This acidified solution, having a protein content of 1.10 wt %, was reduced in volume from 700 to 80 L by concentration on a polyethersulfone membrane having a molecular weight cut-off (MWCO) of 10,000 daltons, operated at a temperature of about 60° C. The concentrated acidified protein solution with a protein content of 7.84 wt % was then diafiltered on the same membrane with 160 L of filtered city water at a temperature of about 59° C. then further concentrated to a protein concentration of 9.03 wt %. The product was displaced from the membrane system with filtered city water. The collected diafiltered acidified protein solution (81.82 kg) had a protein content of 7.77 wt %.

The diafiltered acidified protein solution was adjusted to pH 7.17. This pH adjusted protein solution was mixed with filtered city water having a target temperature of 60° C., then centrifuged with a disc stack centrifuge to provide 479.8 L solids-removed protein solution and 33.74 kg of protein solids. Another 6.92 kg of protein solids were collected by flushing the disc stack discharge chute with filtered city water.

The solids-removed protein solution having a protein content of 0.30 wt % was reduced in volume to 30 L by concentration on a polyethersulfone membrane with a molecular weight cut-off (MWCO) of 10,000 daltons operated at a temperature of about 58° C. The protein solution was concentrated to a protein content of 3.47 wt %. This solution was then diafiltered on the same membrane with 30 L of filtered city water at a temperature of about 58° C. then further concentrated to a protein concentration of 3.64 wt %. 19.3 kg of diafiltered protein solution was combined with the 40.66 kg of protein solids and pasteurized at about 72° C. for 1 minute. The pasteurized material, having a protein content of 8.32 wt % was spray dried to yield a product having a protein content of 96.40% (N×6.25) d.b. This product was termed SF39-G11-23A SF871NDS2.

Aliquots of spent meal 2 and washed finer residual solids were combined and freeze dried to provide a product having a protein content of 37.40% (N×6.25) d.b. The product was termed SF39-G11-23A SF871PC.

Note all cited pH values were from measurements conducted with the sample at room temperature unless otherwise noted. The second extraction slurry was noted as having a pH of 7.14 at 56.5° C.

### Example 23

This Example illustrates the protein content of the sunflower protein products prepared as described in Examples 1 to 22 as well as the commercially available sunflower protein products Sunbloom (Sunbloom Proteins GmbH), Heliaflor 55 (Austrade Inc.) and Sunflower Seed Powder 50% Protein (Acetar Bio-Tech Inc.).

As-is protein content was determined by combustion analysis (N×6.25). Dry basis protein contents were calculated from the as-is protein value and the dry matter content of the samples (oven drying method). The protein content of the samples is shown in Table 3.

TABLE 3
Protein content of sunflower protein products

| | % protein | |
|---|---|---|
| | (N × 6.25), | % protein (N × 6.25), |
| Product | as-is | d.b. |
| SF25-I12-22A SF871NDS2 | 94.83 | 98.14 |
| SF19-I28-22A SF871NDS2 | 90.44 | 93.58 |
| SF19-K15-22A SF871NDS2 | 92.19 | 97.69 |
| SF26-L07-22A SF871NDS2 | 96.69 | 101.98 |
| SF26-A10-23A SF871NDS2 | 96.42 | 100.44 |
| SF26-A12-23A SF871NDS2 | 96.41 | 100.18 |
| SF28-A25-23A SF871NDS2 | 92.87 | 95.78 |
| SF26-A30-23A SF871NDS2 | 95.48 | 99.63 |
| SF26-B14-23A SF871NDS2 | 92.87 | 96.84 |
| SF26-B27-23A SF871NDS2 | 93.56 | 96.86 |
| SF26-C13-23A SF871NDS2 | 90.78 | 94.02 |
| SF19-D24-23A SF871NDS2 | 90.23 | 92.72 |
| SF38-F28-23A SF871NDS2 | 84.83 | 88.12 |
| SF39-G11-23A SF871NDS2 | 94.09 | 96.40 |
| SF15-C31-22A SF871NDS | 98.80 | 104.38 |
| SF17-D27-22A SF871NDS | 100.60 | 106.82 |
| SF19-E16-22A SF871NDS | 96.34 | 101.58 |
| SF19-K15-22A SF871NDS | 97.54 | 102.64 |
| SF26-L07-22A SF871NDS | 98.55 | 106.21 |
| SF26-A10-23A SF871NDS | 100.50 | 104.16 |
| SF26-A12-23A SF871NDS | 100.20 | 103.75 |
| SF28-A25-23A SF871NDS | 95.40 | 98.80 |
| SF17-D27-22A SF871NDSRet | 84.24 | 89.00 |
| SF19-E16-22A SF871NDSRet | 63.77 | 68.89 |
| SF19-K15-22A SF871NDSRet | 74.61 | 79.47 |
| SF26-L07-22A SF871NDSRet | 78.92 | 83.37 |
| SF26-A10-23A SF871NDSRet | 83.45 | 86.49 |
| SF26-A12-23A SF871NDSRet | 84.45 | 88.01 |
| SF28-A25-23A SF871NDSRet | 78.30 | 82.06 |
| SF26-A12-23A SF871PC | 42.11 | 45.41 |
| SF26-A30-23A SF871PC | 45.62 | 49.09 |
| SF19-J06-22A SF871PC | 37.20 | 41.26 |
| SF26-B01-23A SF871PC | 38.79 | 43.05 |
| SF26-B07-23A SF871PC | 45.09 | 47.80 |
| SF26-B21-23A SF871PC | 42.84 | 46.69 |
| SF26-C08-23A SF871PC | 40.81 | 43.65 |
| SF19-D24-23A SF871PC | 41.47 | 43.55 |
| SF38-F28-23A SF871PC | 31.40 | 31.50 |
| SF39-G11-23A SF871PC | 37.00 | 37.40 |
| SF19-E16-22A SF871PN2 | 53.36 | 55.91 |
| SF19-I28-22A SF871SM | 44.67 | 47.66 |
| Sunbloom | 50.48 | 53.97 |
| Heliaflor 55 | 51.43 | 55.06 |
| Sunflower Seed Powder | 56.00 | 58.04 |
| 50% Protein | | |

As may be seen from the results in Table 3, the SF871NDS2, SF871NDS and SF871NDSRet products, derived from the sunflower protein solution, were much higher in protein than the commercial products evaluated. Products derived from the residual solids after protein extraction (SF871PC, SF871PN2, SF871SM) had protein contents in the range of or lower than the commercial sunflower protein products.

### Example 24

This Example illustrates the protein solubility of the sunflower protein products prepared as described in Examples 1-6, 8-13 and 19-22 as well as the commercially available sunflower protein products Sunbloom (Sunbloom Proteins GmbH) and Sunflower Seed Powder 50% Protein (Acetar Bio-Tech Inc.).

A 100 ml beaker and magnetic stir bar were pre-weighed. Sufficient protein powder to supply 2 g of protein was weighed into the beaker. 10-15 ml of RO water was added and the sample stirred with the stir bar until the powder was thoroughly wetted. At this point another 25-30 ml of RO water was added and mixed in. The pH of the sample was adjusted to the target value with 0.5M NaOH or HCl as necessary and the sample stirred on a magnetic stir plate set to a speed just below forming a vortex in the sample for about 55-60 minutes with the pH periodically checked and adjusted if necessary during this time. After the end of the stirring time the pH of the sample was checked and corrected as necessary again and then additional RO water added to bring the sample weight to 50 g (protein concentration of 4% w/w) and mixed in. Approximately 20 ml of the dispersion was then transferred to a 50 ml centrifuge tube and centrifuged at 10,000 rpm (7,800 g) in a Sorvall SS-34 rotor for 10 minutes with the centrifuge set to 20° C. After the centrifugation was completed 10 ml of supernatant was removed from the centrifuge tube by pipet. Samples of the supernatant and the original dispersion were tested for protein content by combustion analysis (N×6.25).

Solubility (%)=(supernatant protein conc./original dispersion protein conc.)×100

The protein solubility of the sunflower protein products is shown in Table 4.

TABLE 4
Protein solubility of sunflower protein
products at different pH values

| | pH 4 | pH 5.5 | pH 7 |
|---|---|---|---|
| SF25-I12-22A SF871NDS2 | 14.4 | 8.5 | 15.9 |
| SF19-128-22A SF871NDS2 | 17.7 | 10.1 | 19.1 |
| SF19-K15-22A SF871NDS2 | 18.1 | 10.2 | 20.4 |
| SF26-A10-23A SF871NDS2 | 18.4 | 9.6 | 18.8 |
| SF26-A12-23A SF871NDS2 | 20.4 | 10.0 | 17.7 |
| SF28-A25-23A SF871NDS2 | 22.2 | 14.9 | 24.4 |
| SF26-A30-23A SF871NDS2 | 19.1 | 8.5 | 20.9 |
| SF26-B14-23A SF871NDS2 | 16.3 | 9.3 | 18.3 |
| SF26-B27-23A SF871NDS2 | 17.1 | 9.3 | 20.5 |
| SF26-C13-23A SF871NDS2 | 15.5 | 8.9 | 15.2 |
| SF19-D24-23A SF871NDS2 | 15.2 | 9.6 | 13.8 |
| SF38-F28-23A SF871NDS2 | 13.7 | 8.3 | 20.6 |
| SF39-G11-23A SF871NDS2 | 12.9 | 6.5 | 14.1 |
| SF15-C31-22A SF871NDS | 6.0 | 3.5 | 4.2 |
| SF17-D27-22A SF871NDS | 8.1 | 4.7 | 4.2 |
| SF19-E16-22A SF871NDS | 6.1 | 5.9 | 4.3 |
| SF28-A25-23A SF871NDS | 14.8 | 10.7 | 3.9 |
| SF17-D27-22A SF871NDSRet | 20.8 | 65.2 | 88.6 |
| SF19-K15-22A SF871NDSRet | 19.2 | 64.0 | 89.1 |
| Sunbloom | 20.4 | 20.7 | 41.4 |
| Sunflower Seed Powder 50% Protein | 15.7 | 12.5 | 13.1 |

As may be seen from the results presented in Table 4, the protein solubility of the SF871NDS2 product was similar to that of the commercial products when evaluated at pH 4 and within the range of the commercial products when evaluated at pH 7. The SF871NDS product appeared to have a lower protein solubility than the commercial products. The SF871NDSRet product had a higher protein solubility than the commercial products at pH 5.5 and 7.

### Example 25

This Example contains an evaluation of the dry colour of the sunflower protein products prepared as described in Example 1 to 22 as well as the commercially available sunflower protein products Sunbloom (Sunbloom Proteins GmbH) and Heliaflor 55 (Austrade Inc.). This is an assessment of the colour of the powdered products, as is. Dry colour (CIEL*a*b*) was assessed using either a HunterLab ColorQuest XE or HunterLab UltraScan VIS instrument operated in reflectance mode (RSEX) with an illuminant setting of D65 and an observer setting of 10°. The results are shown in the following Table 5.

TABLE 5
Dry colour of sunflower protein products

| Product | L* | a* | b* |
|---|---|---|---|
| SF25-I12-22A SF871NDS2 | 83.80 | −0.64 | 14.03 |
| SF19-I28-22A SF871NDS2 | 81.18 | −0.04 | 15.55 |
| SF19-K15-22A SF871NDS2 | 83.54 | −0.48 | 12.64 |
| SF26-L07-22A SF871NDS2 | 82.48 | −0.32 | 12.78 |
| SF26-A10-23A SF871NDS2 | 82.47 | −0.28 | 12.71 |
| SF26-A12-23A SF871NDS2 | 82.29 | −0.34 | 12.72 |
| SF28-A25-23A SF871NDS2 | 80.74 | 0.13 | 12.47 |
| SF26-A30-23A SF871NDS2 | 84.99 | −0.56 | 11.07 |
| SF26-B14-23A SF871NDS2 | 83.46 | −0.19 | 12.50 |
| SF26-B27-23A SF871NDS2 | 83.93 | −0.59 | 11.51 |
| SF26-C13-23A SF871NDS2 | 82.60 | −0.29 | 12.50 |
| SF19-D24-23A SF871NDS2 | 82.33 | −0.10 | 12.82 |
| SF38-F28-23A SF871NDS2 | 64.57 | 2.60 | 18.40 |
| SF39-G11-23A SF871NDS2 | 69.24 | 1.85 | 17.33 |
| SF15-C31-22A SF871NDS | 82.51 | −0.28 | 12.90 |
| SF17-D27-22A SF871NDS | 83.49 | −0.33 | 12.79 |
| SF19-E16-22A SF871NDS | 82.39 | −0.53 | 15.37 |
| SF19-K15-22A SF871NDS | 82.93 | −0.86 | 14.04 |
| SF26-L07-22A SF871NDS | 83.80 | −0.74 | 11.76 |
| SF26-A10-23A SF871NDS | 82.01 | −0.27 | 13.75 |
| SF26-A12-23A SF871NDS | 81.74 | −0.39 | 13.73 |
| SF28-A25-23A SF871NDS | 81.17 | −0.39 | 13.10 |
| SF17-D27-22A SF871NDSRet | 81.95 | 0.23 | 13.81 |
| SF19-E16-22A SF871NDSRet | 82.85 | 0.30 | 12.48 |
| SF19-K15-22A SF871NDSRet | 81.98 | 0.52 | 13.19 |
| SF26-L07-22A SF871NDSRet | 80.64 | 0.93 | 12.52 |
| SF26-A10-23A SF871NDSRet | 82.16 | −0.03 | 11.90 |
| SF26-A12-23A SF871NDSRet | 83.01 | −0.12 | 11.36 |
| SF28-A25-23A SF871NDSRet | 78.87 | 0.88 | 10.97 |
| SF26-A12-23A SF871PC | 78.05 | 0.34 | 13.45 |
| SF26-A30-23A SF871PC | 77.81 | 0.34 | 13.74 |
| SF19-J06-22A SF871PC | 72.65 | −0.15 | 13.40 |
| SF26-B01-23A SF871PC | 78.22 | 0.54 | 12.82 |
| SF26-B07-23A SF871PC | 79.03 | −0.04 | 13.32 |
| SF26-B21-23A SF871PC | 79.68 | 0.02 | 12.07 |
| SF26-C08-23A SF871PC | 78.51 | 0.36 | 13.94 |
| SF19-D24-23A SF871PC | 77.37 | 0.61 | 13.44 |
| SF19-I28-22A SF871SM | 73.87 | 1.56 | 16.00 |
| Sunbloom | 79.89 | 0.19 | 9.15 |
| Heliaflor 55 | 78.96 | −0.20 | 9.78 |

As may be seen from the results of Table 5, when the protein source is dehulled material, the products derived from the sunflower protein solution (SF871NDS2, SF871NDS, SF871NDSRet) were generally lighter and yellower than the commercial products evaluated. When there was notable hull material in the protein source (SF38-F28-23A, SF39-G11-23A), the SF871NDS2 produced was darker, redder and yellower than the commercial products evaluated. The evaluated products derived from the residual solids (SF871PC, SF871SM) were yellower than the commercial products evaluated.

### Example 26

This Example contains an evaluation of the water binding capacity of the sunflower protein products prepared as described in Examples 1 to 22 as well as the commercially available sunflower protein products Sunbloom (Sunbloom Proteins GmbH), Heliaflor 55 (Austrade Inc.) and Sunflower Seed Powder 50% Protein (Acetar Bio-Tech Inc.).

The water binding capacity of the products was determined by the following procedure. Protein powder (1 g) was weighed into centrifuge tubes (50 ml) of known weight. To this powder was added approximately 20 ml of RO water at the natural pH. The contents of the tubes were mixed using a vortex mixer at moderate speed for 1 minute. The samples were incubated at room temperature for 5 minutes then mixed with the vortex for 30 seconds. This was followed by incubation at room temperature for another 5 minutes then another 30 seconds of vortex mixing. The samples were then centrifuged at 1,000 g for 15 minutes at 20° C. After centrifugation, the supernatant was carefully poured off, ensuring that all solid material remained in the tube. The centrifuge tube was then re-weighed and the weight of water saturated sample was determined.

Water binding capacity (WBC) was calculated as:

$$WBC ( ml / g ) = ( mass of water saturated sample ( g ) - mass of initial sample ( g ) ) / ( mass of initial sample ( g ) \times total solids content of sample )$$

The WBC results are shown in Table 6.

TABLE 6
WBC of sunflower protein products

| Product | WBC (ml/g) |
|---|---|
| SF25-I12-22A SF871NDS2 | 2.82 |
| SF19-I28-22A SF871NDS2 | 2.47 |
| SF19-K15-22A SF871NDS2 | 2.80 |
| SF26-L07-22A SF871NDS2 | 2.90 |
| SF26-A10-23A SF871NDS2 | 2.29 |
| SF26-A12-23A SF871NDS2 | 2.49 |
| SF28-A25-23A SF871NDS2 | 2.63 |
| SF26-B14-23A SF871NDS2 | 2.71 |
| SF26-B27-23A SF871NDS2 | 2.91 |
| SF26-C13-23A SF871NDS2 | 2.87 |
| SF19-D24-23A SF871NDS2 | 2.66 |
| SF38-F28-23A SF871NDS2 | 2.96 |
| SF39-G11-23A SF871NDS2 | 3.26 |
| SF15-C31-22A SF871NDS | 3.01 |
| SF17-D27-22A SF871NDS | 3.30 |
| SF19-E16-22A SF871NDS | 2.92 |
| SF17-D27-22A SF871NDSRet | 1.30 |
| SF19-E16-22A SF871NDSRet | 0.17 |
| SF19-K15-22A SF871NDSRet | 1.82 |
| SF26-L07-22A SF871NDSRet | 0.00 |
| SF26-A12-23A SF871PC | 7.08 |
| SF26-A30-23A SF871PC | 5.96 |
| SF19-J06-22A SF871PC | 8.95 |
| SF26-B01-23A SF871PC | 6.73 |
| SF26-B07-23A SF871PC | 6.16 |
| SF26-B21-23A SF871PC | 6.99 |
| SF26-C08-23A SF871PC | 7.32 |
| SF19-D24-23A SF871PC | 7.53 |
| SF19-E16-22A SF871PN2 | 1.17 |
| SF19-I28-22A SF871SM | 7.32 |
| Sunbloom | 3.10 |
| Heliaflor 55 | 3.68 |
| Sunflower Seed Powder 50% Protein | 1.75 |

As may be seen from the results in Table 6, the SF871NDS2 and SF871NDS products had water binding capacity within the range of the commercial products. The SF871NDSRet product had a generally lower water binding capacity than the commercial products. The products containing the coarse residual solids from the protein source (SF871PC, SF871SM) had a higher water binding capacity than the commercial products.

### Example 27

This Example contains an evaluation of the oil binding capacity of the sunflower protein product prepared as described in Example 1 to 22 as well as the commercially available sunflower protein products Sunbloom (Sunbloom Proteins GmbH), Heliaflor 55 (Austrade Inc.) and Sunflower Seed Powder 50% Protein (Acetar Bio-Tech Inc.).

The oil binding capacity of the products was determined by the following procedure. Protein powder (1 g) was weighed into centrifuge tubes (50 ml) of known weight. To this powder was added approximately 20 ml of retail canola oil. The contents of the tubes were mixed using a vortex mixer at moderate speed for 1 minute. The samples were incubated at room temperature for 5 minutes then mixed with the vortex for 30 seconds. This was followed by incubation at room temperature for another 5 minutes then another 30 seconds of vortex mixing. The samples were then centrifuged at 1,000 g for 15 minutes at 20° C. After centrifugation, the supernatant was pipetted off, ensuring that all solid material remained in the tube. The centrifuge tube was then re-weighed and the weight of oil saturated sample was determined.

Oil binding capacity (OBC) was calculated as:

$$OBC ( ml / g ) = ( ( mass of oil saturated sample ( g ) - mass of initial sample ( g ) ) / 0.914 g / ml ) / ( mass of initial sample ( g ) \times total solids content of sample ) .$$

The OBC results are shown in Table 7.

TABLE 7
OBC of sunflower protein products

| Product | OBC (ml/g) |
|---|---|
| SF25-I12-22A SF871NDS2 | 1.07 |
| SF19-I28-22A SF871NDS2 | 0.93 |
| SF19-K15-22A SF871NDS2 | 0.87 |
| SF26-L07-22A SF871NDS2 | 1.16 |
| SF26-A10-23A SF871NDS2 | 1.01 |
| SF26-A12-23A SF871NDS2 | 1.21 |
| SF28-A25-23A SF871NDS2 | 1.20 |
| SF26-B14-23A SF871NDS2 | 0.93 |
| SF26-B27-23A SF871NDS2 | 0.96 |
| SF26-C13-23A SF871NDS2 | 0.98 |
| SF19-D24-23A SF871NDS2 | 1.01 |
| SF38-F28-23A SF871NDS2 | 0.91 |
| SF39-G11-23A SF871NDS2 | 0.86 |
| SF15-C31-22A SF871NDS | 0.94 |
| SF17-D27-22A SF871NDS | 1.02 |
| SF19-E16-22A SF871NDS | 0.90 |
| SF17-D27-22A SF871NDSRet | 3.74 |
| SF19-E16-22A SF871NDSRet | 1.29 |
| SF19-K15-22A SF871NDSRet | 2.24 |
| SF26-L07-22A SF871NDSRet | 2.47 |
| SF26-A12-23A SF871PC | 2.56 |
| SF26-A30-23A SF871PC | 2.75 |
| SF19-J06-22A SF871PC | 3.52 |
| SF26-B01-23A SF871PC | 2.78 |
| SF26-B07-23A SF871PC | 2.33 |
| SF26-B21-23A SF871PC | 2.39 |
| SF26-C08-23A SF871PC | 2.73 |
| SF19-D24-23A SF871PC | 3.29 |
| SF19-E16-22A SF871PN2 | 1.19 |
| SF19-I28-22A SF871SM | 2.89 |
| Sunbloom | 1.79 |
| Heliaflor 55 | 1.35 |
| Sunflower Seed Powder 50% Protein | 0.96 |

As may be seen from the results in Table 7, the SF871NDS2 and SF871NDS products had oil binding capacity similar to that of the lower oil binding commercial products. The SF871NDSRet product had a similar or higher oil binding capacity compared to the commercial products. The products containing the coarse residual solids from the protein source (SF871PC, SF871SM) had a higher oil binding capacity than the commercial products.

### Example 28

This Example describes the amino acid profile of sunflower protein products prepared as described in Examples 5, 8, 12, 13, 15, 16 and 19.

Amino acid profiles of the sunflower protein products were assessed experimentally according to method reference USDA MSS2 (1993). A complete amino acid profile was done, to quantify tryptophan, cysteine/methionine and the remaining amino acids. The as-is protein concentration was determined and the amino acid results expressed as mg/g protein.

Amino acid profiles for sunflower protein products prepared as described in Examples 5, 8, 12, 13, 15, 16 and 19 are shown in Table 8 below.

TABLE 8
Amino acid profile of sunflower protein products

| | concentration (mg/g protein) | | | | | | | |
|---|---|---|---|---|---|---|---|---|
| | SF26- | SF26- | SF26- | SF26- | SF26- | SF19- | SF26- | SF26- |
| | B14-23A | B27-23A | C13-23A | A10-23A | A10-23A | I28-22A | B01-23A | B07-23A |
| Amino acid | SF871NDS2 | SF871NDS2 | SF871NDS2 | SF871NDS | SF871NDSRet | SM | SF871PC | SF871PC |
| Aspartic | 105.8 | 100.3 | 93.5 | 98.6 | 75.7 | 75.2 | 91.6 | 91.2 |
| Threonine | 37.9 | 35.0 | 29.9 | 31.2 | 34.2 | 36.0 | 45.3 | 43.1 |
| Serine | 41.0 | 43.0 | 37.3 | 41.8 | 35.0 | 41.4 | 51.0 | 53.1 |
| Glutamic | 207.7 | 231.9 | 227.1 | 181.7 | 203.8 | 107.1 | 169.9 | 181.3 |
| Proline | 57.2 | 58.7 | 56.2 | 58.8 | 66.6 | 50.6 | 60.1 | 62.1 |
| Glycine | 47.8 | 47.8 | 45.9 | 43.4 | 53.7 | 62.6 | 77.0 | 74.5 |
| Alanine | 40.4 | 42.1 | 40.3 | 37.2 | 30.5 | 38.5 | 44.2 | 47.0 |
| Valine | 43.5 | 48.8 | 49.0 | 48.0 | 40.4 | 43.7 | 49.4 | 52.4 |
| Isoleucine | 38.1 | 40.3 | 39.1 | 42.3 | 32.6 | 34.2 | 42.1 | 42.5 |
| Leucine | 58.1 | 64.1 | 62.4 | 61.3 | 50.8 | 56.3 | 67.6 | 72.3 |
| Tyrosine | 27.8 | 22.3 | 30.6 | 27.2 | 24.4 | 22.3 | 26.0 | 21.2 |
| Phenylalanine | 49.4 | 52.8 | 50.1 | 56.2 | 27.7 | 34.2 | 41.9 | 47.0 |
| Lysine | 27.5 | 28.5 | 27.2 | 23.6 | 41.7 | 37.1 | 46.7 | 47.0 |
| Histidine | 25.5 | 26.2 | 25.0 | 26.0 | 24.2 | 21.8 | 23.9 | 25.3 |
| Arginine | 91.8 | 94.0 | 92.6 | 92.3 | 87.4 | 68.9 | 77.5 | 82.0 |
| Cysteine | 19.9 | 15.2 | 14.2 | 13.4 | 34.2 | 17.6 | 27.8 | 21.5 |
| Methionine | 22.6 | 24.5 | 23.0 | 20.5 | 34.8 | 16.0 | 19.0 | 18.5 |
| Tryptophan | 11.4 | 10.4 | 10.5 | 13.1 | 6.5 | 10.8 | 10.4 | 10.4 |

As may be seen from the results in Table 8, the product SF871NDSRet was particularly high in sulfur containing amino acids.

### Example 29

This Example illustrates the chlorogenic acid content of the sunflower protein products prepared by the procedures of Examples 2, 4-10, 12, 14-16, 18 and 19 and the commercial product Heliaflor 55 (Austrade Inc.). The chlorogenic acid content was determined by modified AOAC 2018.08 by Vanguard Laboratory (Olympia, WA). Dry basis results were calculated from the as-is chlorogenic acid content and the dry matter content of the samples (oven drying method). The results are shown in Table 9.

TABLE 9
Chlorogenic acid content of sunflower protein products

| Product | Chlorogenic acid content (ppm d.b.) |
|---|---|
| SF25-I12-22A SF871NDS2 | 2,285 |
| SF19-I28-22A SF871NDS2 | 1,519 |
| SF19-K15-22A SF871NDS2 | 394 |
| SF26-L07-22A SF871NDS2 | 632 |
| SF26-A10-23A SF871NDS2 | 119 |
| SF26-A12-23A SF871NDS2 | 287 |
| SF26-B14-23A SF871NDS2 | 181 |
| SF26-C13-23A SF871NDS2 | 213 |
| SF17-D27-22A SF871NDS | 195 |
| SF19-K15-22A SF871NDS | 296 |
| SF26-L07-22A SF871NDS | 642 |
| SF26-A10-23A SF871NDS | 158 |
| SF26-A12-23A SF871NDS | 263 |
| SF28-A25-23A SF871NDS | 212 |
| SF19-K15-22A SF871NDSRet | 199 |
| SF26-L07-22A SF871NDSRet | 404 |
| SF26-A10-23A SF871NDSRet | 8 |
| SF26-A12-23A SF871NDSRet | 25 |
| SF28-A25-23A SF871NDSRet | 5 |
| SF26-A12-23A SF871PC | 5,471 |
| SF19-J06-22A SF871PC | 784 |
| SF26-B01-23A SF871PC | 543 |
| SF26-B07-23A SF871PC | 757 |
| SF26-C08-23A SF871PC | 973 |
| SF19-I28-22A SF871SM | 10,449 |
| Heliaflor 55 | 21,684 |

As may be seen from the results in Table 9, the products prepared by the procedures of Examples 2, 4-10, 12, 14-16, 18 and 19 were much lower in chlorogenic acid than the Heliaflor 55, particularly the products derived from the sunflower protein solution (SF871NDS2, SF871NDS, SF871NDSRet). Multiple extractions and washing of the finer residual solids was found to reduce the chlorogenic acid content of the SF871PC.

### Example 30

This Example illustrates the sodium content of products prepared as described in Examples 1, 4, 5, 8, 14 and 19.

Sodium contents were determined by AOAC 984.27. Dry basis results were calculated from the as-is sodium content and the dry matter content of the samples (AOAC 950.46 or AOAC 964.22).

The results are as shown in Table 10.

TABLE 10
Sodium content of sunflower protein products

| Product | mg sodium/100 g d.b. |
|---|---|
| SF25-I12-22A SF871NDS2 | 1,398 |
| SF19-I28-22A SF871NDS2 | 910 |
| SF26-A10-23A SF871NDS2 | 546 |
| SF26-C13-23A SF871NDS2 | 557 |
| SF15-C31-22A SF871NDS | 521 |
| SF19-J06-22A SF871PC | 219 |
| SF19-I28-22A SF871SM | 235 |

As may be seen from the results in Table 10, the product containing the residual solids from the protein source (SF871PC, SF871SM) had a lower sodium content than the products derived from the sunflower protein solution (SF871NDS2, SF871NDS).

### Example 31

This Example illustrates the fat content of the products prepared as described in Examples 1-22. The fat content was determined using an acid hydrolysis method (AOAC 933.05). Dry basis results were calculated from the as-is fat content and the dry matter content of the samples (AOAC 950.46 or AOAC 964.22). The results are shown in Table 11.

TABLE 11
Acid hydrolysis fat content of sunflower protein products

| Product | Acid hydrolysis fat content (% d.b.) |
|---|---|
| SF25-I12-22A SF871NDS2 | 2.63 |
| SF19-I28-22A SF871NDS2 | 6.85 |
| SF19-K15-22A SF871NDS2 | 5.84 |
| SF26-L07-22A SF871NDS2 | 2.31 |
| SF26-A30-23A SF871NDS2 | 5.44 |
| SF26-B14-23A SF871NDS2 | 6.21 |
| SF26-B27-23A SF871NDS2 | 9.01 |
| SF26-C13-23A SF871NDS2 | 9.18 |
| SF19-D24-23A SF871NDS2 | 9.70 |
| SF38-F28-23A SF871NDS2 | 10.69 |
| SF15-C31-22A SF871NDS | 3.30 |
| SF17-D27-22A SF871NDS | 1.84 |
| SF19-E16-22A SF871NDS | 5.09 |
| SF19-K15-22A SF871NDS | 5.42 |
| SF26-L07-22A SF871NDS | 1.55 |
| SF26-A10-23A SF871NDS | 3.58 |
| SF26-A12-23A SF871NDS | 4.46 |
| SF28-A25-23A SF871NDS | 9.76 |
| SF17-D27-22A SF871NDSRet | 1.74 |
| SF19-K15-22A SF871NDSRet | 9.04 |
| SF26-L07-22A SF871NDSRet | 4.71 |
| SF26-A10-23A SF871NDSRet | 7.05 |
| SF26-A12-23A SF871NDSRet | 7.02 |
| SF28-A25-23A SF871NDSRet | 12.15 |
| SF26-A12-23A SF871PC | 9.62 |
| SF26-A30-23A SF871PC | 10.77 |
| SF19-J06-22A SF871PC | 7.75 |
| SF26-B01-23A SF871PC | 6.49 |
| SF26-B07-23A SF871PC | 6.70 |
| SF26-B21-23A SF871PC | 7.02 |
| SF26-C08-23A SF871PC | 7.66 |
| SF19-D24-23A SF871PC | 9.44 |
| SF38-F28-23A SF871PC | 9.59 |
| SF39-G11-23A SF871PC | 9.54 |
| SF19-E16-22A SF871PN2 | 18.09 |
| SF19-I28-22A SF871SM | 9.74 |

As may be seen from the results in Table 11, lower fat contents were generally obtained for products derived from the sunflower protein solution (SF871NDS2, SF871NDS, SF871NDSRet) compared to products containing the residual solids from the protein source (SF871PC, SF871PN2, SF871SM).

### Example 32

This Example illustrates the foaming properties (foam overrun and foam stability) of the sunflower products prepared by the methods of Examples 2, 4, 6-9 and 12.

Foam Overrun: Sufficient protein powder to supply 8 g of protein was weighed out into a beaker. A small amount of water was stirred into the protein powder to make a paste. Enough water to make the volume up to approximately 150 ml was then added and the mixture stirred with a magnetic stirrer at a speed controlled so as to try to avoid foam formation. Once the protein was well dispersed the pH of the solution was adjusted to a value of 7 using NaOH or HCl as necessary. Stirring was continued to a total of 60 minutes with the pH corrected periodically. The sample was then made up to 160 ml with water to yield a 5% w/v dispersion. A sample of protein dispersion (75 ml) was weighed then poured into the bowl of the Hobart N-50 mixer (Hobart Corporation, Troy, Ohio) and whipped for 5 minutes on the highest speed (setting 3) of the mixer using the whisk attachment. After 2, 3.5 and 5 minutes of whipping, the mixer was stopped and two measuring cups (125 ml) were filled with foam and weighed. These foam samples were then returned to the bowl before whipping proceeded. Overrun was calculated for each time point using the following equation (Phillips et al., J. Food Sci., 55 (5): 1441-1444, 1453):

$$Overrun ( \% ) = ( wt liquid sample ( 125 ml ) - wt foam ( 125 ml ) ) / wt foam ( 125 ml ) \times 100$$

Foam Stability: To measure foam stability, a second sample (75 ml) of protein dispersion was poured into the special bowl of the Hobart N-50 mixer and whipped for 5 minutes on the highest speed (setting 3) of the mixer using the whisk attachment. The special bowl contains a 6 mm diameter hole drilled into the bottom of the bowl just outside the path of the beater (Phillips et al., 1990). During whipping this hole was covered by a piece of tape. Once whipping was completed the tape was removed and the hole cleared with a stirring rod. The weight of material that drained out of the bowl was determined every 5 minutes for 30 minutes. The weight of drained sample was divided by the starting weight of foam to calculate what percentage of material had drained out of the bowl.

The foam overrun and foam stability for the SF810N products tested are set forth in Tables 12 and 13 respectively.

TABLE 12
Foam overrun for sunflower products

| | Overrun (%) at whipping time of | | |
|---|---|---|---|
| sample | 2 minutes | 3.5 minutes | 5 minutes |
| SF25-I12-22A SF871NDS2 | 347.0 | 356.7 | 341.4 |
| SF26-A12-23A SF871NDS2 | 567.7 | 461.9 | 426.8 |
| SF26-B14-23A SF871NDS2 | 463.0 | 360.8 | 482.3 |
| SF17-D27-22A SF871NDSRet | 1160.1 | 1497.6 | 1783.5 |
| SF19-K15-22A SF871NDSRet | 384.7 | 552.3 | 708.2 |
| SF26-L07-22A SF871NDSRet | 522.8 | 610.1 | 773.4 |
| SF26-A10-23A SF871NDSRet | 739.5 | 938.9 | 997.6 |
| SF26-A12-23A SF871NDSRet | 568.0 | 759.9 | 856.6 |

TABLE 13
Foam stability for sunflower products

| | Mass loss (%) at drainage time of | | | | | |
|---|---|---|---|---|---|---|
| sample | 5 min | 10 min | 15 min | 20 min | 25 min | 30 min |
| SF26-B14-23A SF871NDS2 | 74.3 | 81.2 | 86.2 | 89.9 | 92.5 | 95.0 |
| SF17-D27-22A SF871NDSRet | 0.0 | 0.0 | 0.0 | 0.0 | 0.0 | 0.0 |
| SF19-K15-22A SF871NDSRet | 0.0 | 0.7 | 5.9 | 15.0 | 23.3 | 31.0 |
| SF26-L07-22A SF871NDSRet | 0.3 | 15.5 | 38.3 | 55.8 | 67.8 | 75.9 |
| SF26-A10-23A SF871NDSRet | 0.0 | 1.1 | 11.8 | 24.5 | 35.4 | 44.3 |
| SF26-A12-23A SF871NDSRet | 1.7 | 25.9 | 46.2 | 59.6 | 68.9 | 75.6 |

As may be seen from the results in Table 12, the SF871NDSRet products tested provided generally higher overruns than the SF871NDS2 products tested. As may be seen from the results in Table 13, the SF871NDSRet products tested provided foams that were more stable than that provided by the SF871NDS2 product.

### Example 33

This Example illustrates the in vitro protein digestibility of product prepared by the method of Example 12.

In vitro protein digestibility was determined according to the method of Tinus et al. (2012) (J. Food Eng., 113:254-264). The SF26-B14-23A SF871NDS2 product was found to have an in vitro protein digestibility of 99.6%.

### Example 34

This Example illustrates the preparation of a dairy alternative beverage with a protein content of 3.5 wt %, using sunflower protein product prepared by the procedure of Example 6. The formulation for the sunflower protein dairy alternative beverage was as shown in Table 14.

TABLE 14
Formulation for dairy alternative beverage

| Ingredient | Amount (g) | Percentage (%) |
|---|---|---|
| Water, spring | 363.62 | 90.91 |
| SF19-K15-21A SF871NDS2 | 15.18 | 3.79 |
| Sugar, white | 12.00 | 3.00 |
| Sunflower oil | 8.00 | 2.00 |
| Flavour, dry, vanilla | 0.80 | 0.20 |
| Stabilizer, gellan gum | 0.40 | 0.10 |
| Total | 400.0 | 100.00 |

The protein powder, sugar, and stabilizer were placed in a large beaker. The water was added to the dry ingredients and mixed on a magnetic stirring hot plate. When the mixture was dispersed, the oil was slowly added while continually mixing. To batch pasteurize, the product was heated on the magnetic stirring hot plate. When the product reached a temperature between 65° C. and 70° C., the flavour was added. The product was pasteurized at 72-76° C. for 30 seconds. After pasteurization, the product was homogenized using a GEA Niro Soavi Panda Plus at 175 bar/35 bar (210 total). The product was filled into a bottle and stored at refrigerated temperature (4° C.).

The beverage was tasted by an informal sensory panel with four participants. Comments provided by the panelists confirmed that an edible beverage of at least acceptable quality was prepared with the product of the present disclosure. Specific comments included “clean”, “not very sweet”, “no off flavour”, “thin texture”, “not viscous”, and “light colour.”

### Example 35

This Example illustrates the preparation and sensory assessment of baked meringue cookies containing about 2.4 wt % protein from sunflower protein product prepared by the procedure of Example 2. The formulation for the cookies is shown in Table 15.

TABLE 15
Formulation for baked meringues cookies
with sunflower protein product

| Ingredient | Amount (g) |
|---|---|
| SF17-D27-22A-SF871NDSRet | 9.50 |
| Water | 160.00 |
| Cream of tartar | ½ tsp (about 2 g) |
| White sugar | ¾ c (about 157 g) |

The protein and water were mixed with a magnetic stirrer in a beaker until fully dispersed. 75 ml of mixture was placed in a Hobart stand mixer and whipped with the whisk attachment for 5 minutes on high speed (setting 3). The remaining mixture was added and whipped continued. Two minutes later ½ tsp of cream of tartar was added followed by ¾ cup of sugar, with one third of the sugar added at a time slowly until the sugar was dispersed. Whipping continued until stiff glossy peaks formed. The whipped batter was dropped by 1-2 tablespoonfuls onto a parchment lined baking pan and baked at 275° F. for 25 minutes. After baking, the oven was turned off and the oven door left slightly ajar for 1 hour. The oven door was then shut, and meringues were left in the oven overnight.

The cookies were tasted by an informal sensory panel with 10 participants. Comments provided by the panelists confirmed that an edible cookie of at least acceptable quality was prepared with the product of the present disclosure. Specific comments included “sweet taste”, “slightly sweet”, “vanilla sweet”, “no off flavour”, “marshmallow feel”, “crunchy then chewy”, “melted in mouth”, “no strong aroma”, “no off aroma”, “good colour”, “very chewy then melts to nothing”, “good mouthfeel”, “smooth mouthfeel”, “not sticky to touch”, “slightly sticky”, “slightly acidic notes”, “tastes like regular meringue” and “very similar in texture to meringue.”

### Example 36

This Example illustrates the preparation and evaluation of a cooked pork sausage using sunflower protein product prepared by the procedure of Example 18. The formulation for the sausage containing sunflower protein product was as shown in Table 16. A control sausage using soy protein concentrate was also prepared and evaluated with the formulation as shown in Table 17.

TABLE 16
Formulation for cooked pork sausage
with sunflower protein product

| Ingredient | Amount (g) | Percentage (%) |
|---|---|---|
| Pork shoulder meat, ground | 378.00 | 84.00 |
| Water | 49.50 | 11.00 |
| SF26-C08-23A SF871PC | 15.75 | 3.50 |
| Salt | 6.75 | 1.50 |
| Total | 450.00 | 100.00 |

TABLE 17
Formulation for cooked pork sausage with soy protein concentrate

| Ingredient | Amount (g) | Percentage (%) |
|---|---|---|
| Pork shoulder meat, ground | 378.00 | 84.00 |
| Water | 49.50 | 11.00 |
| Soy protein concentrate, ADM Arcon F | 15.75 | 3.50 |
| Salt | 6.75 | 1.50 |
| Total | 450.00 | 100.00 |

The protein powder and salt were added to the ground pork in a Hobart N-50 mixer. Using a paddle attachment, the dry ingredients were dispersed and mixed on the lowest speed (setting 1) for a total of two minutes, stopping every 30 seconds to scrape the sides and bottom of the bowl. The water was added and mixed for an additional 10 minutes. After mixing, the meat mixture was hand-formed into 14 sausages approximately 3 inches in length and ¾ inch in diameter. The weight of each raw link was determined. The formed sausages were placed on a baking sheet with parchment paper and cooked on the middle rack in a 350° F. oven for 10 minutes to an internal temperature of 160° F. The cooked sausages were allowed to cool to room temperature, weighed, then frozen. After three days in frozen storage, each sausage was weighed again. The cook yield from cooked (cook yield 1) and cooked and frozen (cook yield 2) were calculated for each sausage containing sunflower protein product as shown in Table 18. Sausages with soy protein concentrate were prepared following the same procedure as those with sunflower protein product. The cook yields for each sausage containing soy protein concentrate are shown in Table 19.

$$\% cook yield 1 = ( weight of cooked link / weight of raw link ) \times 100$$

$$\% cook yield 2 = ( weight of cooked and frozen link / weight of raw link ) \times 100$$

TABLE 18
Cook yield data for cooked pork sausage
with sunflower protein product

| | | | Cook | Wt. frozen, | |
|---|---|---|---|---|---|
| | Wt. raw | Wt. cooked | yield | cooked | Cook yield |
| Link | link (g) | link, (g) | 1 (%) | link, (g) | 2 (%) |
| 1 | 31.05 | 26.68 | 85.93% | 26.13 | 84.15 |
| 2 | 31.20 | 26.89 | 86.19% | 26.07 | 83.56 |
| 3 | 31.69 | 27.17 | 85.74% | 26.47 | 83.53 |
| 4 | 32.12 | 27.97 | 87.08% | 27.35 | 85.15 |
| 5 | 31.37 | 27.09 | 86.36% | 26.21 | 83.55 |
| 6 | 30.08 | 26.30 | 87.43% | 25.47 | 84.67 |
| 7 | 30.58 | 26.91 | 88.00% | 26.18 | 85.61 |
| 8 | 32.56 | 28.61 | 87.87% | 27.89 | 85.66 |
| 9 | 32.22 | 27.34 | 84.85% | 26.50 | 82.25 |
| 10 | 32.31 | 28.18 | 87.22% | 27.55 | 85.27 |
| 11 | 31.04 | 27.29 | 87.92% | 26.59 | 85.66 |
| 12 | 31.81 | 28.29 | 88.93% | 27.52 | 86.51 |
| 13 | 30.89 | 26.99 | 87.37% | 26.33 | 85.24 |
| 14 | 29.83 | 25.75 | 86.32% | 25.13 | 84.24 |
| Average | | | 86.94% | | 84.65 |

TABLE 19
Cook yield data for control cooked pork
sausage with soy protein concentrate

| | | | Cook | Wt. frozen, | |
|---|---|---|---|---|---|
| | Wt. raw | Wt. cooked | yield | cooked | Cook yield |
| Link | link (g) | link, (g) | 1 (%) | link, (g) | 2 (%) |
| 1 | 30.19 | 26.55 | 87.94% | 25.75 | 85.29 |
| 2 | 29.26 | 25.80 | 88.17% | 25.04 | 85.58 |
| 3 | 31.24 | 27.55 | 88.19% | 26.61 | 85.18 |
| 4 | 32.39 | 28.43 | 87.77% | 27.57 | 85.12 |
| 5 | 33.20 | 28.53 | 85.93% | 27.48 | 82.77 |
| 6 | 33.48 | 29.47 | 88.02% | 28.33 | 84.62 |
| 7 | 31.93 | 27.67 | 86.66% | 26.48 | 82.93 |
| 8 | 32.07 | 27.81 | 86.72% | 26.71 | 83.29 |
| 9 | 32.65 | 28.32 | 86.74% | 26.81 | 82.11 |
| 10 | 31.75 | 27.34 | 86.11% | 26.05 | 82.05 |
| 11 | 31.78 | 27.14 | 85.40% | 25.84 | 81.31 |
| 12 | 31.81 | 27.6 | 86.77% | 26.26 | 82.55 |
| 13 | 31.42 | 27.01 | 85.96% | 25.50 | 81.16 |
| 14 | 32.23 | 27.27 | 84.61% | 25.73 | 79.83 |
| Average | | | 86.79% | | 83.13 |

As may be seen from the results in Tables 18 and 19, sausages prepared with the SF871PC product demonstrated higher cook yields than control sausages prepared with soy protein concentrate.

Textural analysis was conducted with a TA.XTplus Texture Analyzer. To prepare the sausages for textural analysis, cooked sausages that hadn't been frozen were covered and re-warmed in an oven to an internal temperature of about 50-60° C. The re-warmed sausages were sheared with a MORS blade (TA-46) travelling 12 mm at a speed of 2 mm/see, with trigger force set to 5 g. The maximum force was recorded. Results presented in Table 20 are the average of 10 measurements.

TABLE 20
Peak force for shearing of sausages containing sunflower
protein product or soy protein concentrate

| Sample | Peak force (g) |
|---|---|
| Sausages with sunflower protein product | 701.43 |
| Sausages with soy protein concentrate | 713.19 |

As may be seen from the results in Table 20, the sausages made with the soy protein concentrate were slightly firmer than the sausages made with the sunflower protein product.

Sensory evaluation was conducted starting from frozen sausages. Twelve frozen sausages were heated and browned in a covered pan with three tablespoons of water on medium heat for five minutes. The pan was uncovered then cooked for an additional eight minutes, turning often to brown the surface.

The sausages were evaluated by an informal sensory panel of eight participants. Comments provided by the panellists confirmed that an edible sausage of at least acceptable quality was prepared with the SF871PC. Specific comments included “golden brown”, “even interior appearance”, “no irregular pockets of fat/meat”, “pleasant aroma”, “meaty aroma”, “salty”, “nice flavour”, “meaty flavour”, “sweet”, “firm”, “chewy”, “firm bite”, “softer”, and “no aftertaste or off notes.” Sausages containing soy protein concentrate were also evaluated with eight participants. Specific comments included “golden brown”, “meaty”, “salty”, “savoury”, “slightly sweet”, “firm”, “tougher”, and “no aftertaste or off notes.”

### Example 37

This Example illustrates the preparation and evaluation of a beef meatball using sunflower protein product prepared by the procedure of Example 16. The formulation for the meatball containing sunflower protein product was as shown in Table 21. A control meatball using soy protein concentrate was also prepared and evaluated with the formulation as shown in Table 22.

TABLE 21
Formulation for beef meatballs with sunflower protein product

| Ingredient | Amount (g) | Percentage (%) |
|---|---|---|
| Ground beef, regular | 423.00 | 94.00 |
| Water | 18.00 | 4.00 |
| SF26-B07-23A SF871PC | 9.00 | 2.00 |
| Total | 450.00 | 100.00 |

TABLE 22
Formulation for beef meatballs with soy protein concentrate

| | Amount | Percentage |
|---|---|---|
| Ingredient | (g) | (%) |
| Ground beef, regular | 423.00 | 94.00 |
| Water | 18.00 | 4.00 |
| Soy protein concentrate, Bunge PurePro 70N-50 | 9.00 | 2.00 |
| Total | 450.00 | 100.00 |

The protein powder was added to the ground beef in a Hobart N-50 mixer. Using a paddle attachment, the protein powder was mixed with the meat on the lowest speed (setting 1) for a total of two minutes, stopping after 1 minute to scrape the sides and bottom of the bowl. The water was added and mixed for an additional 5 minutes. After mixing, the meat mixture was hand-formed into meatballs approximately 1¼ inch in diameter. The weight of each raw meatball was determined. The meatballs were placed on a baking sheet with parchment paper and cooked on the middle rack in a 350° F. oven for 18 minutes to an internal temperature of 160° F. The hot, cooked meatballs were placed on paper towel to absorb excess fat. The meatballs were removed from the paper towel and allowed to cool to room temperature, weighed, then frozen. After three days in frozen storage, each meatball was weighed again. The cook yield from cooked (cook yield 1) and cooked and frozen (cook yield 2) were calculated for each meatball containing sunflower protein product as shown in Table 23. Meatballs with soy protein concentrate were prepared following the same procedure as those with sunflower protein product. The cook yields for each meatball containing soy protein concentrate are shown in Table 24.

$$\% cook yield 1 = ( weight of cooked meatball / weight of raw meatball ) \times 100$$

$$\% cook yield 2 = ( weight of cooked and frozen meatball / weight of raw meatball ) \times 100$$

TABLE 23
Cook yield data for beef meatballs with sunflower protein product

| | Wt. raw | | Cook | Wt. frozen, | Cook |
|---|---|---|---|---|---|
| | Meatball | Wt. cooked | Yield | cooked | Yield |
| Meatball | (g) | meatball (g) | 1 (%) | meatball (g) | 2 (%) |
| 1 | 21.44 | 13.71 | 63.95% | 13.31 | 62.08% |
| 2 | 21.67 | 13.66 | 63.04% | 13.32 | 61.47% |
| 3 | 21.94 | 14.33 | 65.31% | 13.99 | 63.76% |
| 4 | 20.21 | 13.35 | 66.06% | 13.05 | 64.57% |
| 5 | 20.50 | 13.55 | 66.10% | 13.24 | 64.59% |
| 6 | 21.11 | 13.85 | 65.61% | 13.48 | 63.86% |
| 7 | 20.69 | 14.01 | 67.71% | 13.63 | 65.88% |
| 8 | 21.6 | 14.54 | 67.31% | 14.14 | 65.46% |
| 9 | 20.07 | 13.51 | 67.31% | 13.18 | 65.67% |
| 10 | 21.32 | 14.22 | 66.70% | 13.91 | 65.24% |
| 11 | 20.22 | 12.70 | 62.81% | 12.39 | 61.28% |
| 12 | 20.28 | 13.31 | 65.63% | 12.97 | 63.95% |
| 13 | 20.90 | 13.98 | 66.89% | 13.67 | 65.41% |
| 14 | 21.55 | 14.21 | 65.94% | 13.85 | 64.27% |
| 15 | 20.75 | 14.14 | 68.14% | 13.78 | 66.41% |
| 16 | 21.02 | 13.67 | 65.03% | 13.33 | 63.42% |
| 17 | 21.13 | 13.38 | 63.32% | 13.01 | 61.57% |
| 18 | 20.65 | 13.81 | 66.88% | 13.47 | 65.23% |
| 19 | 21.73 | 14.63 | 67.33% | 14.29 | 65.76% |
| 20 | 20.80 | 13.89 | 66.78% | 13.66 | 65.67% |
| Average | | | 65.89% | | 64.28% |

TABLE 24
Cook yield data for beef meatballs with soy protein concentrate

| | Wt. raw | | Cook | Wt. frozen, | Cook |
|---|---|---|---|---|---|
| | Meatball | Wt. cooked | Yield | cooked | Yield |
| Meatball | (g) | meatball (g) | 1 (%) | meatball (g) | 2 (%) |
| 1 | 20.09 | 13.28 | 66.10% | 12.83 | 63.86% |
| 2 | 20.26 | 12.67 | 62.54% | 12.28 | 60.61% |
| 3 | 21.81 | 14.26 | 65.38% | 13.86 | 63.55% |
| 4 | 19.85 | 13.00 | 65.49% | 12.59 | 63.43% |
| 5 | 21.30 | 13.66 | 64.13% | 13.25 | 62.21% |
| 6 | 19.66 | 12.8 | 65.11% | 12.43 | 63.22% |
| 7 | 21.28 | 13.89 | 65.27% | 13.51 | 63.49% |
| 8 | 19.73 | 12.92 | 65.48% | 12.57 | 63.71% |
| 9 | 20.40 | 13.67 | 67.01% | 13.28 | 65.10% |
| 10 | 21.16 | 13.77 | 65.08% | 13.41 | 63.37% |
| 11 | 19.86 | 13.41 | 67.52% | 13.02 | 65.56% |
| 12 | 21.56 | 14.21 | 65.91% | 13.81 | 64.05% |
| 13 | 20.06 | 13.48 | 67.20% | 13.13 | 65.45% |
| 14 | 20.80 | 13.98 | 67.21% | 13.64 | 65.58% |
| 15 | 20.45 | 13.45 | 65.77% | 13.09 | 64.01% |
| 16 | 20.78 | 13.39 | 64.44% | 13.01 | 62.61% |
| 17 | 21.80 | 14.31 | 65.64% | 13.90 | 63.76% |
| 18 | 21.71 | 14.52 | 66.88% | 14.13 | 65.09% |
| 19 | 21.31 | 14.25 | 66.87% | 13.87 | 65.09% |
| 20 | 21.05 | 13.44 | 63.85% | 13.10 | 62.23% |
| Average | | | 65.64% | | 63.80% |

As may be seen from the results in Tables 23 and 24, meatballs prepared with the SF871PC product demonstrated higher cook yields than control meatballs prepared with soy protein concentrate.

Textural analysis was conducted with a TA.XTplus Texture Analyzer. To prepare the meatballs for textural analysis, cooked meatballs that hadn't been frozen were covered and re-warmed in an oven to an internal temperature of about 50-60° C. The re-warmed meatballs were sheared with a MORS blade (TA-46) travelling 12 mm at a speed of 2 mm/see, with trigger force set to 5 g. The maximum force was recorded. Results presented in Table 25 are the average of 12 measurements.

TABLE 25
Peak force for shearing of meatballs containing sunflower
protein product or soy protein concentrate

| Sample | Peak force (g) |
|---|---|
| Meatballs with sunflower protein product | 594.155 |
| Meatballs with soy protein concentrate | 560.418 |

As may be seen from the results in Table 25, the meatballs made with the sunflower protein product were firmer than the meatballs made with the soy protein concentrate.

Sensory evaluation was conducted starting from frozen meatballs. Frozen meatballs were heated and browned in a preheated 350 F oven on the middle rack for 20 minutes prior to presentation to the sensory panel.

The meatballs were evaluated by an informal sensory panel of twelve participants. Comments provided by the panellists confirmed that an edible meatball of at least acceptable quality was prepared with the SF871PC. Specific comments included “dark brown colour”, “golden fried appearance”, “beefy”, “meaty”, “bland”, “savoury”, “soft”, “chewy”, “some fatty mouthfeel”, “firm”, “dry”, and “lean texture.” Meatballs containing soy protein concentrate were also evaluated by twelve participants. Specific comments included “dark brown colour”, “golden fried appearance”, “beefy”, “meaty”, “less savoury”, “more bland”, “milder beef flavour”, “chewy”, “firm”, “dry”, and “lean texture.”

### Example 38

This Example illustrates the preparation and evaluation of an egg- and gluten-free, protein-fortified pancake mix containing sunflower protein products prepared by the procedures of Examples 13 and 16. The formulation for the pancake mix containing the sunflower protein products was as shown in Table 26.

TABLE 26
Formulation for pancake mix with sunflower protein products

| Ingredient | Percentage (%) |
|---|---|
| Buckwheat flour | 60.0 |
| Chickpea flour | 5.0 |
| SF26-B27-24A-SF871NDS2 | 7.5 |
| SF26-B07-24A-SF871PC | 4.0 |
| Sugar | 17.0 |
| Baking powder | 6.5 |
| Total | 100.0 |

The buckwheat flour, chickpea flour, sunflower protein products, sugar, and baking powder were dry blended together to make the egg- and gluten-free protein fortified pancake mix. To prepare the pancakes, 125 grams of oat milk was added to the dry ingredients and mixed with a spatula to achieve a homogenous batter. A light coating of vegetable oil was applied to a frying pan and the pan pre-heated on low to medium heat. The pancake batter was spread in ¼ cup portions in the hot pan and cooked on each side to a golden-brown colour, approximately 2 minutes per side.

The pancakes were evaluated by an informal sensory panel of six participants. Comments provided by the panellists confirmed that an edible pancake mix of at least acceptable quality was prepared with the sunflower protein products. Specific comments included “nice golden brown surface”, “appearance like whole grain pancakes”, “homogenous crumb”, “bland”, “nutty notes”, “a little dense”, “consistent internal texture”, “fluffy texture”, and “wholesome and healthy.”

### Example 39

This Example illustrates the preparation and evaluation of bread made with residual sunflower protein source derived sunflower protein product. The formulation for the bread was as shown in Table 27.

TABLE 27
Formulation for bread

| Ingredient | Percentage (%) | Weight, grams |
|---|---|---|
| All purpose flour | 61.6 | 500.0 |
| Water | 34.5 | 280.0 |
| Yeast | 1.0 | 8.0 |
| SF19/23-J11-22A-SF871PC | 1.6 | 13.0 |
| Salt | 0.1 | 0.5 |
| Sugar | 0.6 | 5.0 |
| Vegetable oil | 0.6 | 5.0 |
| Total | 100.0 | 811.5 |

The SF19/23-J11-22A-SF871PC was dispersed in the water and allowed to hydrate for 15-30 minutes. The yeast was activated for 10 minutes in 50-55° C. water in which the sugar was dissolved. The dough was prepared by combining the flour, salt, hydrated protein, oil and activated yeast. The dough was mixed together with a silicone spatula then kneaded by hand until a smooth elastic dough was formed. The dough was covered and allowed to rest for 10 minutes. The dough was formed into 12 buns and placed on a baking sheet. The buns were allowed to rise for 60 minutes. The buns were baked in a pre-heated 350° F. oven for 32-35 minutes until lightly browned. The buns were removed from the oven and transferred to a baking rack to cool.

The buns were evaluated by an informal sensory panel of twelve participants. Comments provided by the panellists indicated that an edible bread of at least acceptable quality was prepared with the SF871PC. Specific comments included “smells like bread”, “light coloured”, “good leavening”, “good interior air pockets”, “firm exterior”, “soft in the middle”, “slightly chewy texture”, “dense”, “dry”, “cleaner flavour” and “no off flavour.”

It will be appreciated that the examples and embodiments disclosed herein are intended to be non-limiting. What has been described is merely illustrative of the application of the principles of the disclosure. However, it will be apparent to a person skilled in the art that a number of variations and modifications can be made without departing from the scope of the following claims.

1. A process for preparing a sunflower protein product from a sunflower protein source, the sunflower protein product having a protein content of greater than 60 wt % (N×6.25) d.b., the process comprising
a) extracting sunflower protein from a sunflower protein source, optionally by a counter-current procedure, to cause solubilization of the sunflower protein from the sunflower protein source to produce an aqueous phase and a residual sunflower protein source; wherein optionally an anti-foamer, which is optionally a food-grade, non-silicone based anti-foamer, is added during the extraction to reduce the volume of foam formed upon further processing;
b) separating the aqueous phase from the residual sunflower protein source to produce an aqueous sunflower protein solution and a separated residual sunflower protein source, wherein optionally the aqueous sunflower protein solution is treated with an adsorbent, which is optionally granulated activated carbon, to remove colour and/or odour compounds
c) optionally defatting the separated aqueous sunflower protein solution to at least partially remove fat from the separated aqueous sunflower protein solution;
d) adjusting the pH of the aqueous sunflower protein solution to an acidic value in the range of about pH 1.5 to about pH 5.0 to provide an acidified sunflower protein solution;
e) optionally concentrating the acidified sunflower protein solution;
f) optionally diafiltering the concentrated acidified sunflower protein solution using water as the diafiltration solution or optionally diafiltering the acidified sunflower protein solution using water prior to concentration or optionally diafiltering the partially concentrated acidified sunflower protein solution using water;
g) optionally drying the acidified sunflower protein solution (d) or optionally concentrated and/or diafiltered sunflower protein solution ((e) or (f)) to provide a sunflower protein product;
wherein steps e) and f) may optionally be carried out simultaneously.

2-4. (canceled)

5. The process of claim 1, wherein separation step b) comprises a first centrifugation with a decanter centrifuge to produce coarse residual solids, and optionally a second centrifugation with a disc stack centrifuge to produce finer residual solids.

6-8. (canceled)

9. The process of claim 1, wherein a pH of the extraction may be the natural pH of the combination of the water and the sunflower protein source, or the pH of the extraction may be adjusted up to any value between the natural pH and about 8.5, or the pH may be adjusted within the range of about 6.8 to about 8.0, or the pH may be adjusted to about 6.8 to about 7.5.

10-14. (canceled)

15. The process of claim 1, wherein the water of extraction contains an antioxidant, wherein optionally the antioxidant is ascorbic acid in an amount of from about 0.01 to about 1 wt % of the solution.

16. (canceled)

17. The process of claim 1 wherein the separated sunflower protein solution is adjusted in pH to a pH of about 2.0 to about 3.0 in step (d).

18-24. (canceled)

25. The process of claim 1, wherein the concentration step e) is effected by a selective membrane technique, using a membrane with a molecular weight cut-off of about 1,000 to about 1,000,000 daltons.

26-28. (canceled)

29. The process of claim 25, wherein the diafiltration step f) is effected using the same membrane as for the concentration step e) or the diafiltration step f) is effected using a separate membrane with a different molecular weight cut-off.

30-43. (canceled)

44. The process of claim 1, wherein step e) and/or f) are carried out and said concentrated and/or diafiltered acidified sunflower protein solution is subjected to drying step g) to provide a sunflower protein product having a protein content of at least about 60 wt %, at least about 65 wt %, at least about 70 wt %, at least about 75 wt %, at least about 80 wt %, at least about 85 wt %, or greater than about 90 wt % protein (N×6.25) d.b.

45. The process of claim 1, wherein the pH of the optionally concentrated and optionally diafiltered acidified sunflower protein solution is raised to a value, which is less than about 8.0, about 6.0 to about 8.0 or about 6.5 to about 7.5, to produce a pH adjusted sunflower protein solution.

46-47. (canceled)

48. The process of claim 45, wherein the pH adjusted sunflower protein solution is separated into protein solids and a solids-removed protein solution, wherein the solids-removed protein solution is concentrated by a selective membrane technique using a membrane with a molecular weight cut-off of about 1,000 to about 100,000 daltons.

49-50. (canceled)

51. The process of claim 48, wherein the concentrated solids-removed protein solution is diafiltered using water as the diafiltration solution or the solids-removed protein solution is diafiltered with water prior to concentration or the partially concentrated solids-removed protein solution is diafiltered with water then further concentrated.

52-55. (canceled)

56. The process of claim 48, wherein the protein solids and concentrated and optionally diafiltered solids-removed protein solution are pasteurized individually or in combination by heating to a temperature of about 55° to about 85° C. for about 10 seconds to about 60 minutes, preferably about 60° C. to about 70° C. for about 10 minutes to about 60 minutes or about 70° C. to about 85° C. for about 10 seconds to about 60 seconds and optionally combined if not combined previously, then optionally dried.

57-61. (canceled)

62. The process of claim 5, wherein the finer residual solids are washed, optionally by suspending the solids in between about 1 and about 20 volumes of wash solution, then a separation step is performed to provide washed finer residual solids and a used wash solution.

63-64. (canceled)

65. The process of claim 62, wherein the washed finer solids are optionally diluted with water, optionally pasteurized then dried to provide a sunflower protein product having a protein content of at least about 40 wt % (N×6.25) d.b.

66-69. (canceled)

70. The process of claim 5, wherein the coarse residual solids are captured separately from the finer residual solids of the separated residual sunflower protein source in step b), are optionally diluted with water, optionally RO water, optionally pH adjusted to a value between about 6.0 and about 8.0, optionally pasteurized then optionally dried to form a sunflower protein product having a protein content of at least about 25 wt % (N×6.25) d.b.

71. The process of claim 5, wherein the coarse residual solids are captured separately from the finer residual solids of the separated residual sunflower protein source in step b), the finer residual solids are optionally washed, then the coarse residual solids and the optionally washed finer residual solids are combined for optional dilution with water, optional pasteurization and optional drying to form a sunflower protein product having a protein content of at least about 25, 30, 35, 40, 45, 50, 55, 60, 65 or 70 wt % (N×6.25) d.b.

72-74. (canceled)

75. A sunflower protein product having any one or more of the following attributes:
a protein content of at least about 60, at least about 65, at least about 70, at least about 75, at least about 80, at least about 85, at least about 90, or at least about 95 wt % (N×6.25) d.b., and a protein solubility of less than about 30% when measured at pH 4, less than about 20% when measured at pH 5.5, and less than about 40% when measured at pH 7;
a water binding capacity of about 4.0 to about 10.0 and optionally a dry colour b* value of less than about 14.80;
an in vitro protein digestibility of at least 99%;
a protein content as defined in or captured by or encompassing all or part of Table 3;
a protein solubility as defined in or captured by or encompassing all or part of Table 4;
a dry colour as defined in or captured by or encompassing all or part of Table 5;
a water binding capacity as defined in or captured by or encompassing all or part of Table 6;
an oil binding capacity as defined in or captured by or encompassing all or part of Table 7;
an amino acid profile comprising one or more amino acids as defined or captured by or encompassing all or part of Table 8;
a chlorogenic acid content as defined or captured by or encompassing all or part of Table 9;
a sodium content as defined or captured by or encompassing all or part of Table 10;
an acid hydrolysis fat content as defined or captured by or encompassing all or part of Table 11;
a foam overrun as defined in or captured by or encompassing all or part of Table 12; and
a foam stability as defined in or captured by or encompassing all or part of Table 13.

76-83. (canceled)

84. A food or beverage comprising the sunflower protein product of claim 75.

85-95. (canceled)

96. The food or beverage of claim 84, which is an extended meat product and wherein the cook yield is about equal to or greater than the cook yield when the same quantity of soy protein concentrate is used as the extender.

97-101. (canceled)

102. A sunflower protein product having
a) an amino acid profile comprising:

| Amino acid | Concentration (mg/g protein) |
|---|---|
| Tyrosine | about 21.2 to about 30.6 |
| Cysteine | about 13.4 to about 34.2 |

which optionally further comprises:

| Amino acid | Concentration (mg/g protein) |
|---|---|
| Threonine | about 29.9 to about 45.3 |
| Valine | about 40.4 to about 52.4 |
| Isoleucine | about 32.6 to about 42.5 |
| Leucine | about 50.8 to about 72.3 |
| Phenylalanine | about 27.7 to about 56.2 |
| Lysine | about 23.6 to about 47.0 |
| Histidine | about 21.8 to about 26.2 |
| Methionine | about 16.0 to about 34.8 |
| Tryptophan | about 6.5 to about 13.1 |

and/or
b) a chlorogenic acid content of less than about 1500 ppm on a dry basis, wherein the sunflower protein product optionally has a protein content of less than about 60 wt % (N×6.25) d.b.

103. The sunflower protein product of claim 102, whose amino acid profile comprises:

| Amino acid | Concentration (mg/g protein) |
|---|---|
| Tyrosine | about 21.2 to about 26.0 |
| Cysteine | about 21.5 to about 27.8 |

104-105. (canceled)
